(19) United States
(12) Patent Application Publication
(10) Pub. No.: US 2024/0401837 A1
(43) Pub. Date: Dec. 5, 2024

(54) AIR CONDITIONING SYSTEM

(71) Applicant: DENSO CORPORATION, Kariya-city (JP)

(72) Inventors: Takuro Furukoshi, Kariya-city (JP); Naohisa Ishizaka, Kariya-city (JP); Tatsuhiro Suzuki, Kariya-city (JP)

(21) Appl. No.: 18/804,878

(22) Filed: Aug. 14, 2024

Related U.S. Application Data
(63) Continuation of application No. PCT/JP2023/004789, filed on Feb. 13, 2023.

(30) Foreign Application Priority Data
Feb. 24, 2022 (JP) 2022-027142

(51) Int. Cl. F24F 11/84

(52) U.S. Cl. CPC F24F 11/84

(57) ABSTRACT

An air conditioning system includes a casing having an air introduction port, an internal passage, and an external passage. A bypass passage guides air flowing through the internal passage to the external passage. A refrigeration cycle includes a first heat exchanger that heats air flowing in the internal passage, and a second heat exchanger that absorbs heat from air flowing in the external passage. The bypass passage may have an air flow upstream end disposed in the internal passage, and an air flow downstream end disposed upstream of the second heat exchanger in an air flow in the external passage. A flow rate adjustment unit may adjust a temperature of air flowing through the internal passage by adjusting a flow rate of air flowing from the external passage to the internal passage via the bypass passage.

### CROSS REFERENCE TO RELATED APPLICATIONS

The present application is a continuation application of International Patent Application No. PCT/JP2023/004789 filed on Feb. 13, 2023, which designated the U.S. and claims the benefit of priority from Japanese Patent Application No. 2022-027142 filed on Feb. 24, 2022.

### TECHNICAL FIELD

The present disclosure relates to an air conditioning system.

### BACKGROUND ART

Conventionally, there is an air conditioning system including a housing having a first air flow channel and a second air flow channel through which air flows toward a passenger compartment of a vehicle, and a door unit that controls a flow of air flowing through the first air flow channel and the second air flow channel.

### SUMMARY

According to at least one embodiment of the present disclosure, an air conditioning system is used for blowing heated air. The air conditioning system includes a casing, a bypass passage, an air blowing unit, and a refrigerant cycle. The casing includes an air introduction port configured to introduce air, an internal passage configured to guide the air introduced from the air introduction port to an inside of a compartment, and an external passage configured to guide the air introduced from the air introduction port to an outside of the compartment. The bypass passage is configured to guide air flowing through the internal passage to the external passage. The air blowing unit is configured to generate an air flow in the internal passage and the external passage. The refrigeration cycle includes an electric compressor configured to compress and discharge a refrigerant by an operation of an electric motor as a drive source, a first heat exchanger provided in the internal passage and configured to heat the air flowing in the internal passage by exchanging heat between the refrigerant discharged from the electric compressor and the air flowing in the internal passage, a decompressor configured to reduce a pressure of a refrigerant that has flowed out from the first heat exchanger, and a second heat exchanger provided in the external passage and configured to absorb heat from air flowing in the external passage by exchanging heat between a refrigerant that has flowed out from the decompressor and the air flowing in the external passage. The bypass passage includes an air flow upstream end disposed in the internal passage, and an air flow downstream end disposed in the external passage.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a schematic configuration diagram of an air conditioning system according to a first embodiment.

FIG. 2 is a schematic configuration diagram of a refrigeration cycle device according to the first embodiment.

FIG. 3 is a diagram showing a flow of air when the air conditioning system according to the first embodiment operates in a heating mode.

FIG. 4 is a diagram showing a flow of air when the air conditioning system according to the first embodiment operates in a cooling mode.

FIG. 5 is a diagram showing a flow of air when a first modification of the air conditioning system according to the first embodiment operates in a heating mode.

FIG. 6 is a diagram showing a flow of air when the first modification of the air conditioning system according to the first embodiment operates in a cooling mode.

FIG. 7 is a diagram showing a flow of air when a second modification of the air conditioning system according to the first embodiment operates in a heating mode.

FIG. 8 is a diagram showing a flow of air when the second modification of the air conditioning system according to the first embodiment operates in a cooling mode.

FIG. 9 is a diagram showing a flow of air when a third modification of the air conditioning system according to the first embodiment operates in a heating mode.

FIG. 10 is a diagram showing a flow of air when the third modification of the air conditioning system according to the first embodiment operates in a cooling mode.

FIG. 11 is a diagram showing a flow of air when an air conditioning system according to a second embodiment operates in a heating mode.

FIG. 12 is a diagram showing a flow of air when the air conditioning system according to the second embodiment operates in a cooling mode.

FIG. 13 is a diagram showing a flow of air when a first modification of the air conditioning system according to the second embodiment operates in a heating mode.

FIG. 14 is a diagram showing a flow of air when the first modification of the air conditioning system according to the second embodiment operates in a cooling mode.

FIG. 15 is a diagram showing a flow of air when a second modification of the air conditioning system according to the second embodiment operates in a heating mode.

FIG. 16 is a diagram showing a flow of air when the second modification of the air conditioning system according to the second embodiment operates in a cooling mode.

FIG. 17 is a diagram showing a flow of air when a third modification of the air conditioning system according to the second embodiment operates in a heating mode.

FIG. 18 is a diagram showing a flow of air when the third modification of the air conditioning system according to the second embodiment operates in a cooling mode.

FIG. 19 is a diagram showing a flow of air when an air conditioning system according to a third embodiment operates in a heating mode.

FIG. 20 is a diagram showing a flow of air when the air conditioning system according to the third embodiment operates in a cooling mode.

FIG. 21 is a diagram showing a flow of air when a first modification of the air conditioning system according to the third embodiment operates in a heating mode.

FIG. 22 is a diagram showing a flow of air when the first modification of the air conditioning system according to the third embodiment operates in a cooling mode.

FIG. 23 is a diagram showing a flow of air when a second modification of the air conditioning system according to the third embodiment operates in a heating mode.

FIG. 24 is a diagram showing a flow of air when the second modification of the air conditioning system according to the third embodiment operates in a cooling mode.

FIG. 25 is a diagram showing a flow of air when a third modification of the air conditioning system according to the third embodiment operates in a heating mode.

FIG. 26 is a diagram showing a flow of air when the third modification of the air conditioning system according to the third embodiment operates in a cooling mode.

FIG. 27 is a diagram showing a flow of air when an air conditioning system according to a fourth embodiment operates in a heating mode.

FIG. 28 is a diagram showing a flow of air when the air conditioning system according to the fourth embodiment operates in a cooling mode.

FIG. 29 is a diagram showing a flow of air when a first modification of the air conditioning system according to the fourth embodiment operates in a heating mode.

FIG. 30 is a diagram showing a flow of air when the first modification of the air conditioning system according to the fourth embodiment operates in a cooling mode.

FIG. 31 is a diagram showing a flow of air when a second modification of the air conditioning system according to the fourth embodiment operates in a heating mode.

FIG. 32 is a diagram showing a flow of air when the second modification of the air conditioning system according to the fourth embodiment operates in a cooling mode.

FIG. 33 is a diagram showing a flow of air when a third modification of the air conditioning system according to the fourth embodiment operates in a heating mode.

FIG. 34 is a diagram showing a flow of air when the third modification of the air conditioning system according to the fourth embodiment operates in a cooling mode.

FIG. 35 is a diagram showing a flow of air when an air conditioning system according to a fifth embodiment operates in a heating mode.

FIG. 36 is a diagram showing a flow of air when the air conditioning system according to the fifth embodiment operates in a cooling mode.

FIG. 37 is a diagram showing a flow of air when a first modification of the air conditioning system according to the fifth embodiment operates in a heating mode.

FIG. 38 is a diagram showing a flow of air when the first modification of the air conditioning system according to the fifth embodiment operates in a cooling mode.

FIG. 39 is a diagram showing a flow of air when a second modification of the air conditioning system according to the fifth embodiment operates in a heating mode.

FIG. 40 is a diagram showing a flow of air when the second modification of the air conditioning system according to the fifth embodiment operates in a cooling mode.

FIG. 41 is a diagram showing a flow of air when a third modification of the air conditioning system according to the fifth embodiment operates in a heating mode.

FIG. 42 is a diagram showing a flow of air when the third modification of the air conditioning system according to the fifth embodiment operates in a cooling mode.

FIG. 43 is a diagram showing a flow of air when an air conditioning system according to a sixth embodiment operates in a heating mode.

FIG. 44 is a diagram showing a flow of air when the air conditioning system according to the sixth embodiment operates in a cooling mode.

FIG. 45 is a diagram showing a flow of air when a first modification of the air conditioning system according to the sixth embodiment operates in a heating mode.

FIG. 46 is a diagram showing a flow of air when the first modification of the air conditioning system according to the sixth embodiment operates in a cooling mode.

FIG. 47 is a diagram showing a flow of air when a second modification of the air conditioning system according to the sixth embodiment operates in a heating mode.

FIG. 48 is a diagram showing a flow of air when the second modification of the air conditioning system according to the sixth embodiment operates in a cooling mode.

FIG. 49 is a diagram showing a flow of air when a third modification of the air conditioning system according to the sixth embodiment operates in a heating mode.

FIG. 50 is a diagram showing a flow of air when the third modification of the air conditioning system according to the sixth embodiment operates in a cooling mode.

FIG. 51 is a schematic configuration diagram of a refrigeration cycle device according to a seventh embodiment.

FIG. 52 is a schematic configuration diagram of an air conditioning system according to an eighth embodiment.

### EMBODIMENTS FOR CARRYING OUT INVENTION

To begin with, examples of relevant techniques will be described. According to a comparative example, an air conditioning system includes a housing having a first air flow channel and a second air flow channel through which air flows toward a passenger compartment of a vehicle, and a door unit controls a flow of air flowing through the first air flow channel and the second air flow channel. The air conditioning system includes a flap member provided between the first air flow channel and the second air flow channel, a compressor that compresses a refrigerant, a first heat exchanger that cools air flowing through the first air flow channel, an expansion valve for expanding the refrigerant, and a second heat exchanger that heats air flowing through the second air flow channel. In the air conditioning system, the compressor, the first heat exchanger, the expansion valve, and the second heat exchanger constitute a refrigeration cycle. The first heat exchanger cools and dehumidifies air flowing through the first air flow channel toward the passenger compartment by exchanging heat with the refrigerant. The second heat exchanger heats air flowing through the second air flow channel toward the passenger compartment by exchanging heat with the refrigerant.

The air conditioning system rotates the door unit such that the air cooled and dehumidified in the first heat exchanger in the first air flow channel or the air heated in the second heat exchanger in the second air flow channel is blown toward the passenger compartment and an ambient environment of the passenger compartment. Further, in the air conditioning system, by opening the flap member, the air cooled and dehumidified in the first air flow channel and the air heated in the second air flow channel are mixed, and the heated and dehumidified air is blown toward the passenger compartment and the ambient environment of the passenger compartment.

Regarding the air conditioning system of the comparative example, inventors have studied to improve efficiency of the refrigeration cycle during operation of the air conditioning system to reduce energy consumption of the air conditioning system. For example, when the compressor that circulates the refrigerant in the refrigeration cycle is an electric compressor that operates according to rotation of an electric motor, the efficiency of the refrigeration cycle when the air conditioning system heats air to obtain required heating performance is affected by a rotation speed of the electric motor of the electric compressor. The rotation speed of the electric motor of the electric compressor is affected by a temperature and a flow rate of the refrigerant and air supplied to the heat exchanger for the air conditioning system to obtain the required heating performance.

For example, when the temperature of the refrigerant and the air flowing into the heat exchanger is constant, the higher the required heating performance of the air conditioning system, the greater the flow rate of the refrigerant and air per unit time introduced into the heat exchanger. Therefore, in order to satisfy the required heating performance, there is a method of increasing the rotation speed of the electric motor of the electric compressor to increase the flow rate of the refrigerant introduced into the heat exchanger per unit time.

However, according to intensive studies by the inventors, it has been found that efficiency of the electric compressor tends to deteriorate as the rotation speed of the electric motor increases in a high rotation range. It has been found that, when the refrigerant circulates in the refrigerant circuit, a pressure loss occurs, and the greater the flow rate of circulating refrigerant per unit time, the greater this pressure loss. Therefore, a method of increasing the flow rate per unit time of the refrigerant circulating in the refrigeration cycle by increasing the rotation speed of the electric motor of the electric compressor in order for the air conditioning system to satisfy the required heating performance may reduce efficiency of the refrigeration cycle.

In contrast, according to the present disclosure, an air conditioning system is capable of improving efficiency of a refrigeration cycle when heating air.

According to one aspect of the present disclosure, an air conditioning system is used for blowing heated air. The air conditioning system includes a casing. a bypass passage, an air blowing unit, and a refrigerant cycle. The casing includes an air introduction port configured to introduce air, an internal passage configured to guide the air introduced from the air introduction port to an inside of a compartment, and an external passage configured to guide the air introduced from the air introduction port to an outside of the compartment. The bypass passage is configured to guide air flowing through the internal passage to the external passage. The air blowing unit is configured to generate an air flow in the internal passage and the external passage. The refrigeration cycle includes an electric compressor configured to compress and discharge a refrigerant by an operation of an electric motor as a drive source, a first heat exchanger provided in the internal passage and configured to heat the air flowing in the internal passage by exchanging heat between the refrigerant discharged from the electric compressor and the air flowing in the internal passage, a decompressor configured to reduce a pressure of a refrigerant that has flowed out from the first heat exchanger, and a second heat exchanger provided in the external passage and configured to absorb heat from air flowing in the external passage by exchanging heat between a refrigerant that has flowed out from the decompressor and the air flowing in the external passage. The bypass passage includes an air flow upstream end disposed in the internal passage, and an air flow downstream end disposed in the external passage and upstream of a position of the second heat exchanger in the air flow in the external passage.

Accordingly, since air flowing through the internal passage is guided to an area upstream of the position of the second heat exchanger in the external passage via the bypass passage, a flow rate of air per unit time introduced into the second heat exchanger can be increased. Therefore, a heat absorption amount absorbed by the refrigerant introduced into the second heat exchanger from the air per unit time can be increased. Accordingly, since a temperature of the refrigerant flowing out of the second heat exchanger is increased and a pressure of the refrigerant is increased, a flow rate of the refrigerant flowing out of the second heat exchanger per unit time can be increased.

Therefore, compared with a configuration that does not have the bypass passage, a rotation speed of the electric motor of the electric compressor during operation of the air conditioning system can be reduced, so that efficiency of the refrigeration cycle can be improved.

According to another aspect of the present disclosure, an air conditioning system is used for blowing heated air. The air conditioning system includes a casing, a bypass passage, an air blowing unit, a refrigerant cycle, and a flow rate adjustment unit. The casing includes an air introduction port configured to introduce air, an internal passage configured to guide the air introduced from the air introduction port to an inside of a compartment, and an external passage configured to guide the air introduced from the air introduction port to an outside of the compartment. The bypass passage is configured to guide air flowing through the internal passage to the external passage. The bypass passage includes an air flow upstream end disposed in the external passage, and an air flow downstream end disposed in the internal passage. The air blowing unit is configured to generate an air flow in the internal passage and the external passage. The refrigeration cycle includes an electric compressor configured to compress and discharge a refrigerant by an operation of an electric motor as a drive source, a first heat exchanger provided in the internal passage and configured to heat air flowing in the internal passage by exchanging heat between the refrigerant discharged from the electric compressor and the air flowing in the internal passage, a decompressor configured to reduce a pressure of a refrigerant that has flowed out from the first heat exchanger, and a second heat exchanger provided in the external passage and configured to absorb heat from the air flowing in the external passage by exchanging heat between a refrigerant that has flowed out from the decompressor and the air flowing in the external passage. The flow rate adjustment unit is configured to adjust a flow rate of air flowing from the external passage to the internal passage via the bypass passage. The flow rate adjustment unit adjusts a temperature of the air flowing through the internal passage by adjusting the flow rate of the air flowing from the external passage to the internal passage via the bypass passage.

Accordingly, when the first heat exchanger changes a temperature of air to be heated and blown to the inside of the compartment by using air flowing through the external passage and discharged to the outside, the temperature of the air to be changed can be adjusted by the flow rate adjustment unit adjusting a flow rate of air flowing through the bypass passage.

Methods of adjusting the temperature of the air blown to the inside of the compartment includes a method in which two heat exchangers are provided in a flow channel through which the air blown into the compartment flows, as in the air conditioning system of the comparative example. However, when the refrigerant flows in the heat exchanger, a pressure loss occurs. Therefore, in the air conditioning system according to the present disclosure, when a heat exchanger for adjusting the temperature of the air in the internal passage is further provided separately from the first heat exchanger, the pressure loss when the refrigerant circulates in the refrigeration cycle increases as compared with a case where only the first heat exchanger is provided in the internal passage.

When the pressure loss increases when the refrigerant circulates, it becomes difficult for the refrigerant to circulate, so that it is necessary to increase the rotation speed of the electric motor of the electric compressor to compensate for the increase in pressure loss. Therefore, the heat exchanger provided in addition to the first heat exchanger for adjusting the temperature of the air in the internal passage may cause the increase in the pressure loss generated during circulation of the refrigerant in the refrigeration cycle, and the increase in the pressure loss causes deterioration in the efficiency of the refrigeration cycle.

In contrast, the air conditioning system of the present disclosure is capable of adjusting the temperature of the air heated by the first heat exchanger without providing a heat exchanger different from the first heat exchanger by adjusting a flow rate of air flowing through the bypass passage by the flow rate adjustment unit. Therefore, the rotation speed of the electric motor of the electric compressor can be reduced as compared with a configuration in which the heat exchanger for adjusting the temperature of the air in the internal passage is further provided in addition to the first heat exchanger, and the efficiency of the refrigeration cycle can be improved.

Hereinafter, multiple embodiments of the present disclosure will be described with reference to the drawings. Elements corresponding to or equivalent to each other among the embodiments are assigned the same numeral and their descriptions may be omitted. When only a part of a component is described in an embodiment, another part of the component can be relied on the component of a preceding embodiment. Furthermore, it is also possible to combine components from different embodiments, as long as the combination poses no difficulty, even if not explicitly described.

### First Embodiment

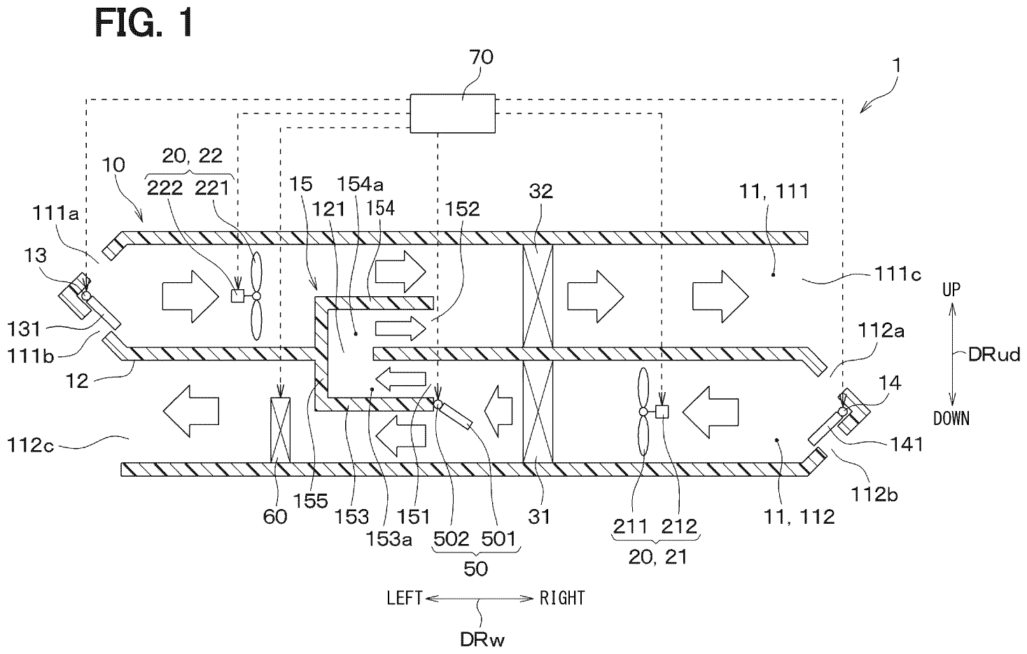

The present embodiment will be described with reference to FIGS. 1 to 4. In the present embodiment, an example in which an air conditioning system 1 that performs air conditioning inside a vehicle compartment is applied to a vehicle will be described. As shown in FIG. 1, the air conditioning system 1 includes a casing 10, air blowing units 20, a first heat exchanger 31, a second heat exchanger 32, a flow rate adjustment unit 50, a PTC heater 60, a control device 70, and the like. The air conditioning system 1 according to the present embodiment has a vapor compression type refrigeration cycle including the first heat exchanger 31, the second heat exchanger 32, and the like. The air conditioning system 1 is configured to heat an inside of the vehicle compartment by blowing air heated by a refrigerant that circulates in the refrigeration cycle, and cool the inside of the vehicle compartment by blowing air cooled by the refrigerant.

In the present embodiment, an arrow DRud shown in FIG. 1 and the like indicates an upper-lower direction when the air conditioning system 1 is disposed in the vehicle, and an arrow DRw indicates a left-right direction when the air conditioning system 1 is disposed in the vehicle. In the following description, an upper side in the upper-lower direction DRud may be simply referred to as an upper side, and a lower side in the upper-lower direction DRud may be simply referred to as a lower side. A right side in the left-right direction DRw may be simply referred to as a right side, and a left side in the left-right direction DRw may be simply referred to as a left side. A disposition state of the air conditioning system 1 according to the present disclosure is not limited to the directions indicated in the drawings.

The casing 10 forms an air passage 11 through which air supplied into the inside of the vehicle compartment flows. The casing 10 is provided in a hollow shape and is made of a material having a certain degree of elasticity and excellent strength (for example, polypropylene). The casing 10 accommodates the air blowing unit 20, the first heat exchanger 31, the second heat exchanger 32, the flow rate adjustment unit 50, the PTC heater 60, and the like. The casing 10 includes a passage partition portion 12 that partitions the air passage 11 in the upper-lower direction DRud. The air passage 11 is divided in the upper-lower direction DRud by the passage partition portion 12.

Specifically, the air passage 11 has an external passage 111 for guiding air introduced into the casing 10 to an outside of the vehicle compartment at the upper side in the upper-lower direction DRud of the passage partition portion 12, and has an internal passage 112 for guiding air introduced into the casing 10 to the inside of the vehicle compartment at the lower side in the upper-lower direction DRud.

That is, the air passage 11 is partitioned by the passage partition portion 12 such that the upper side in the upper-lower direction DRud is constituted by the external passage 111 and the lower side is constituted by the internal passage 112. In other words, the external passage 111 and the internal passage 112 are provided side by side in the upper-lower direction DRud via the passage partition portion 12 in the casing 10.

At a most upstream side of an air flow in the external passage 111 of the casing 10, an external outside air suction port 111a for introducing air outside the vehicle compartment (hereinafter, referred to as “outside air”) into the external passage 111 and an external inside air suction port 111b for introducing air inside the vehicle compartment (hereinafter, referred to as “inside air”) are provided. At a most downstream side of the air flow in the external passage 111 of the casing 10, an external opening 111c for guiding air, which is introduced into the external passage 111 from the external outside air suction port 111a and the external inside air suction port 111b, to an outside of the external passage 111 is provided.

The external outside air suction port 111a is provided outside the vehicle compartment, and is configured to allow suctioning of outside air. The external inside air suction port 111b is provided inside the vehicle compartment, and is configured to allow suctioning of inside air. The external opening 111c is connected to, for example, a duct (not shown) that opens to a drive device chamber that accommodates a drive device of the vehicle, and is configured to discharge the air that flows through the external passage 111 to the outside of the vehicle compartment via the duct.

Further, inside the casing 10, an external switching device 13 that switches air introduced into the external passage 111 between outside air and inside air is disposed at the most upstream side of the air flow in the external passage 111.

An internal outside air suction port 112a for introducing outside air into the internal passage 112 and an internal inside air suction port 112b for introducing inside air into the internal passage 112 are provided at a most upstream side of an air flow in the internal passage 112 of the casing 10. An internal opening 112c for guiding air, which is introduced into the internal passage 112 from the internal outside air suction port 112a and the internal inside air suction port 112b, to an outside of the internal passage 112 is provided at a most downstream side of the air flow in the internal passage 112 of the casing 10.

The internal outside air suction port 112a is provided outside the vehicle compartment, and is configured to allow suctioning of outside air. The internal inside air suction port 112b is provided inside the vehicle compartment, and is configured to allow suctioning of inside air. The internal opening 112c is connected to, for example, a duct (not shown) that communicates with a blowing port (not shown) provided in a dashboard inside the vehicle compartment, and is configured to blow air that flows through the internal passage 112 to the inside of the vehicle compartment via the duct.

The external outside air suction port 111a, the external inside air suction port 111b, the internal outside air suction port 112a, and the internal inside air suction port 112b function as air introduction ports for introducing air into the casing 10. Hereinafter, air introduced from the external outside air suction port 111a and the external inside air suction port 111b into the external passage 111 is also referred to as external blown air, and air introduced from the internal outside air suction port 112a and the internal inside air suction port 112b into the internal passage 112 is also referred to as internal blown air.

Further, inside the casing 10, an internal switching device 14 that switches air introduced into the internal passage 112 between outside air and inside air is disposed at the most upstream side of the air flow in the internal passage 112. A bypass passage 15 for guiding air flowing through the internal passage 112 to the external passage 111 is provided inside the casing 10. The bypass passage 15 is provided with the flow rate adjustment unit 50 that adjusts a flow rate of air flowing through the bypass passage 15. The bypass passage 15 and the flow rate adjustment unit 50 will be described in detail later.

The external passage 111 is an air flow channel for guiding air introduced from the external outside air suction port 111a and the external inside air suction port 111b to the outside of the vehicle compartment, and is provided along the left-right direction DRw. An upstream side of the external passage 111 communicates with the external outside air suction port 111a and the external inside air suction port 111b, and a downstream side communicates with the external opening 111c.

The internal passage 112 is an air flow channel for guiding air introduced from the internal outside air suction port 112a and the internal inside air suction port 112b to the inside of the vehicle compartment, and is provided along the left-right direction DRw. An upstream side of the internal passage 112 communicates with the internal outside air suction port 112a and the internal inside air suction port 112b, and a downstream side communicates with the internal opening 112c.

The passage partition portion 12 has a flat plate shape having a plate surface in the upper-lower direction DRud, and is molded integrally with the casing 10. The passage partition portion 12 extends along the left-right direction DRw from an end portion on one side of the casing 10 to an end portion on the other side in the left-right direction DRw. A through hole 121 forming a part of the bypass passage 15, which will be described later, is provided in the passage partition portion 12. The through hole 121 penetrates the passage partition portion 12 in the upper-lower direction DRud, and allows the external passage 111 and the internal passage 112 to communicate with each other.

The external switching device 13 includes a plate-shaped external switching door 131, and switches a suction port to be opened of the external outside air suction port 111a and the external inside air suction port 111b by the external switching door 131. The external switching device 13 switches air introduced into the external passage 111 to either the outside air or the inside air by switching the suction port to be opened by rotating the external switching door 131 about one end side of the external switching door 131. The external switching door 131 is driven by an electric actuator (not shown) for the external switching door 131. An operation of the electric actuator is controlled by a control signal output from the control device 70.

The internal switching device 14 includes a plate-shaped internal switching door 141, and switches a suction port to be opened of the internal outside air suction port 112a and the internal inside air suction port 112b by the internal switching door 141. The internal switching device 14 switches air introduced into the internal passage 112 to either the outside air or the inside air by switching the suction port to be opened by rotating the internal switching door 141 about one end side of the internal switching door 141. The internal switching door 141 is driven by an electric actuator (not shown) for the internal switching door 141. An operation of the electric actuator is controlled by a control signal output from the control device 70.

The air blowing unit 20 that generates an air flow in the air passage 11 is accommodated inside the air passage 11. Specifically, an external air blowing unit 22 that generates an air flow in the external passage 111 is accommodated inside the external passage 111, and an internal air blowing unit 21 that generates an air flow in the internal passage 112 is accommodated inside the internal passage 112. Inside the external passage 111, the second heat exchanger 32 that exchanges heat between air flowing through the external passage 111 and the refrigerant is accommodated in a space downstream of the external air blowing unit 22.

Inside the internal passage 112, the PTC heater 60 that heats air flowing through the internal passage 112 and the first heat exchanger 31 that exchanges heat between air flowing through the internal passage 112 and the refrigerant is accommodated in a space downstream of the internal air blowing unit 21. The external air blowing unit 22 is provided upstream of a position of the second heat exchanger 32 in air flow in the external passage 111. Further, the external air blowing unit 22 is provided upstream of a downstream opening 152 in air flow in the bypass passage 15 described later.

The internal air blowing unit 21 is provided upstream of positions of the first heat exchanger 31 and the PTC heater 60 in air flow in the internal passage 112. Further, the internal air blowing unit 21 is provided upstream of an upstream opening 151 in air flow in the bypass passage 15 described later.

The internal air blowing unit 21 and the external air blowing unit 22 are blowers that generate an air flow in the air passage 11 by suctioning air and blowing the suctioned air. The internal air blowing unit 21 and the external air blowing unit 22 according to the present embodiment are implemented with, for example, axial flow fans that blow air suctioned from a direction along a fan axis in a direction along a fan axis.

The internal air blowing unit 21 includes an internal blower fan 211 that rotates to generate an air flow, and an internal motor 212 that rotates the internal blower fan 211. The internal air blowing unit 21 is an electric blower that drives the internal blower fan 211 with the internal motor 212. The internal blower fan 211 has an axis disposed along the left-right direction DRw. The internal blower fan 211 is rotated by a drive force transmitted from the internal motor 212, thereby blowing the suctioned internal blown air toward an area downstream of the internal passage 112. The internal blower fan 211 and the internal motor 212 are provided upstream of the position of the first heat exchanger 31 in air flow in the internal passage 112.

The internal air blowing unit 21 according to the present embodiment is disposed such that air flows from the right side to the left side in the internal passage 112 by pushing air suctioned from a right side of the internal blower fan 211 toward a left side by rotation of the internal blower fan 211. Therefore, the internal air blowing unit 21 generates an air flow so that the internal blown air flows from the right side to the left side in the internal passage 112, and blows the internal blown air from the internal opening 112c.

The internal motor 212 is electrically connected to the control device 70. A rotation speed (that is, air blowing capacity) is controlled by a control voltage transmitted from the control device 70.

The external air blowing unit 22 includes an external blower fan 221 that rotates to generate an air flow, and an external motor 222 that rotates the external blower fan 221. The external air blowing unit 22 is an electric blower that drives the external blower fan 221 with the external motor 222. The external blower fan 221 has an axis disposed along the left-right direction DRw. The external blower fan 221 is rotated by a drive force transmitted from the external motor 222, thereby blowing the suctioned external blown air toward an area downstream of the external passage 111. The external blower fan 221 and the external motor 222 are provided upstream of the position of the second heat exchanger 32 in air flow in the external passage 111.

The external air blowing unit 22 according to the present embodiment is disposed such that air flows from the left side to the right side in the external passage 111 by pushing air suctioned from a left side of the external blower fan 221 toward a right side by rotation of the external blower fan 221. Therefore, the external air blowing unit 22 generates an air flow so that the external blown air flows from the left side to the right side in the external passage 111, and blows the external blown air from the external opening 111c.

The internal air blowing unit 21 and the external air blowing unit 22 according to the present embodiment are disposed such that a direction of air flowing through the internal passage 112 is opposite to a direction of air flowing through the external passage 111. In other words, the air flowing through the internal passage 112 and the air flowing through the external passage 111 flow in opposite directions in the left-right direction DRw.

The external motor 222 is electrically connected to the control device 70. A rotation speed (that is, air blowing capacity) is controlled by a control voltage transmitted from the control device 70.

The internal air blowing unit 21 and the external air blowing unit 22 operate independently of each other according to control voltages transmitted from the control device 70 to the internal motor 212 and the external motor 222, respectively. Therefore, the internal air blowing unit 21 and the external air blowing unit 22, for example, the internal blower fan 211 and the external blower fan 221, are capable of rotating at different rotation speeds from each other.

The internal air blowing unit 21 that generates an air flow in the internal passage 112 and the external air blowing unit 22 that generates an air flow in the external passage 111 are not limited to the axial flow fan. The internal air blowing unit 21 and the external air blowing unit 22 may be implemented by, for example, a centrifugal fan or a mixed flow fan. The internal air blowing unit 21 and the external air blowing unit 22 may be implemented by, for example, blower fans having different configurations, such as one being an axial flow fan and the other being a centrifugal fan.

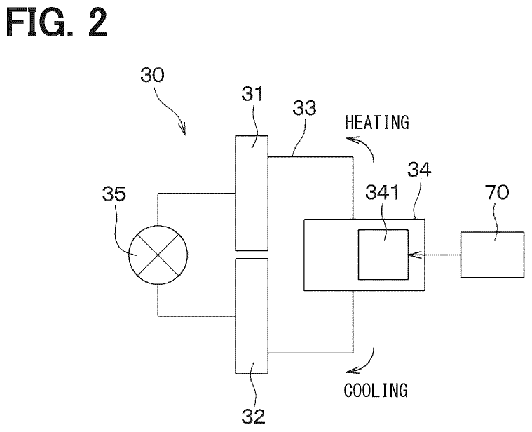

As shown in FIG. 2, the first heat exchanger 31 and the second heat exchanger 32 constitute a vapor compression type refrigeration cycle device 30 together with a refrigerant circuit 33, an electric compressor 34, and a decompressor 35. The refrigeration cycle device 30 adopts, for example, an HFO refrigerant (specifically, R1234yf) as a refrigerant, and constitutes a vapor compression type subcritical refrigeration cycle in which a pressure of a refrigerant discharged from the electric compressor 34 does not exceed a critical pressure of the refrigerant. The refrigeration cycle device 30 according to the present embodiment constitutes a heat pump cycle capable of switching a flowing direction of the refrigerant flowing through the refrigerant circuit 33. As the refrigerant, an HFC-based refrigerant (for example, R134a) or a natural refrigerant (for example, carbon dioxide) may be used.

The electric compressor 34 compresses and discharges the refrigerant sucked into the refrigeration cycle device 30. The electric compressor 34 is an electric compressor having an electric motor 341 as a drive source and a fixed capacity type compression mechanism (not shown) that is driven by the electric motor 341 and has a fixed discharge capacity. In the electric compressor 34, a rotation speed of the electric motor 341 (that is, refrigerant discharge capacity) is controlled by a control voltage output from the control device 70. Hereinafter, rotation of the electric motor 341 of the electric compressor 34 may be simply referred to as rotation of the electric compressor 34.

In the electric compressor 34 according to the present embodiment, a rotation direction of the electric motor 341 is configured to be switched between a forward rotation direction and a reverse rotation direction by a control voltage output from the control device 70. Accordingly, the electric compressor 34 according to the present embodiment is capable of switching a flowing direction of the refrigerant flowing through the refrigerant circuit 33 by switching the rotation direction of the electric motor 341. The electric compressor 34 guides a high-temperature and high-pressure refrigerant discharged by forward rotation of the electric motor 341 to the first heat exchanger 31 when the air conditioning system 1 operates in a heating mode to heat the inside of the vehicle compartment. The electric compressor 34 guides a high-temperature and high-pressure refrigerant discharged by reverse rotation of the electric motor 341 to the second heat exchanger 32 when the air conditioning system 1 operates in a cooling mode to cool the inside of the vehicle compartment.

The first heat exchanger 31 is disposed in the internal passage 112, and is a heat exchange device that exchanges heat between a refrigerant flowing inside the first heat exchanger 31 and air flowing through the internal passage 112. The first heat exchanger 31 is provided downstream of the internal air blowing unit 21 in air flow in the internal passage 112, and air pushed out from the internal blower fan 211 is introduced into the first heat exchanger 31. Accordingly, the first heat exchanger 31 heats and cools the internal blown air by exchanging heat between the refrigerant flowing inside the first heat exchanger 31 and air flowing from the right side to the left side in the internal passage 112.

Specifically, when the air conditioning system 1 operates in the heating mode, the first heat exchanger 31 heats the air flowing through the internal passage 112 by exchanging heat between the high-temperature and high-pressure refrigerant discharged from the electric compressor 34 and the internal blown air. When the air conditioning system 1 operates in the cooling mode, the first heat exchanger 31 absorbs heat from the internal blown air by utilizing latent heat of vaporization when a low-temperature and low-pressure refrigerant before being introduced into the electric compressor 34 evaporates, and cools the air.

That is, when the air conditioning system 1 operates in the heating mode, the first heat exchanger 31 functions as a condenser that condenses the high-temperature and high-pressure refrigerant discharged from the electric compressor 34 by exchanging heat with the air flowing through the internal passage 112. In contrast, when the air conditioning system 1 operates in the cooling mode, the first heat exchanger 31 functions as an evaporator that evaporates the low-temperature and low-pressure refrigerant before being introduced into the electric compressor 34 by exchanging heat with the air flowing through the internal passage 112.

The first heat exchanger 31 is disposed over substantially an entire passage cross section of a portion where the first heat exchanger 31 is disposed in the internal passage 112. Accordingly, the first heat exchanger 31 exchanges heat of substantially all air flowing through the internal passage 112. The first heat exchanger 31 is provided upstream of the bypass passage 15 described later in air flow.

The decompressor 35 and the second heat exchanger 32 are connected in this order at a refrigerant flow downstream side of the first heat exchanger 31 in the refrigeration cycle in which the air conditioning system 1 operates in the heating mode. That is, the decompressor 35 is provided between the first heat exchanger 31 and the second heat exchanger 32. The decompressor 35 is connected to a refrigerant flow downstream side of the second heat exchanger 32 in the refrigeration cycle in which the air conditioning system 1 operates in the cooling mode.

The decompressor 35 is an expansion valve that decompresses and expands the refrigerant flowing out of the first heat exchanger 31 or the second heat exchanger 32. The decompressor 35 is electrically connected to the control device 70, and is configured to control a valve opening degree by a control signal transmitted from the control device 70. When the air conditioning system 1 operates in the heating mode, the decompressor 35 decompresses and expands the refrigerant supplied from the first heat exchanger 31 to the second heat exchanger 32, supplies the refrigerant to the second heat exchanger 32 as a gas-liquid two-phase state at a low temperature and a low pressure, and adjusts a flow rate of the refrigerant. When the air conditioning system 1 operates in the cooling mode, the decompressor 35 decompresses and expands the refrigerant supplied from the second heat exchanger 32 to the first heat exchanger 31, supplies the refrigerant to the first heat exchanger 31 as a gas-liquid two-phase state at a low temperature and a low pressure, and adjusts a flow rate of the refrigerant. The decompressor 35 may be, for example, a capillary tube and an orifice.

The second heat exchanger 32 is disposed in the external passage 111, and is a heat exchange device that exchanges heat between a refrigerant flowing inside the second heat exchanger 32 and air flowing through the external passage 111. The second heat exchanger 32 is provided downstream of the external air blowing unit 22 in air flow in the external passage 111, and air pushed out from the external blower fan 221 is introduced into the second heat exchanger 32. Accordingly, the second heat exchanger 32 heats and cools the external blown air by exchanging heat between the refrigerant flowing inside the second heat exchanger 32 and air flowing from the left side to the right side in the external passage 111.

Specifically, when the air conditioning system 1 operates in the heating mode, the second heat exchanger 32 absorbs heat from the external blown air by using latent heat of vaporization when a low-temperature and low-pressure refrigerant before being introduced into the electric compressor 34 evaporates. When the air conditioning system 1 operates in the cooling mode, the second heat exchanger 32 causes the refrigerant to release heat by exchanging heat between the high-temperature and high-pressure refrigerant discharged from the electric compressor 34 and the external blown air.

That is, when the air conditioning system 1 operates in the heating mode, the second heat exchanger 32 functions as an evaporator that evaporates the low-temperature and low-pressure refrigerant before being introduced into the electric compressor 34 by exchanging heat with the air flowing through the external passage 111. In contrast, when the air conditioning system 1 operates in the cooling mode, the second heat exchanger 32 functions as a condenser that condenses the high-temperature and high-pressure refrigerant discharged from the electric compressor 34 by exchanging heat with the air flowing through the external passage 111.

The second heat exchanger 32 is disposed over substantially an entire passage cross section of a portion where the second heat exchanger 32 is disposed in the external passage 111. Accordingly, the second heat exchanger 32 exchanges heat of substantially all the air flowing through the external passage 111. The second heat exchanger 32 is provided downstream of the bypass passage 15 described later in air flow.

Disposition positions of the first heat exchanger 31 and the second heat exchanger 32 overlap each other in the left-right direction DRw. The first heat exchanger 31 and the second heat exchanger 32 are disposed side by side along the upper-lower direction DRud with the passage partition portion 12 in between. That is, the first heat exchanger 31 is disposed at a lower side of the second heat exchanger 32 in the upper-lower direction DRud.

In the refrigeration cycle device 30 configured as described above, when the air conditioning system 1 operates in the heating mode, the refrigerant that circulates in the refrigerant circuit 33 flows in an order of the electric compressor 34, the first heat exchanger 31, the decompressor 35, and the second heat exchanger 32. When the air conditioning system 1 operates in the cooling mode, the refrigerant that circulates in the refrigerant circuit 33 flows in an order of the electric compressor 34, the second heat exchanger 32, the decompressor 35, and the first heat exchanger 31. The PTC heater 60 is provided downstream of the first heat exchanger 31 in air flow in the internal passage 112.

The PTC heater 60 is a heater that generates heat according to supplied electric power and heats the air passed through the first heat exchanger 31 in the internal passage 112. The PTC heater 60 heats the air passed through the first heat exchanger 31 and lowers relative humidity of the air passed through the first heat exchanger 31. An operation of the PTC heater 60 is controlled by a control signal output from the control device 70.

The control device 70 is implemented by a microcomputer including a storage unit such as a CPU, ROM, and RAM, and a peripheral circuit thereof, and is an air conditioner ECU that controls operations of components of the air conditioning system 1. The ECU is an abbreviation for Electronic Control Unit. The control device 70 performs various calculations and processes based on an air conditioning control program stored in the ROM, and controls operations of components connected to an output side thereof. The ROM and the RAM of the control device 70 are implemented by non-transitory tangible storage media.

Although not shown, the air conditioning system 1 includes a pressure sensor for detecting a pressure of the refrigerant discharged from the electric compressor 34, a suction port temperature sensor for detecting a temperature of the air introduced into the external passage 111 and the internal passage 112, a vehicle interior temperature sensor for detecting a temperature inside the vehicle compartment, and the like. Although not shown, the air conditioning system 1 includes a heat exchanger temperature sensor for detecting a temperature of the air passed through the first heat exchanger 31 and a temperature of the air passed through the second heat exchanger 32, a vehicle exterior temperature sensor for detecting a temperature outside the vehicle compartment, and a solar radiation sensor for detecting an amount of solar radiation. These sensor groups are electrically connected to the control device 70 and transmit detection signals to the control device 70 according to detection results.

The control device 70 controls rotation speeds of the electric motor 341 of the electric compressor 34, the internal motor 212 of the internal air blowing unit 21, and the external motor 222 of the external air blowing unit 22 based on information input from the sensor groups and temperature information set by an operation of an operator. The control device 70 controls the rotation speeds of the electric motor 341 of the electric compressor 34 independently of each other, the internal motor 212 of the internal air blowing unit 21, and the external motor 222 of the external air blowing unit 22. The control device 70 controls operations of the external switching device 13, the internal switching device 14, the PTC heater 60, and the flow rate adjustment unit 50 based on information input from the sensor groups and temperature information set by an operation of the operator.

When the air conditioning system 1 operates in the heating mode, the control device 70 determines rotation speeds of the motors based on temperature information set by an operation of the operator. That is, the rotation speeds of the electric motor 341, the internal motor 212, and the external motor 222 are set at rotation speeds necessary for obtaining required heating performance that is set by an operation of the operator when the air conditioning system 1 operates in the heating mode. The rotation speeds of the electric motor 341, the internal motor 212, and the external motor 222 are set at rotation speeds necessary for obtaining required cooling performance that is set by an operation of the operator when the air conditioning system 1 operates in the cooling mode.

The control device 70 according to the present embodiment functions as a motor control device that controls an operation of the electric motor 341, and functions as a blowing control device that controls operations of the internal air blowing unit 21 and the external air blowing unit 22.

Next, the bypass passage 15 and the flow rate adjustment unit 50 will be described. The bypass passage 15 forms an air flow channel for guiding a part of the air flowing through the internal passage 112 to the external passage 111, and is provided in a hollow shape. The bypass passage 15 is molded integrally with the casing 10. A part of the bypass passage 15 is formed by the passage partition portion 12.

The bypass passage 15 has an air flow channel having one end communicating with the internal passage 112, and the other end communicating with the external passage 111. Specifically, in the bypass passage 15, an air flow upstream end of the air flow channel is disposed in the internal passage 112, and an air flow downstream end is disposed in the external passage 111. In the bypass passage 15, the air flow upstream end communicates with the air flow downstream end via the through hole 121 formed in the passage partition portion 12.

The bypass passage 15 has a substantially U-shape, and has a shape in which a flow direction of air introduced into the bypass passage 15 from an opening on one end side is reversed and guided to an opening on the other end side. The bypass passage 15 includes the upstream opening 151 that opens into the internal passage 112 and introduces the air flowing through the internal passage 112, and the downstream opening 152 that opens into the external passage 111 and blows the air introduced from the upstream opening 151 to the external passage 111. Of air flow channels formed by the bypass passage 15, the bypass passage 15 includes an upstream passage portion 153 forming an upstream passage 153a disposed at an internal passage 112 side and a downstream passage portion 154 forming a downstream passage 154a disposed at an external passage 111 side. The bypass passage 15 further includes a bypass bottom portion 155 connecting the upstream passage portion 153 and the downstream passage portion 154. The upstream passage portion 153, the downstream passage portion 154, and the bypass bottom portion 155 are integrally molded.

The upstream passage portion 153 extends in parallel with the passage partition portion 12 along the left-right direction DRw from a position at a right side of the through hole 121 of the passage partition portion 12 to a left end portion of the through hole 121 in the internal passage 112. That is, a part of the upstream passage portion 153 overlaps the passage partition portion 12 in the upper-lower direction DRud, and the overlapping part faces a lower plate surface of the passage partition portion 12.

The downstream passage portion 154 extends in parallel with the passage partition portion 12 along the left-right direction DRw from a position at the right side of the through hole 121 of the passage partition portion 12 to the left end portion of the through hole 121 in the external passage 111. That is, a part of the downstream passage portion 154 overlaps the passage partition portion 12 in the upper-lower direction DRud, and the overlapping part faces an upper plate surface of the passage partition portion 12.

The upstream passage portion 153 and the downstream passage portion 154 have the same size in the left-right direction DRw, and overlap in the upper-lower direction DRud. The upstream passage portion 153 and the downstream passage portion 154 are connected to each other at left end portions by the bypass bottom portion 155.

The bypass bottom portion 155 extends along the upper-lower direction DRud from the left end portion of the upstream passage portion 153 to the left end portion of the downstream passage portion 154. That is, the bypass bottom portion 155 extends along the upper-lower direction DRud from the internal passage 112 to the external passage 111.

The upstream opening 151 is an opening formed by a right end portion of the upstream passage portion 153 and the lower plate surface of the passage partition portion 12. The upstream opening 151 opens toward the right side in the left-right direction DRw. That is, the upstream opening 151 faces the air flow upstream side in the internal passage 112.

The upstream opening 151 is disposed downstream of the position of the first heat exchanger 31 in air flow in the internal passage 112. The upstream opening 151 faces an air blowing side in the first heat exchanger 31.

The upstream opening 151 faces an air blowing side in the internal blower fan 211 via the first heat exchanger 31. In other words, the upstream opening 151 opens toward the air blowing side in the internal blower fan 211 via the first heat exchanger 31.

The downstream opening 152 is an opening formed by a right end portion of the downstream passage portion 154 and the upper plate surface of the passage partition portion 12. The downstream opening 152 opens toward the right side in the left-right direction DRw. That is, the downstream opening 152 faces the air flow downstream side in the external passage 111.

The downstream opening 152 is disposed upstream of the position of the second heat exchanger 32 in air flow in the external passage 111. The downstream opening 152 faces an air suction side in the second heat exchanger 32.

The downstream opening 152 is provided downstream of the external blower fan 221 in air flow and does not face the external blower fan 221. In other words, the downstream opening 152 does not open toward the external blower fan 221.

Air pushed out from the internal blower fan 211 and passed through the first heat exchanger 31 is introduced into the above-described bypass passage 15 from the upstream opening 151. The air introduced from the upstream opening 151 flows from the right side to the left side through the upstream passage 153a, and is reversed in flow direction by the bypass bottom portion 155 to be introduced into the downstream passage 154a through the through hole 121 formed in the passage partition portion 12. The air introduced into the downstream passage 154a flows through the downstream passage 154a from the left side to the right side, and is blown from the downstream opening 152 to the external passage 111.

Accordingly, when the air conditioning system 1 operates in the heating mode, a part of the air flowing through the internal passage 112 heated by the first heat exchanger 31 is guided to the external passage 111 via the bypass passage 15. That is, when the air conditioning system 1 operates in the heating mode, a part of the air heated by the first heat exchanger 31 flows into the external passage 111.

When the air conditioning system 1 operates in the cooling mode, a part of the air flowing through the internal passage 112 cooled by the first heat exchanger 31 is guided to the external passage 111 via the bypass passage 15. That is, when the air conditioning system 1 operates in the cooling mode, a part of the air cooled by the first heat exchanger 31 flows into the external passage 111.

The bypass passage 15 is provided with the flow rate adjustment unit 50 that adjusts a flow rate of air flowing through the bypass passage 15 in the upstream opening 151. The flow rate adjustment unit 50 adjusts a flow rate of air introduced from the upstream opening 151 into the bypass passage 15.

The flow rate adjustment unit 50 includes a flow rate adjustment door 501 for changing an opening area of the upstream opening 151 and an electric actuator 502 for changing a rotation angle of the flow rate adjustment door 501. The flow rate adjustment unit 50 changes a flow rate of air introduced from the upstream opening 151 to the bypass passage 15 by continuously changing the opening area of the upstream opening 151 by the flow rate adjustment door 501. The electric actuator 502 is an actuator unit that changes a posture of the flow rate adjustment door 501, and is implemented by, for example, an electric motor. The flow rate adjustment door 501 functions as a flow channel adjustment unit that changes a flow channel area of an air flow most upstream side portion of the bypass passage 15.

That is, the flow rate adjustment unit 50 adjusts an opening degree of the flow rate adjustment door 501 to adjust a flow rate of the heated and cooled air introduced from the internal passage 112 to the external passage 111 via the bypass passage 15. The flow rate adjustment unit 50 is configured to adjust an opening degree of the upstream opening 151 in a range from fully closed (that is, 0%) to full opening (that is, 100%) by rotating the flow rate adjustment door 501.

The electric actuator 502 that changes the rotation angle of the flow rate adjustment door 501 is electrically connected to the control device 70, and a rotation angle thereof is controlled by a control voltage output from the control device 70.

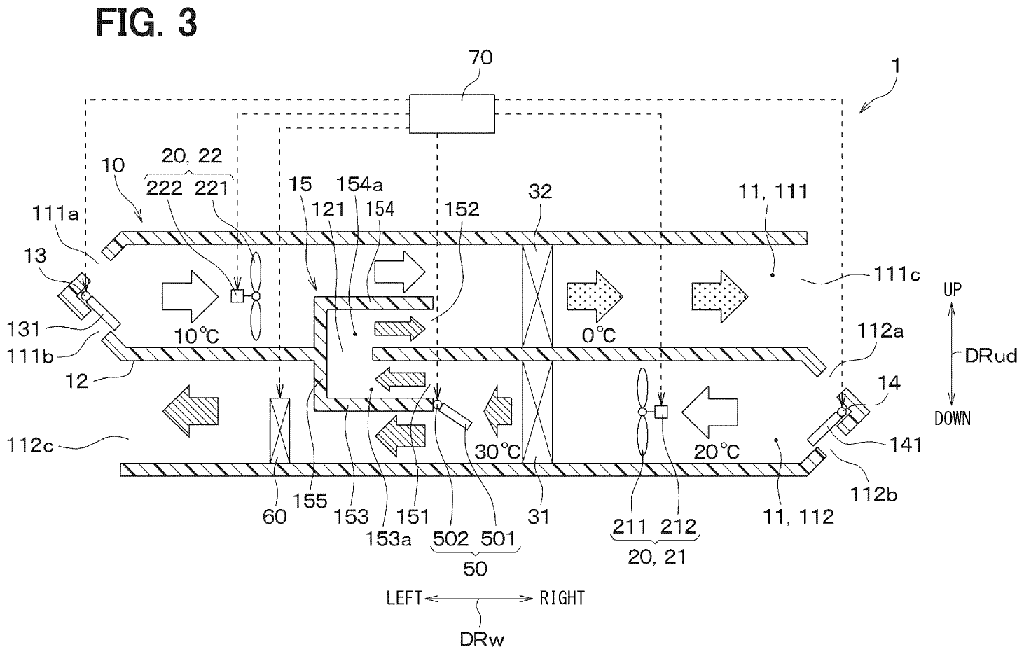

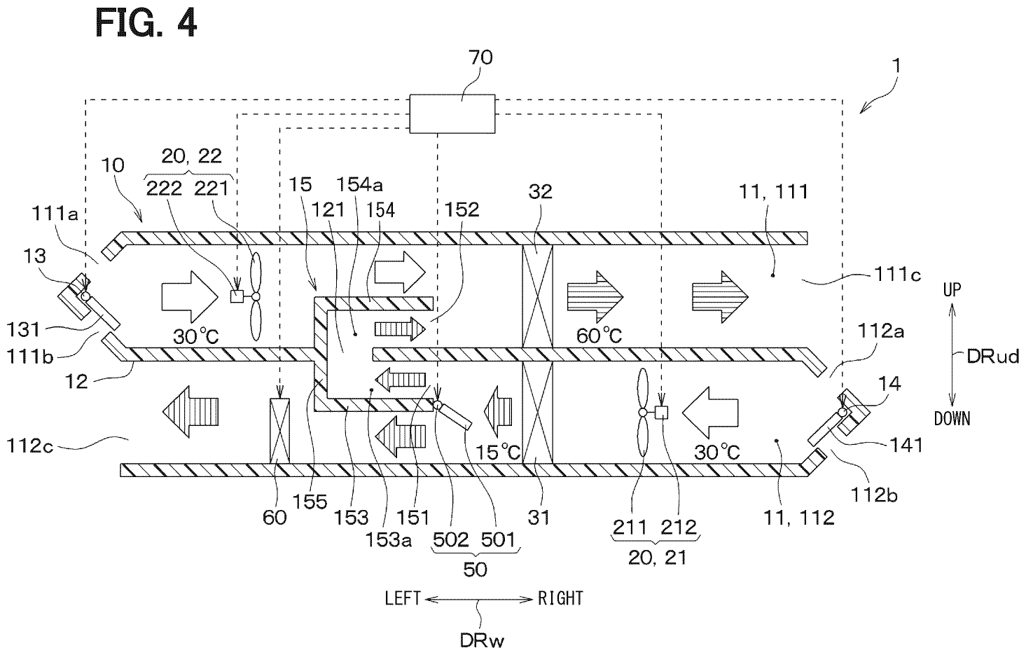

Next, an operation of the air conditioning system 1 according to the present embodiment will be described with reference to FIGS. 3 and 4. When the internal blower fan 211 of the internal air blowing unit 21 rotates according to a control signal transmitted from the control device 70, air is introduced into the internal passage 112 from either the internal outside air suction port 112a or the internal inside air suction port 112b. The air introduced from the internal outside air suction port 112a and the internal inside air suction port 112b and suctioned into the internal blower fan 211 is pushed out from the internal blower fan 211 and flows from the right side to the left side in the area downstream of the internal blower fan 211 in air flow in the internal passage 112.

When the external blower fan 221 of the external air blowing unit 22 rotates according to a control signal transmitted from the control device 70, air is introduced into the external passage 111 from either the external outside air suction port 112a or the external inside air suction port 112b. The air introduced from the internal outside air suction port 112a and the internal inside air suction port 112b and suctioned into the external blower fan 221 is pushed out from the external blower fan 221 and flows from the left side to the right side in the area downstream of the external blower fan 221 in the external passage 111.

When the air conditioning system 1 operates in the heating mode, in the refrigeration cycle device 30, the refrigerant flows in the order of the electric compressor 34, the first heat exchanger 31, the decompressor 35, and the second heat exchanger 32.

The first heat exchanger 31 exchanges heat between the high-temperature and high-pressure refrigerant discharged from the electric compressor 34 and the air flowing through the internal passage 112 to heat the air. Therefore, as shown in FIG. 3, the air flowing in the area downstream of the first heat exchanger 31 in the internal passage 112 is heated to a temperature higher than before flowing into the first heat exchanger 31, and passes through the first heat exchanger 31.

The second heat exchanger 32 absorbs heat from the air flowing through the external passage 111 by utilizing latent heat of vaporization when the low-temperature and low-pressure refrigerant before being introduced into the electric compressor 34 evaporates. Therefore, as shown in FIG. 3, the air flowing in the area downstream of the second heat exchanger 32 in the external passage 111 is cooled to a temperature lower than before flowing into the second heat exchanger 32, and passes through the second heat exchanger 32.

Among arrows in the diagram showing the operation in the heating mode shown in FIG. 3, arrows hatched with diagonal lines indicate a flow of air heated by the first heat exchanger 31. Among the arrows in the diagram showing the operation in the heating mode shown in FIG. 3, arrows hatched with dots indicate a flow of air whose heat has been absorbed by the second heat exchanger 32. In the drawings showing the operation of the heating mode in each of the following embodiments, arrows hatched with diagonal lines indicate a flow of air heated by the first heat exchanger 31, and arrows hatched with dots indicate a flow of air whose heat has been absorbed by the second heat exchanger 32.

The air that has passed through the second heat exchanger 32 and has been cooled flows in the area downstream of the second heat exchanger 32 in the external passage 111 in air flow, and is discharged to the outside of the vehicle compartment via the external opening 111c.

When the flow rate adjustment unit 50 is in an open state, the air that has passed through the first heat exchanger 31 and has been heated flows in the area downstream side of the first heat exchanger 31 in the internal passage 112, and a part thereof is introduced into the bypass passage 15 from the upstream opening 151.

In contrast, of air that has passed through the first heat exchanger 31 and has been heated, air that is not introduced into the bypass passage 15 flows through the area downstream of the bypass passage 15 in air flow. Alternatively, when the flow rate adjustment unit 50 is in a fully closed state, all air that has passed through the first heat exchanger 31 and has been heated bypasses the bypass passage 15 and flows through the area downstream of the bypass passage 15 in air flow.

When the PTC heater 60 is operating, the air that has bypassed the bypass passage 15 is further heated by the PTC heater 60, has relative humidity lowered, and is blown into the vehicle compartment through the internal opening 112c. Accordingly, by blowing air having lower relative humidity than air inside the vehicle compartment into the vehicle compartment, the inside of the vehicle compartment can be heated and dehumidified, and a window inside the vehicle compartment can be defogged. In contrast, when the PTC heater 60 is not operating, the air bypassed the bypass passage 15 is blown into the vehicle compartment via the internal opening 112c without being heated by the PTC heater 60.

The air introduced into the bypass passage 15 flows from the right side to the left side through the upstream passage 153a, and is reversed in flow direction by the bypass bottom portion 155 to be introduced into the downstream passage 154a through the through hole 121 of the passage partition portion 12. The air introduced into the downstream passage 154a flows through the downstream passage 154a from the left side to the right side, and is blown from the downstream opening 152 to the area downstream of the bypass passage 15 in the external passage 111. The air blown from the downstream opening 152 to the external passage 111 is mixed with air introduced from the external outside air suction port 111a and the external inside air suction port 111b in an area upstream of the second heat exchanger 32, and flows toward the second heat exchanger 32.

Thus, a part of the air heated by the first heat exchanger 31 is guided to the air flow upstream side of the second heat exchanger 32 in the external passage 111 via the bypass passage 15. Therefore, a flow rate of air introduced into the second heat exchanger 32 increases by an amount of air introduced from the internal passage 112 to the external passage 111 via the bypass passage 15.

A temperature of the air introduced from the external outside air suction port 111a and the external inside air suction port 111b is increased by being mixed with the air heated by the first heat exchanger 31. Therefore, a temperature of the air introduced into the second heat exchanger 32 increases by an amount of heat corresponding to a flow rate of the air introduced from the internal passage 112 to the external passage 111 via the bypass passage 15.

The flow rate adjustment unit 50 adjusts the opening degree of the upstream opening 151 according to an amount of heat absorbed by the refrigerant from the air in the first heat exchanger 31, and adjusts the flow rate of the air introduced from the internal passage 112 to the external passage 111 via the bypass passage 15. For example, the flow rate adjustment unit 50 may increase the opening degree of the upstream opening 151 as the amount of heat absorbed by the refrigerant from the air in the first heat exchanger 31 increases. The flow rate adjustment unit 50 may decrease the opening degree of the upstream opening 151 as the amount of heat absorbed by the refrigerant from the air in the first heat exchanger 31 is smaller.

The flow rate adjustment unit 50 adjusts a flow rate of air flowing from the external passage 111 to the internal passage 112 via the bypass passage 15 to adjust a temperature of air introduced into the second heat exchanger 32.

When the air conditioning system 1 operates in the cooling mode, in the refrigeration cycle device 30, the refrigerant flows in the order of the electric compressor 34, the second heat exchanger 32, the decompressor 35, and the first heat exchanger 31.

The second heat exchanger 32 exchanges heat between a high-temperature and high-pressure refrigerant discharged from the electric compressor 34 and air flowing through the external passage 111, thereby releasing heat of the refrigerant to the air flowing through the external passage 111. Therefore, as shown in FIG. 4, the air flowing in the area downstream of the second heat exchanger 32 in air flow in the external passage 111 is heated as compared with before flowing into the second heat exchanger 32 and passes through the second heat exchanger 32.

The first heat exchanger 31 absorbs heat from the air flowing through the internal passage 112 by utilizing latent heat of vaporization when the low-temperature and low-pressure refrigerant before being introduced into the electric compressor 34 evaporates to cool the air. Therefore, as shown in FIG. 4, the air flowing in the area downstream of the first heat exchanger 31 in the internal passage 112 is cooled as compared with before flowing into the first heat exchanger 31 and passes through the first heat exchanger 31.

Among arrows in the diagram showing the operation in the cooling mode shown in FIG. 4, arrows hatched with vertical lines indicate a flow of air cooled by the first heat exchanger 31. Among arrows in the diagram showing the operation in the cooling mode shown in FIG. 4, arrows hatched with horizontal lines indicate a flow of air heated by the second heat exchanger 32. In the drawings showing the operation of the cooling mode in each of the following embodiments, arrows hatched with vertical lines indicate a flow of air cooled by the first heat exchanger 31, and arrows hatched with horizontal lines indicate a flow of air heated by the second heat exchanger 32.

The air that has passed through the second heat exchanger 32 and has been heated flows in the area downstream of the second heat exchanger 32 in air flow in the external passage 111, and is discharged to the outside of the vehicle compartment via the external opening 111c.

When the flow rate adjustment unit 50 is in an open state, the air that has passed through the first heat exchanger 31 and has been cooled flows in the area downstream of the first heat exchanger 31 in air flow in the internal passage 112, and a part thereof is introduced into the bypass passage 15 from the upstream opening 151.

In contrast, of air that has passed through the first heat exchanger 31 and has been cooled, air that is not introduced into the bypass passage 15 flows in the area downstream of the bypass passage 15. Alternatively, when the flow rate adjustment unit 50 is in a fully closed state, all air that has passed through the first heat exchanger 31 and has been cooled bypasses the bypass passage 15 and flows in the area downstream of the bypass passage 15.

When the PTC heater 60 is operating, the air that has bypassed the bypass passage 15 is heated by the PTC heater 60 so that the relative humidity is reduced, and the air is blown into the vehicle compartment via the internal opening 112c. Accordingly, by blowing air having lower relative humidity than air inside the vehicle compartment into the vehicle compartment, the inside of the vehicle compartment can be cooled and dehumidified, and a window inside the vehicle compartment can be defogged. In contrast, when the PTC heater 60 is not operating, the air bypassed the bypass passage 15 is blown into the vehicle compartment via the internal opening 112c without being heated by the PTC heater 60.

The air introduced into the bypass passage 15 flows from the right side to the left side through the upstream passage 153a, and is reversed in flow direction by the bypass bottom portion 155 to be introduced into the downstream passage 154a through the through hole 121 formed in the passage partition portion 12. The air introduced into the downstream passage 154a flows through the downstream passage 154a from the left side to the right side, and is blown from the downstream opening 152. The air blown from the downstream opening 152 to the external passage 111 is mixed with air introduced from the external outside air suction port 111a and the external inside air suction port 111b in an area upstream of the second heat exchanger 32, and flows toward the second heat exchanger 32.

Thus, a part of the air cooled by the first heat exchanger 31 is guided to the area upstream of the second heat exchanger 32 in air flow in the external passage 111 via the bypass passage 15. Therefore, a flow rate of air introduced into the second heat exchanger 32 increases by an amount of air introduced from the internal passage 112 to the external passage 111 via the bypass passage 15.

A temperature of the air introduced from the external outside air suction port 111a and the external inside air suction port 111b is reduced by being mixed with the air cooled by the first heat exchanger 31. Therefore, a temperature of the air introduced into the second heat exchanger 32 decreases by an amount of heat corresponding to a flow rate of the air introduced from the internal passage 112 to the external passage 111 via the bypass passage 15.

The flow rate adjustment unit 50 adjusts the opening degree of the upstream opening 151 according to an amount of heat released from the refrigerant to the air in the first heat exchanger 31, and adjusts the flow rate of the air introduced from the internal passage 112 to the external passage 111 via the bypass passage 15. For example, the flow rate adjustment unit 50 may increase the opening degree of the upstream opening 151 as the amount of heat released from the refrigerant to the air in the first heat exchanger 31 increases. The flow rate adjustment unit 50 may decrease the opening degree of the upstream opening 151 as the amount of heat released from the refrigerant to the air in the first heat exchanger 31 is smaller.

The flow rate adjustment unit 50 adjusts a flow rate of air flowing from the external passage 111 to the internal passage 112 via the bypass passage 15 to adjust a temperature of air introduced into the second heat exchanger 32.

Efficiency of the refrigeration cycle when the air conditioning system 1 obtains required heating performance and required cooling performance is affected by the rotation speed of the electric motor 341 of the electric compressor 34. The rotation speed of the electric motor 341 is affected by performance of the first heat exchanger 31 and the second heat exchanger 32 when heat exchange is performed in the first heat exchanger 31 and the second heat exchanger 32 in order for the air conditioning system 1 to obtain the required heating performance and required cooling performance.

The performance of the first heat exchanger 31 and the second heat exchanger 32 changes depending on a flow rate and temperature of the air and the refrigerant flowing into the first heat exchanger 31 and the second heat exchanger 32. For example, when the first heat exchanger 31 and the second heat exchanger 32 absorb heat from the air by exchanging heat with the refrigerant, the greater the temperature of the air, the more a heat absorption amount per unit flow rate, thereby improving performance in the heat exchange. The performance of the first heat exchanger 31 and the second heat exchanger 32 when exchanging heat improves as the flow rate of air and refrigerant flowing into the first heat exchanger 31 and the second heat exchanger 32 increases per unit time, and the heat absorption amount per unit time increases.

When the first heat exchanger 31 and the second heat exchanger 32 release the heat of the refrigerant to the air, the lower the temperature of the air, the greater a heat release amount per unit flow rate, thereby improving the performance during heat exchange. The performance of the first heat exchanger 31 and the second heat exchanger 32 when exchanging heat improves as the flow rate of air and refrigerant flowing into the first heat exchanger 31 and the second heat exchanger 32 increases per unit time, and the heat release amount per unit time increases.

When the flow rate of the refrigerant flowing into the first heat exchanger 31 and the second heat exchanger 32 is increased, it is necessary to increase the rotation speed of the electric motor 341 of the electric compressor 34. However, efficiency of the electric compressor 34 tends to deteriorate as the rotation speed of the electric motor 341 increases in a high rotation range. When the refrigerant circulates in the refrigerant circuit 33 of the refrigeration cycle device 30, a pressure loss occurs. The greater the flow rate of circulating refrigerant per unit time, the greater this pressure loss. Therefore, the method of increasing the flow rate per unit time of the refrigerant circulating through the refrigerant circuit 33 by increasing the rotation speed of the electric motor 341 of the electric compressor 34 in order for the air conditioning system 1 to satisfy the required heating performance and the required cooling performance causes deterioration in the efficiency of the refrigeration cycle.

When a flow rate of air flowing into the first heat exchanger 31 is increased, it is necessary to increase a rotation speed of the internal motor 212 of the internal air blowing unit 21. When a flow rate of air flowing into the second heat exchanger 32 is increased, it is necessary to increase a rotation speed of the external motor 222 of the external air blowing unit 22. However, when the rotation speed of the internal motor 212 and the external motor 222 is increased, energy consumption of the air conditioning system 1 increases.

In contrast, when operating in the heating mode, the air conditioning system 1 according to the present embodiment is capable of increasing the flow rate of the air introduced into the second heat exchanger 32 by guiding a part of the air heated in the internal passage 112 to the external passage 111 via the bypass passage 15. When operating in the cooling mode, the air conditioning system 1 is capable of increasing the flow rate of the air introduced into the second heat exchanger 32 by guiding a part of the air cooled in the internal passage 112 to the external passage 111 via the bypass passage 15.

Accordingly, when the air conditioning system 1 operates in the heating mode, a heat absorption amount absorbed by the refrigerant from air per unit time in the second heat exchanger 32 is increased, and the performance of the second heat exchanger 32 can be improved. Therefore, as compared with a configuration in which air flowing through the internal passage 112 is not allowed to flow through the external passage 111, a temperature of a refrigerant flowing out of the second heat exchanger 32 is increased and a pressure of the refrigerant is increased, so that a flow rate of the refrigerant flowing out from the second heat exchanger 32 can be increased.

Therefore, a required rotation speed of the electric motor 341 of the electric compressor 34 for obtaining the required heating performance when the air conditioning system 1 operates in the heating mode can be reduced. Therefore, efficiency of the refrigeration cycle in the air conditioning system 1 can be improved.

When the air conditioning system 1 operates in the cooling mode, a heat release amount released by the refrigerant to air per unit flow rate in the second heat exchanger 32 is increased, and the performance of the second heat exchanger 32 can be improved. Accordingly, as compared with a configuration in which air flowing through the internal passage 112 is not allowed to flow through the external passage 111, a temperature of the refrigerant flowing out of the second heat exchanger 32 is decreased, and a pressure of the refrigerant is decreased. Therefore, a required rotation speed of the electric motor 341 of the electric compressor 34 for obtaining the required cooling performance when the air conditioning system 1 operates in the cooling mode can be reduced. Therefore, efficiency of the refrigeration cycle in the air conditioning system 1 can be improved.

Further, by causing the air flowing through the internal passage 112 to flow into the external passage 111 via the bypass passage 15, a flow rate of air flowing through the external passage 111 can be increased. Therefore, the rotation speed of the external motor 222 of the external air blowing unit 22 may be reduced correspondingly to an increase in the flow rate of the air flowing through the external passage 111. Accordingly, a drive force for operating the external motor 222 of the external air blowing unit 22 can be reduced, and the energy consumption of the air conditioning system 1 can be reduced.

According to the above embodiment, the following effects can be obtained.

(1) In the above embodiment, the bypass passage 15 has the air flow upstream end disposed downstream of the position of the first heat exchanger 31 in the air flow in the internal passage 112.

Accordingly, when the air conditioning system 1 operates in the heating mode, the temperature of the air flowing into the second heat exchanger 32 can be increased by mixing the air heated by the first heat exchanger 31 and the air flowing in the area upstream of the second heat exchanger 32 in air flow in the external passage 111. Therefore, when the air conditioning system 1 operates in the heating mode, the heat absorption amount absorbed by the refrigerant from air per unit flow rate in the second heat exchanger 32 can be increased. Therefore, the required rotation speed of the electric motor 341 of the electric compressor 34 for obtaining the required heating performance when the air conditioning system 1 operates in the heating mode can be further reduced. Therefore, the efficiency of the refrigeration cycle in the air conditioning system 1 can be further improved.

Further, by increasing the temperature of the air flowing into the second heat exchanger 32, it is possible to reduce occurrence of frost formation when the second heat exchanger 32 absorbs heat from air by exchanging heat with the refrigerant. Even if frost occurs in the second heat exchanger 32, the frost can be defrosted by increasing the temperature of the air flowing into the second heat exchanger 32.

When the air conditioning system 1 operates in the cooling mode, the temperature of the air flowing into the second heat exchanger 32 can be reduced by mixing the air cooled by the first heat exchanger 31 and the air flowing in the area upstream of the second heat exchanger 32 in air flow in the external passage 111. Therefore, when the air conditioning system 1 operates in the cooling mode, the heat release amount released by the refrigerant to air per unit flow rate in the second heat exchanger 32 can be increased. The required rotation speed of the electric motor 341 of the electric compressor 34 for obtaining the required cooling performance when the air conditioning system 1 operates in the cooling mode can be reduced. Therefore, the efficiency of the refrigeration cycle in the air conditioning system 1 can be further improved.

(2) In the above embodiment, the air conditioning system 1 includes the flow rate adjustment unit 50 that adjusts the flow rate of the air flowing from the internal passage 112 to the external passage 111 via the bypass passage 15.

Accordingly, the flow rate of the air flowing from the internal passage 112 to the external passage 111 via the bypass passage 15 can be adjusted according to an operation state of the refrigeration cycle device 30. For example, when the air conditioning system 1 operates in the heating mode, when the refrigerant is capable of absorbing a relatively large amount of heat from the air in the first heat exchanger 31, the flow rate of the air flowing from the internal passage 112 to the external passage 111 is increased, and a surplus heat amount can be used for improving the refrigeration cycle. In contrast, when the air conditioning system 1 operates in the heating mode, when the refrigerant is not capable of absorbing a relatively large amount of heat from the air in the first heat exchanger 31, the flow rate of the air flowing from the internal passage 112 to the external passage 111 can be reduced to ensure heating inside the vehicle compartment.

(3) In the above embodiment, the flow rate adjustment unit 50 includes the flow rate adjustment door 501 that changes the flow channel area of the bypass passage 15 and the electric actuator 502 that changes the posture of the flow rate adjustment door 501.

Accordingly, the flow rate of the air flowing from the internal passage 112 to the external passage 111 via the bypass passage 15 can be adjusted with a simple configuration. As compared with a case where a flow rate of air flowing from the internal passage 112 to the external passage 111 is adjusted by rotation of the internal air blowing unit 21 and the external air blowing unit 22, the flow rate can be adjusted without affecting the heat exchange performed in the first heat exchanger 31 and the second heat exchanger 32.

(4) In the above embodiment, the air conditioning system 1 includes the internal air blowing unit 21 that generates an air flow in the internal passage 112, the external air blowing unit 22 that generates an air flow in the external passage 111, and the control device 70 that controls rotation speeds of the internal air blowing unit 21 and the external air blowing unit 22 independently of each other.

Accordingly, the flow rates of the air flowing through the internal passage 112 and the external passage 111 can be adjusted independently of each other. Therefore, even when required flow rates of air to be supplied to the first heat exchanger 31 and the second heat exchanger 32 are different from each other, it is possible to ensure the required flow rate of the air to be supplied to the first heat exchanger 31 and the second heat exchanger 32.

(5) In the above embodiment, the internal air blowing unit 21 includes the internal blower fan 211 that rotates to generate an air flow, and the internal motor 212 that rotates the internal blower fan 211. The internal motor 212 is provided upstream of the position of the first heat exchanger 31 in air flow in the internal passage 112.

Accordingly, using heat generated by an operation of the internal motor 212 when rotating the internal blower fan 211, the air flowing upstream of the position of the first heat exchanger 31 in the internal passage 112 can be heated. Therefore, when the air conditioning system 1 operates in the heating mode, the temperature of the air introduced into the first heat exchanger 31 can be increased. Since the heat absorption amount from the refrigerant in the first heat exchanger 31 necessary for the air conditioning system 1 to obtain the required heating performance can be reduced, the required rotation speed of the electric motor 341 of the electric compressor 34 can be reduced. Therefore, the efficiency of the refrigeration cycle can be improved.

(6) In the above embodiment, the external air blowing unit 22 includes the external blower fan 221 that rotates to generate an air flow, and the external motor 222 that rotates the external blower fan 221. The external motor 222 is provided upstream of the position of the second heat exchanger 32 in the air flow in the external passage 111.

Accordingly, using heat generated by an operation of the external motor 222 when rotating the external blower fan 221, the air flow in the area upstream of the position of the second heat exchanger 32 in the external passage 111 can be heated. Therefore, when the air conditioning system 1 operates in the heating mode, the temperature of the air introduced into the second heat exchanger 32 can be increased. The heat absorption amount absorbed by the refrigerant from air per unit flow rate in the second heat exchanger 32 can be further increased. Therefore, the efficiency of the refrigeration cycle in the air conditioning system 1 can be further improved.

(7) In the above embodiment, the air conditioning system 1 includes the control device 70 that controls the rotation of the electric motor 341. The refrigeration cycle device 30 includes the refrigerant circuit 33 that circulates the refrigerant. The control device 70 changes a flow direction of the refrigerant circulating in the refrigerant circuit 33 by switching the rotation direction of the electric motor 341.

Accordingly, the refrigeration cycle device 30 is implemented by a heat pump cycle that switches a flow direction of a refrigerant. Therefore, the air conditioning system 1 is capable of operating in the cooling mode in which cooled air is blown in addition to the heating mode in which heated air is blown. The flow direction of the refrigerant can be switched without providing a circuit switching unit that switches the flow direction of the refrigerant circulating through the refrigerant circuit 33. Therefore, the number of components of the refrigeration cycle device 30 can be reduced compared with a configuration having the circuit switching unit.

### First Modification of First Embodiment

In the first embodiment described above, an example is described in which the internal air blowing unit 21 is provided upstream of the position of the first heat exchanger 31 in air flow in the internal passage 112. An example is described in which the external air blowing unit 22 is provided upstream of the position of the second heat exchanger 32 in air flow in the external passage 111. However, positions where the internal air blowing unit 21 and the external air blowing unit 22 are disposed are not limited thereto.

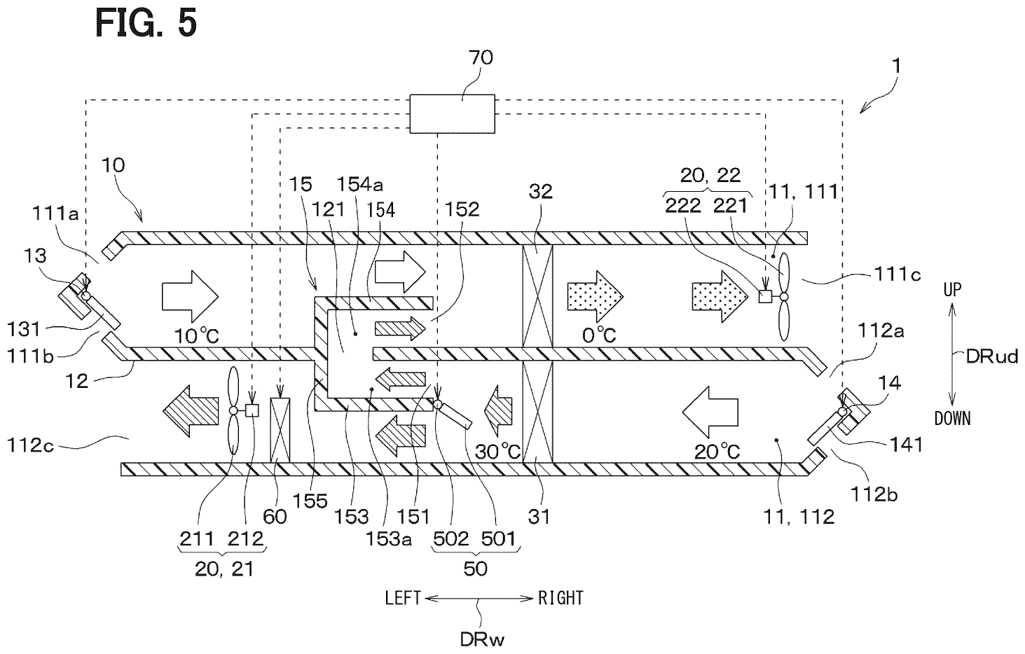

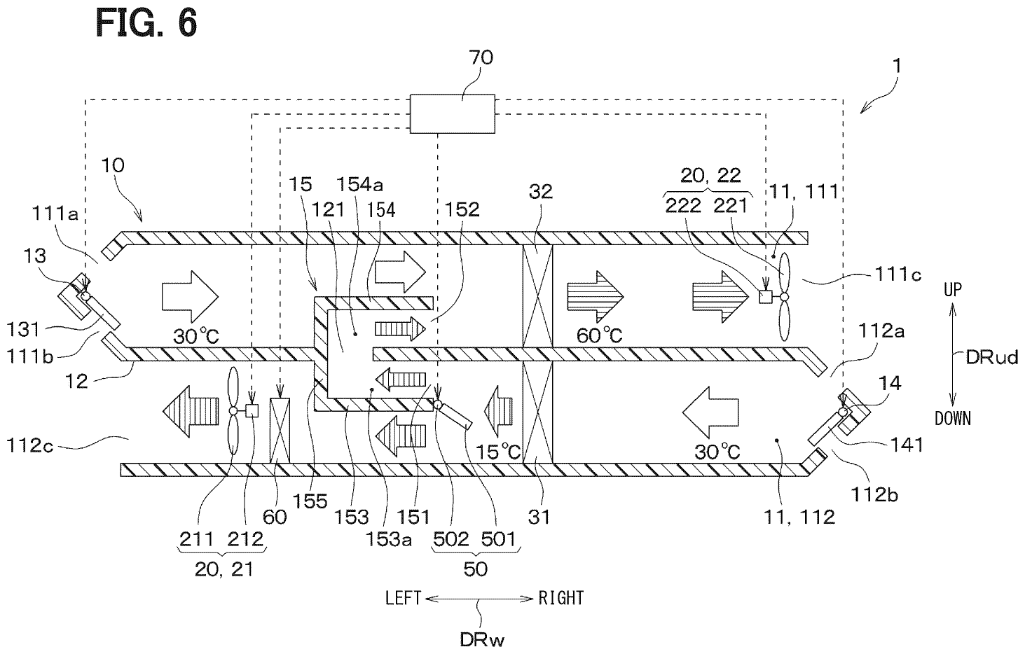

For example, as shown in FIGS. 5 and 6, the internal air blowing unit 21 may be provided downstream of a position of the first heat exchanger 31 in air flow in the internal passage 112. Specifically, the internal blower fan 211 and the internal motor 212 in the internal air blowing unit 21 may be provided downstream of the position of the first heat exchanger 31 in air flow in the internal passage 112.

As shown in FIGS. 5 and 6, the external air blowing unit 22 may be provided downstream of a position of the second heat exchanger 32 in air flow in the external passage 111. Specifically, the external blower fan 221 and the external motor 222 in the external air blowing unit 22 may be provided downstream of the position of the second heat exchanger 32 in air flow in the external passage 111.

FIG. 5 shows a flow of air flowing through the internal passage 112 and a flow of air flowing through the external passage 111 when the air conditioning system 1 operates in a heating mode. FIG. 6 shows a flow of air flowing through the internal passage 112 and a flow of air flowing through the external passage 111 when the air conditioning system 1 operates in a cooling mode.

Other configurations are similar as those in the first embodiment described above. Therefore, similar effects as in the first embodiment can be obtained based on a configuration that is similar or equivalent to that in the first embodiment.

Air flowing through the internal passage 112 due to rotation of the internal blower fan 211 is more likely to be turbulent on a downstream side than on an air flow upstream side of the internal blower fan 211. Air flowing through the external passage 111 due to rotation of the external blower fan 221 is more likely to be turbulent on a downstream side than on an air flow upstream side of the external blower fan 221. Turbulence of an air flow causes uneven heat when the first heat exchanger 31 and the second heat exchanger 32 exchange heat between the refrigerant and the air, and causes deterioration in efficiency of a refrigeration cycle due to the uneven heat.

In contrast, since the internal blower fan 211 is provided downstream of the position of the first heat exchanger 31 in air flow in the internal passage 112, it is possible to reduce turbulence of an air flow passing through the first heat exchanger 31. Since the external blower fan 221 is provided downstream of the position of the second heat exchanger 32 in air flow in the external passage 111, it is possible to reduce turbulence of an air flow passing through the second heat exchanger 32. Therefore, it is possible to reduce the uneven heat occurred when the first heat exchanger 31 and the second heat exchanger 32 exchange heat between the refrigerant and the air, and to reduce deterioration in efficiency of the refrigeration cycle due to the uneven heat.

The external motor 222 is downstream of the position of the second heat exchanger 32 in air flow in the external passage 111. Accordingly, when the air conditioning system 1 operates in the cooling mode, a temperature of air introduced into the second heat exchanger 32 can be prevented from increasing by the heat generated by its own operation when the external blower fan 221 is rotated by the external motor 222. Therefore, when the air conditioning system 1 operates in the cooling mode, it is possible to avoid a decrease in a heat absorption amount absorbed by the refrigerant from air per unit flow rate in the second heat exchanger 32 due to an increase in the temperature of the air introduced into the second heat exchanger 32.

### Second Modification of First Embodiment

In the first embodiment described above, an example is described in which the external air blowing unit 22 is provided upstream of the position of the second heat exchanger 32 in air flow in the external passage 111, but the present disclosure is not limited thereto.

In this modification, as described in the first embodiment described above, the internal air blowing unit 21 is provided upstream of the position of the first heat exchanger 31 in air flow in the internal passage 112. Specifically, the internal blower fan 211 and the internal motor 212 in the internal air blowing unit 21 are provided upstream of the position of the first heat exchanger 31 in air flow in the internal passage 112.

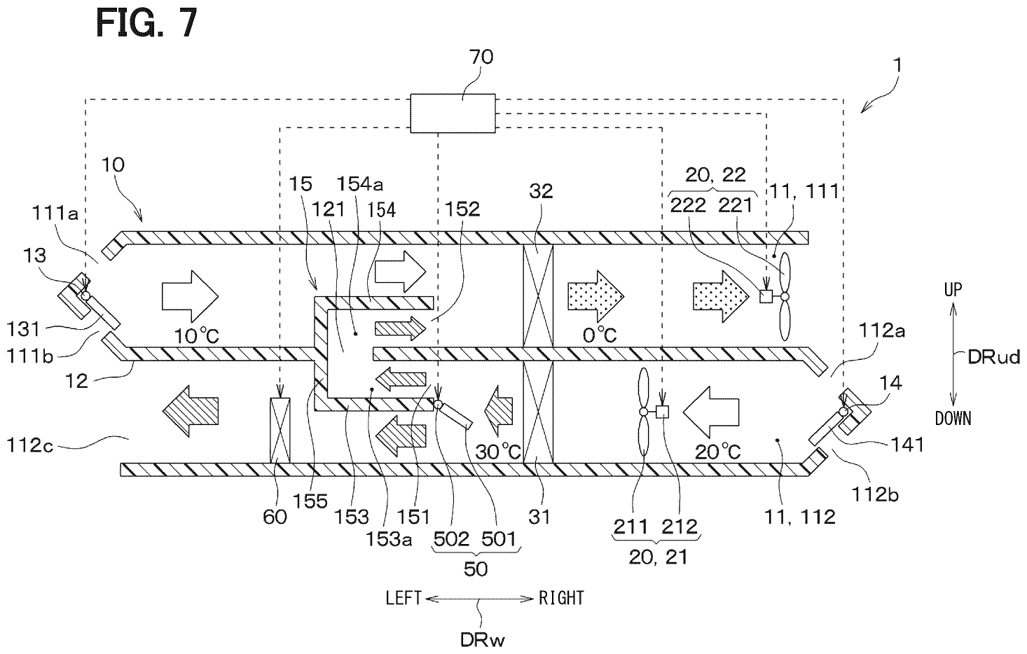

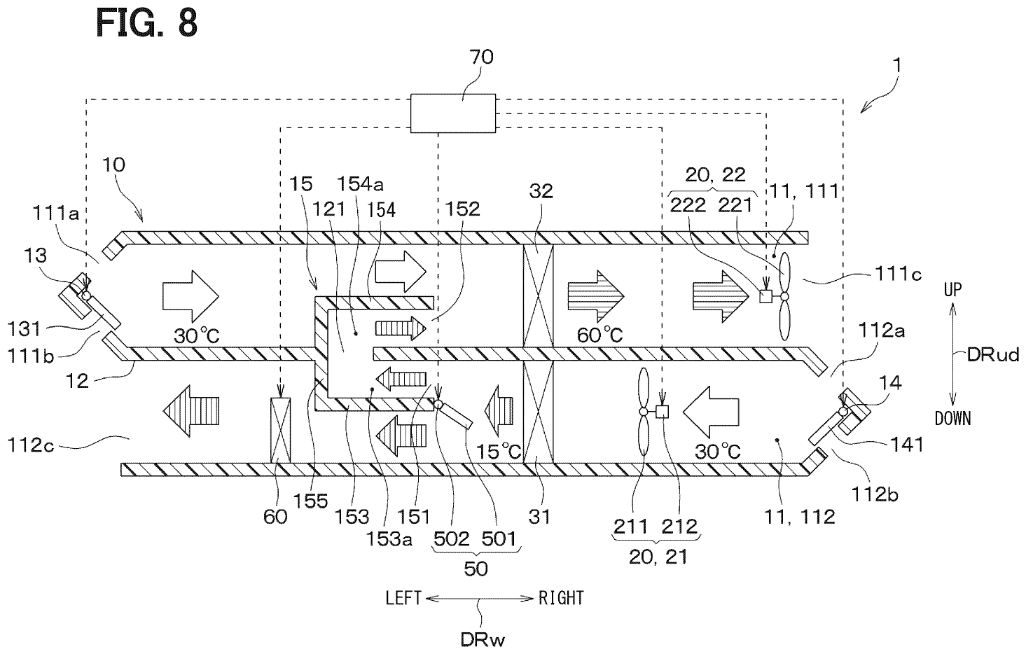

In contrast, as shown in FIGS. 7 and 8, the external air blowing unit 22 may be provided downstream of a position of the second heat exchanger 32 in air flow in the external passage 111. Specifically, the external blower fan 221 and the external motor 222 in the external air blowing unit 22 may be provided downstream of the position of the second heat exchanger 32 in air flow in the external passage 111.

FIG. 7 shows a flow of air flowing through the internal passage 112 and a flow of air flowing through the external passage 111 when the air conditioning system 1 operates in a heating mode. FIG. 8 shows a flow of air flowing through the internal passage 112 and a flow of air flowing through the external passage 111 when the air conditioning system 1 operates in a cooling mode.

Other configurations are similar as those in the first embodiment described above. Therefore, similar effects as in the first embodiment can be obtained based on a configuration that is similar or equivalent to that in the first embodiment.

Since the external blower fan 221 is provided downstream of the position of the second heat exchanger 32 in air flow in the external passage 111, it is possible to reduce turbulence of an air flow passing through the second heat exchanger 32. Therefore, it is possible to reduce the uneven heat occurred when the second heat exchanger 32 exchanges heat between the refrigerant and the air, and to reduce deterioration in efficiency of the refrigeration cycle due to the uneven heat.

When the air conditioning system 1 operates in the cooling mode, it is possible to avoid a decrease in a heat absorption amount absorbed by the refrigerant from air per unit flow rate in the second heat exchanger 32 due to an increase in a temperature of the air introduced into the second heat exchanger 32.

### Third Modification of First Embodiment

In the first embodiment described above, an example is described in which the internal air blowing unit 21 is provided upstream of the position of the first heat exchanger 31 in air flow in the internal passage 112, but the present disclosure is not limited thereto.

In this modification, as described in the first embodiment described above, the external air blowing unit 22 is provided upstream of the position of the second heat exchanger 32 in air flow in the external passage 111. Specifically, the external blower fan 221 and the external motor 222 in the external air blowing unit 22 are provided upstream of the position of the second heat exchanger 32 and upstream of a position of the downstream opening 152 in air flow in the external passage 111.

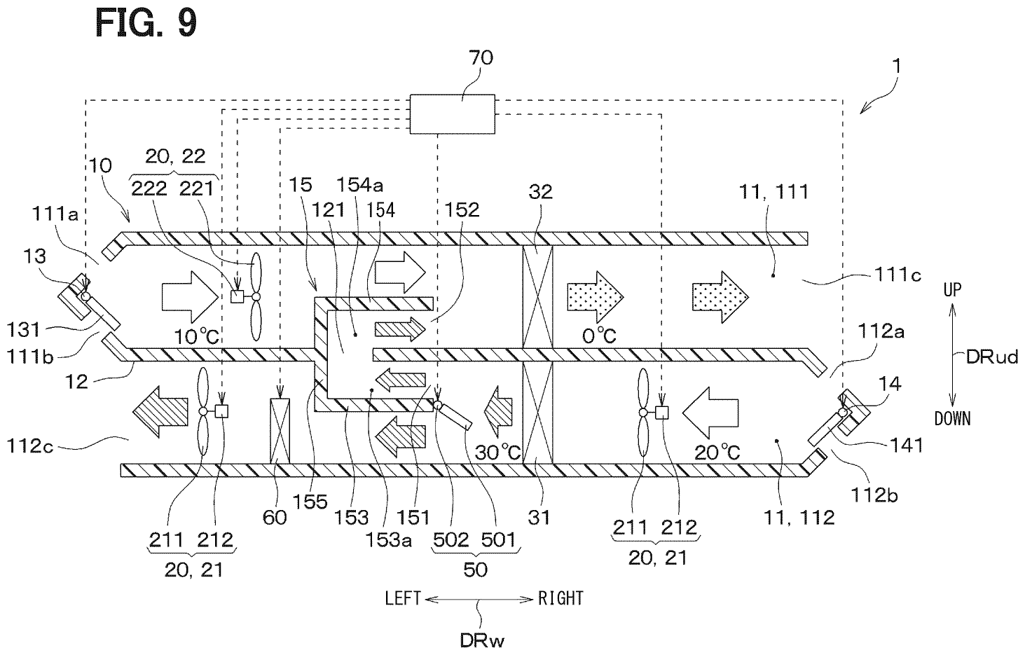

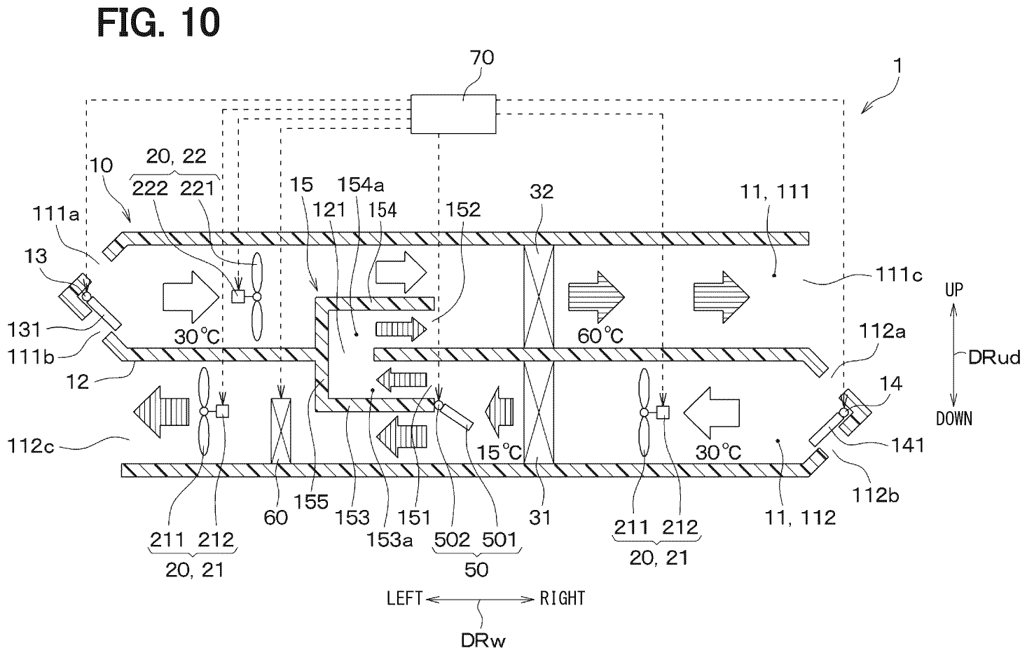

In contrast, as shown in FIGS. 9 and 10, the internal air blowing unit 21 may be provided downstream of a position of the first heat exchanger 31 in air flow in the internal passage 112. Specifically, the internal blower fan 211 and the internal motor 212 in the internal air blowing unit 21 are provided downstream of the position of the first heat exchanger 31 and downstream of a position of the upstream opening 151 in air flow in the internal passage 112.

FIG. 9 shows a flow of air flowing through the internal passage 112 and a flow of air flowing through the external passage 111 when the air conditioning system 1 operates in a heating mode. FIG. 10 shows a flow of air flowing through the internal passage 112 and a flow of air flowing through the external passage 111 when the air conditioning system 1 operates in a cooling mode.

In the present embodiment, the upstream opening 151 that faces the air flow upstream side in the internal passage 112 is disposed upstream of the internal blower fan 211 in air flow in the internal passage 112. The downstream opening 152 that faces the air flow downstream side in the external passage 111 is disposed downstream of the external blower fan 221 in air flow in the external passage 111.

In this case, when an air pressure at the air flow downstream opening 152 side is higher than an air pressure at the upstream opening 151 side, air flowing through the internal passage 112 hardly flows into the external passage 111 via the bypass passage 15. Therefore, by appropriately adjusting rotation speeds of the internal motor 212 and the external motor 222 and reducing the air pressure at the air flow downstream opening 152 side to be smaller than the air pressure at the upstream opening 151 side, the air flowing through the internal passage 112 easily flows into the external passage 111 via the bypass passage 15. Accordingly, similar effects as in the first embodiment can be obtained based on a configuration that is similar or equivalent to that in the first embodiment.

Since the internal blower fan 211 is provided downstream of the position of the first heat exchanger 31 in air flow in the internal passage 112, it is possible to reduce turbulence of an air flow passing through the first heat exchanger 31. Therefore, it is possible to reduce the uneven heat occurred when the first heat exchanger 31 exchanges heat between the refrigerant and the air, and to reduce deterioration in efficiency of the refrigeration cycle due to the uneven heat.

### Second Embodiment

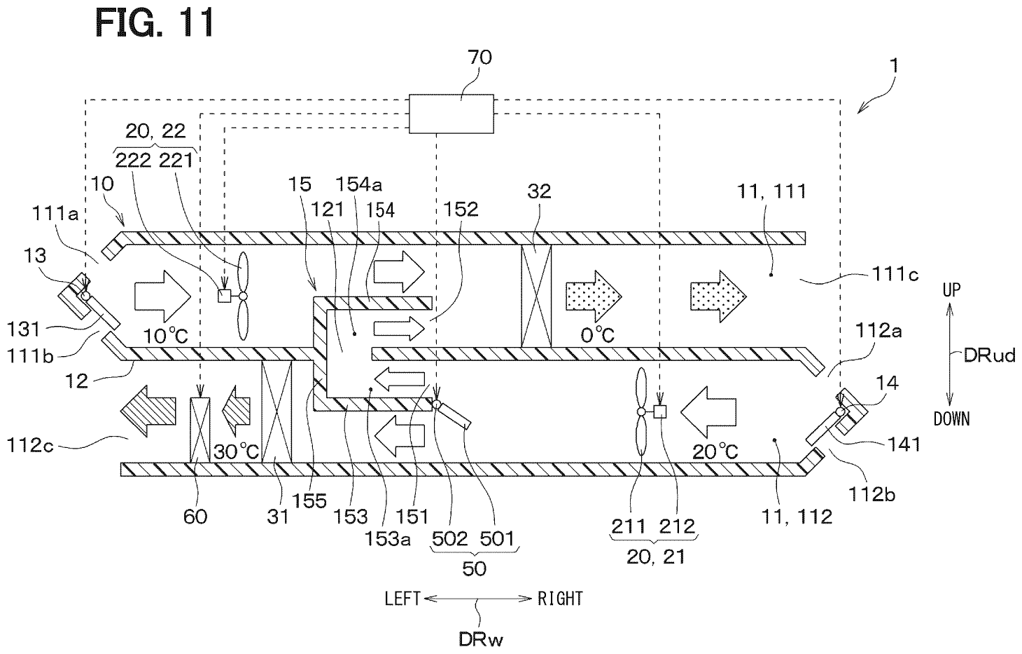

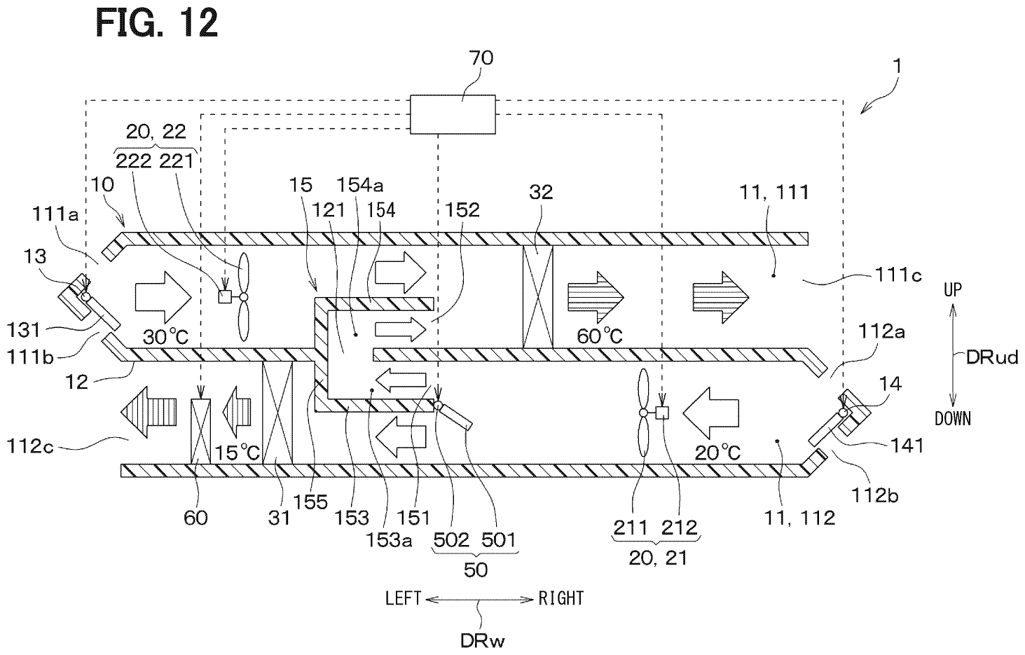

Next, a second embodiment will be described with reference to FIGS. 11 and 12. The present embodiment is different from the first embodiment in a position where the first heat exchanger 31 is disposed. The other configuration is similar as that of the first embodiment. Therefore, in the present embodiment, portions different from the first embodiment will be mainly described, and description of portions similar to the first embodiment may be omitted.

As shown in FIGS. 11 and 12, the first heat exchanger 31 according to the present embodiment is provided downstream of a position of the internal air blowing unit 21 and downstream of the upstream opening 151 of the bypass passage 15 in air flow in the internal passage 112. Therefore, the upstream opening 151 according to the present embodiment does not face an air blowing side of the first heat exchanger 31. The upstream opening 151 opens toward an air blowing side of an internal blower fan 211. That is, the upstream opening 151 faces an air flow upstream side in the internal passage 112.

FIG. 11 shows a flow of air flowing through the internal passage 112 and a flow of air flowing through the external passage 111 when the air conditioning system 1 operates in a heating mode. FIG. 12 shows a flow of air flowing through the internal passage 112 and a flow of air flowing through the external passage 111 when the air conditioning system 1 operates in a cooling mode.

Other configurations are similar as those in the first embodiment described above. Therefore, when operating in the heating mode and the cooling mode, the air conditioning system 1 according to the present embodiment is capable of increasing a flow rate of air introduced into the second heat exchanger 32 by guiding a part of air flowing through the internal passage 112 to the external passage 111 via the bypass passage 15.

Accordingly, as compared with a configuration in which air flowing through the internal passage 112 is not allowed to flow through the external passage 111, performance of the second heat exchanger 32 can be improved, so that a required rotation speed of the electric motor 341 of the electric compressor 34 can be reduced. Therefore, efficiency of the refrigeration cycle in the air conditioning system 1 can be improved.

The first heat exchanger 31 according to the present embodiment is provided at downstream of the upstream opening 151 of the bypass passage 15 in air flow in the internal passage 112. Therefore, unlike the first embodiment, when the air conditioning system 1 operates in the heating mode, air heated by the first heat exchanger 31 cannot be guided to the external passage 111 via the bypass passage 15. Therefore, when the air conditioning system 1 operates in the heating mode, a temperature of air flowing into the second heat exchanger 32 cannot be increased using the air heated by the first heat exchanger 31.

When the air conditioning system 1 operates in the cooling mode, unlike the first embodiment, air cooled by the first heat exchanger 31 cannot be guided to the external passage 111 via the bypass passage 15. Therefore, when the air conditioning system 1 operates in the cooling mode, a temperature of air flowing into the second heat exchanger 32 cannot be reduced using the air cooled by the first heat exchanger 31.

However, when the air conditioning system 1 operates in the heating mode and the cooling mode, air before being heated and cooled by the first heat exchanger 31 can be guided to the external passage 111 via the bypass passage 15. A temperature of air flowing into the second heat exchanger 32 can be changed by mixing the air before being heated and cooled by the first heat exchanger 31 with air flowing upstream of the second heat exchanger 32 in the external passage 111.

Therefore, the control device 70 may control an operation of the flow rate adjustment unit 50 according to a temperature difference between internal blown air and external blown air to open and close the upstream opening 151 of the bypass passage 15.

For example, when the air conditioning system 1 operates in the heating mode, when a temperature of the internal blown air is higher than a temperature of the external blown air, the flow rate adjustment unit 50 may be opened, and air flowing through the internal passage 112 may flow to the external passage 111 via the bypass passage 15. Accordingly, when the air conditioning system 1 operates in the heating mode, air flowing through the internal passage 112 and air flowing through the external passage 111 are mixed to increase a temperature of air flowing into the second heat exchanger 32. Therefore, when the air conditioning system 1 operates in the heating mode, the heat absorption amount absorbed by the refrigerant from air per unit flow rate in the second heat exchanger 32 can be increased. Therefore, the required rotation speed of the electric motor 341 of the electric compressor 34 for obtaining the required heating performance when the air conditioning system 1 operates in the heating mode can be further reduced. Therefore, efficiency of the refrigeration cycle in the air conditioning system 1 can be improved.

In contrast, when the air conditioning system 1 operates in the heating mode, when the temperature of the internal blown air is lower than the temperature of the external blown air, the flow rate adjustment unit 50 may be closed to prevent the air flowing through the internal passage 112 from flowing to the external passage 111. Accordingly, when the air conditioning system 1 operates in the heating mode, it is possible to avoid a decrease in the temperature of the air flowing into the second heat exchanger 32 caused by mixing the air flowing through the internal passage 112, which has a lower temperature than the air flowing through the external passage 111, with the air flowing through the external passage 111. Therefore, when the air conditioning system 1 operates in the heating mode, it is possible to avoid a decrease in the heat absorption amount absorbed by the refrigerant from air per unit flow rate in the second heat exchanger 32.

When the air conditioning system 1 operates in the cooling mode, when a temperature of internal blown air is lower than a temperature of external blown air, the flow rate adjustment unit 50 may be opened, and air flowing through the internal passage 112 may flow to the external passage 111 via the bypass passage 15. Accordingly, when the air conditioning system 1 operates in the cooling mode, air flowing through the internal passage 112 and air flowing through the external passage 111 are mixed to reduce a temperature of air flowing into the second heat exchanger 32. Therefore, when the air conditioning system 1 operates in the cooling mode, the heat release amount released by the refrigerant to air per unit flow rate in the second heat exchanger 32 can be increased. Therefore, a required rotation speed of the electric motor 341 of the electric compressor 34 for obtaining required cooling performance when the air conditioning system 1 operates in the cooling mode can be further reduced. Therefore, efficiency of the refrigeration cycle in the air conditioning system 1 can be improved.

In contrast, when the air conditioning system 1 operates in the cooling mode, when the temperature of the internal blown air is higher than the temperature of the external blown air, the flow rate adjustment unit 50 may be closed to prevent the air flowing through the internal passage 112 from flowing to the external passage 111. Accordingly, when the air conditioning system 1 operates in the cooling mode, it is possible to avoid an increase in the temperature of the air flowing into the second heat exchanger 32 caused by mixing the air flowing through the internal passage 112, which has a higher temperature than the air flowing through the external passage 111, with the air flowing through the external passage 111. Therefore, when the air conditioning system 1 operates in the cooling mode, it is possible to avoid a decrease in the heat release amount released by the refrigerant to air per unit flow rate in the second heat exchanger 32.

The first heat exchanger 31 according to the present embodiment is provided downstream of the upstream opening 151 of the bypass passage 15 in air flow in the internal passage 112. Therefore, a flow rate of air introduced into the first heat exchanger 31 is reduced by flowing air flowing through the internal passage 112 to the external passage 111 via the bypass passage 15. By flowing the air flowing through the internal passage 112 to the external passage 111 via the bypass passage 15, an air volume blown into the vehicle compartment via the internal opening 112c decreases. In this case, it is conceivable to increase a rotation speed of the internal motor 212 and ensure a flow rate of air introduced into the first heat exchanger 31 by an amount by which the flow rate of the air introduced into the first heat exchanger 31 decreases.

However, for example, when the flow rate of the air introduced into the first heat exchanger 31 decreases when the air conditioning system 1 operates in the heating mode, an amount of heat per unit time that the air absorbs from the refrigerant increases when the refrigerant and the air exchange heat in the first heat exchanger 31. Accordingly, as compared with a configuration in which a part of air flowing through the internal passage 112 via the bypass passage 15 is not allowed to flow through the external passage 111, a temperature of air after passing through the first heat exchanger 31 and being heated increases.

Therefore, in order to ensure the flow rate of the air introduced into the first heat exchanger 31, an inside of the vehicle compartment can be sufficiently heated without increasing a rotation speed of the internal blower fan 211.

When the flow rate of the air introduced into the first heat exchanger 31 decreases when the air conditioning system 1 operates in the cooling mode, an amount of heat per unit time that the refrigerant absorbs from the air increases when the refrigerant and the air exchange heat in the first heat exchanger 31. Accordingly, as compared with a configuration in which air flowing through the internal passage 112 is not allowed to flow through the external passage 111 via the bypass passage 15, a temperature of air after passing through the first heat exchanger 31 and being cooled decreases.

Therefore, in order to ensure the flow rate of the air introduced into the first heat exchanger 31, the inside of the vehicle compartment can be sufficiently cooled without increasing a rotation speed of the internal blower fan 211.

### Modification of Second Embodiment

In the second embodiment described above, the air conditioning system 1 is described in an example in which the internal air blowing unit 21 is provided upstream of the position of the first heat exchanger 31 in air flow in the internal passage 112. The air conditioning system 1 is described in an example in which the external air blowing unit 22 is provided upstream of the position of the second heat exchanger 32 in air flow in the external passage 111. However, positions where the internal air blowing unit 21 and the external air blowing unit 22 are disposed are not limited thereto.

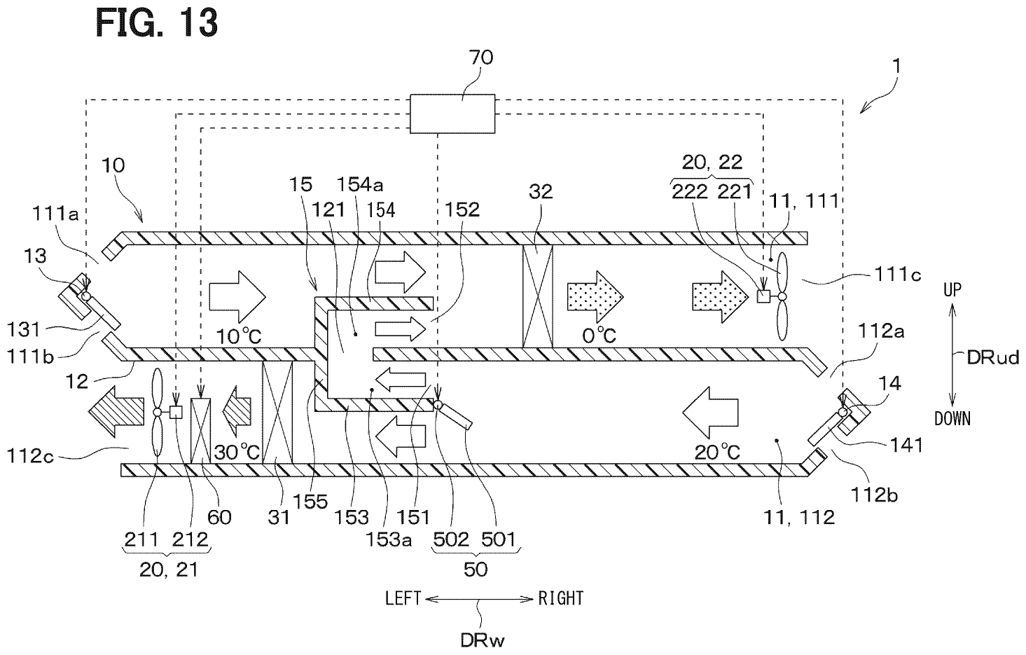

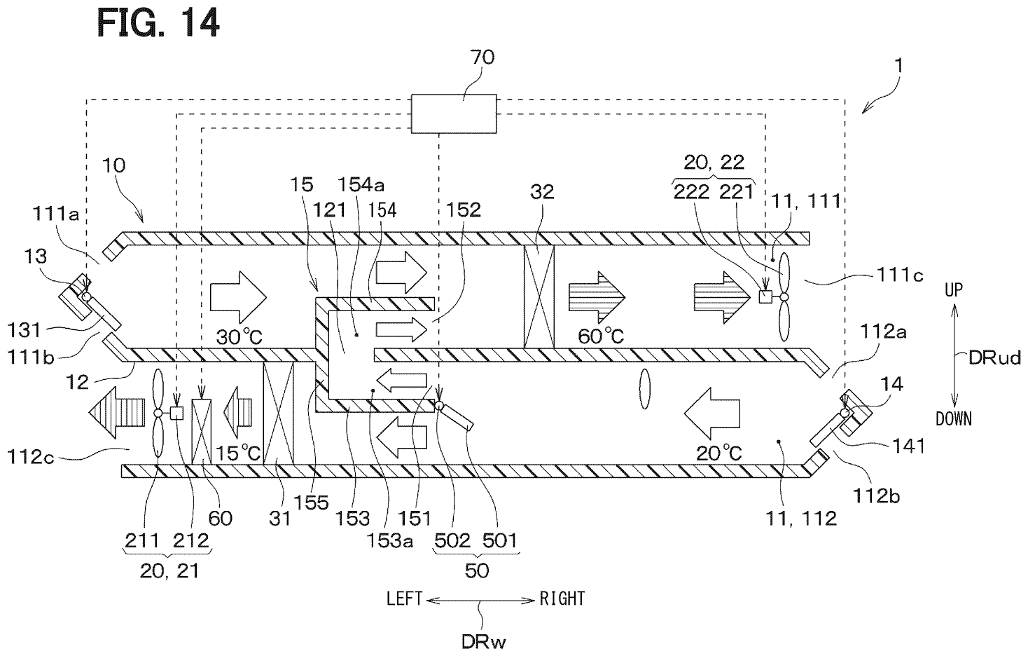

For example, in the air conditioning system 1, the internal air blowing unit 21 and the external air blowing unit 22 may be disposed at positions shown in FIGS. 13 and 14. Specifically, in the air conditioning system 1, the internal air blowing unit 21 may be provided downstream of a position of the first heat exchanger 31 in air flow in the internal passage 112, and the external air blowing unit 22 may be provided downstream of a position of the second heat exchanger 32 in air flow in the external passage 111.

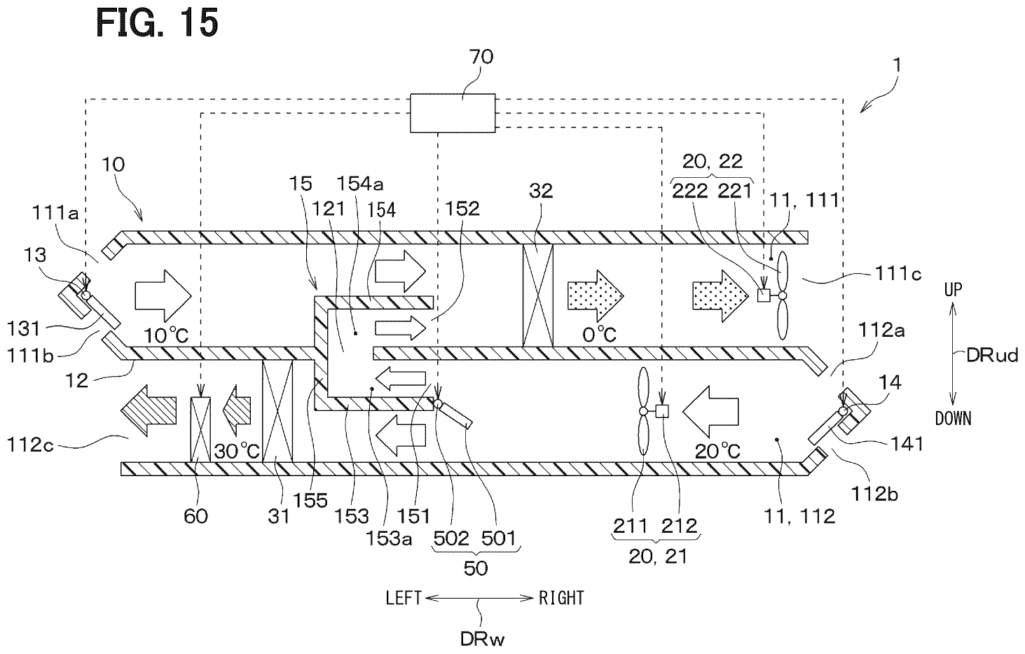

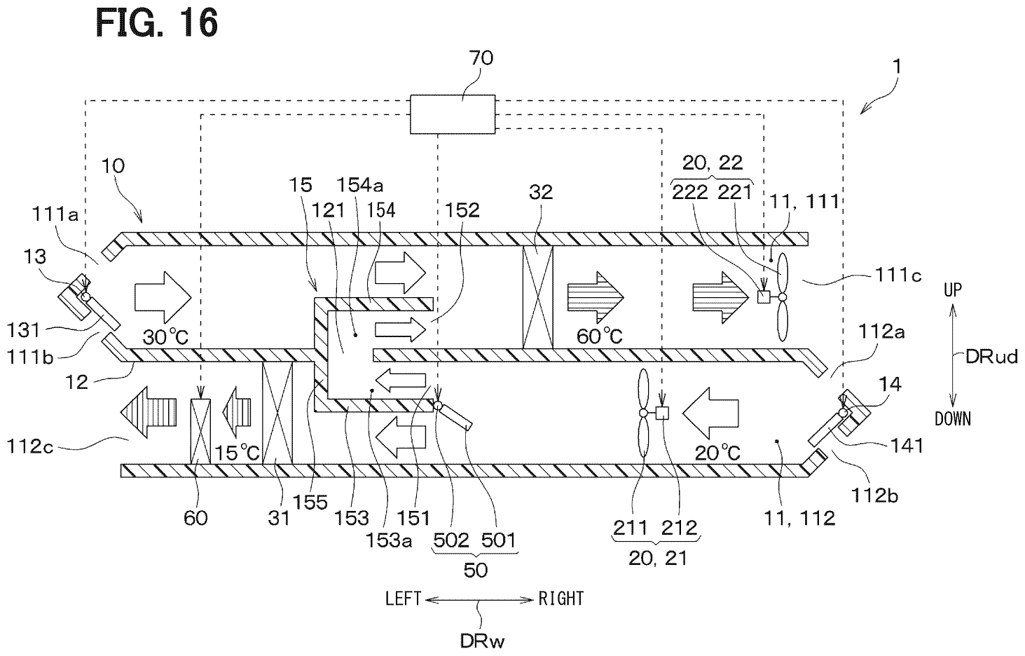

In the air conditioning system 1, the internal air blowing unit 21 and the external air blowing unit 22 may be disposed at positions shown in FIGS. 15 and 16. Specifically, in the air conditioning system 1, the internal air blowing unit 21 may be provided upstream of a position of the first heat exchanger 31 in air flow in the internal passage 112, and the external air blowing unit 22 may be provided downstream of the position of the second heat exchanger 32 in air flow in the external passage 111.

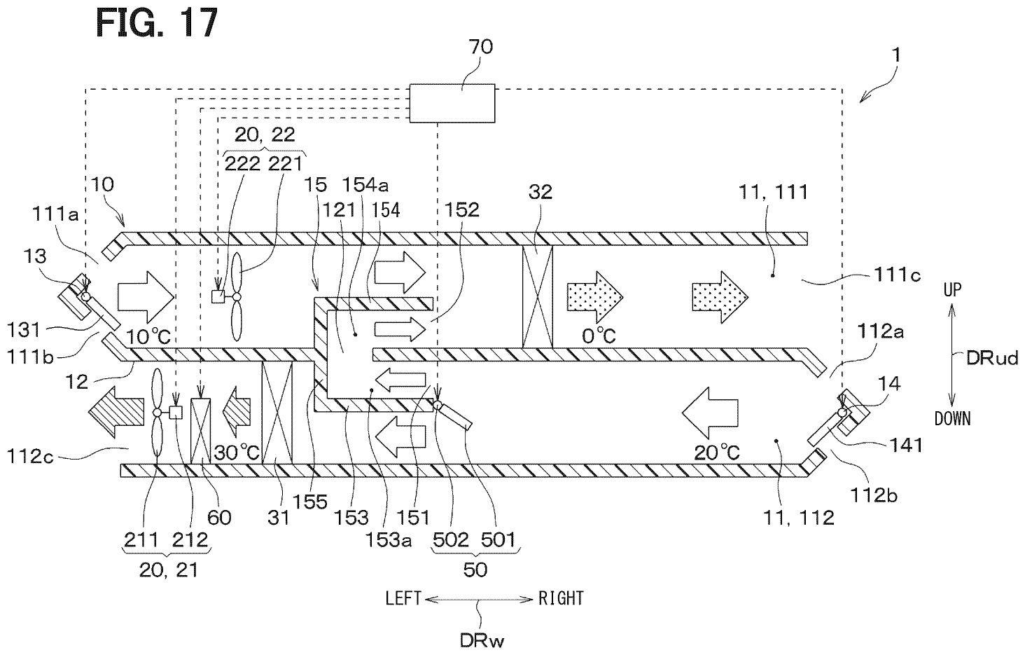

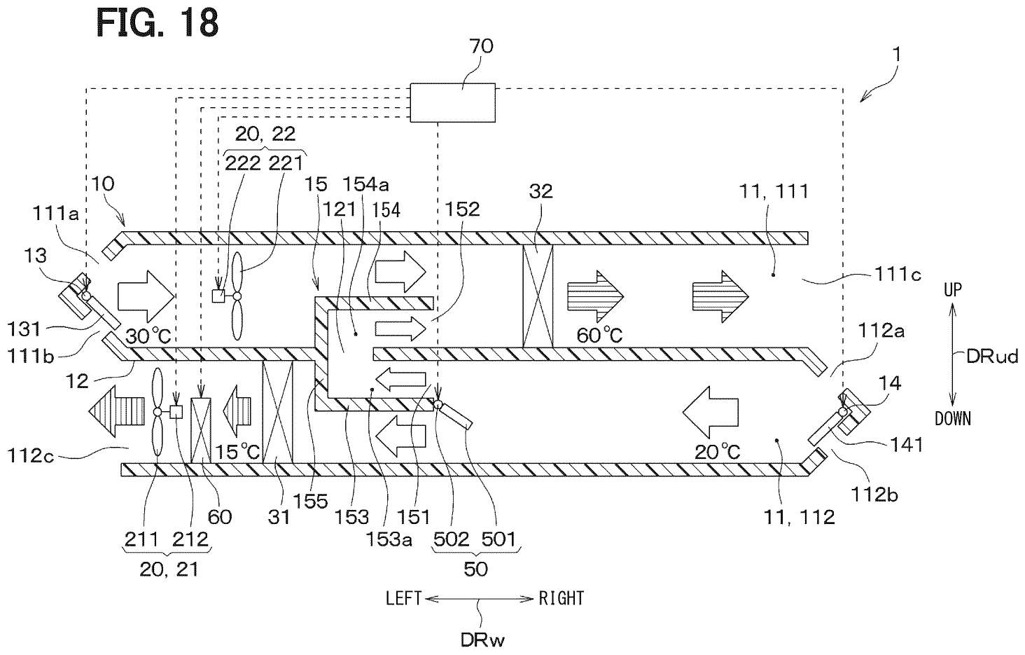

In the air conditioning system 1, the internal air blowing unit 21 and the external air blowing unit 22 may be disposed at positions shown in FIGS. 17 and 18. Specifically, in the air conditioning system 1, the internal air blowing unit 21 may be provided downstream of a position of the first heat exchanger 31 in air flow in the internal passage 112, and the external air blowing unit 22 may be provided upstream of a position of the second heat exchanger 32 in air flow in the external passage 111.

FIGS. 13, 15, and 17 show the flows of air flowing through the internal passage 112 and the flows of air flowing through the external passage 111 when the air conditioning system 1 operates in the heating mode. FIGS. 14, 16, and 18 show the flows of air flowing through the internal passage 112 and the flows of air flowing through the external passage 111 when the air conditioning system 1 operates in the cooling mode.

### Third Embodiment

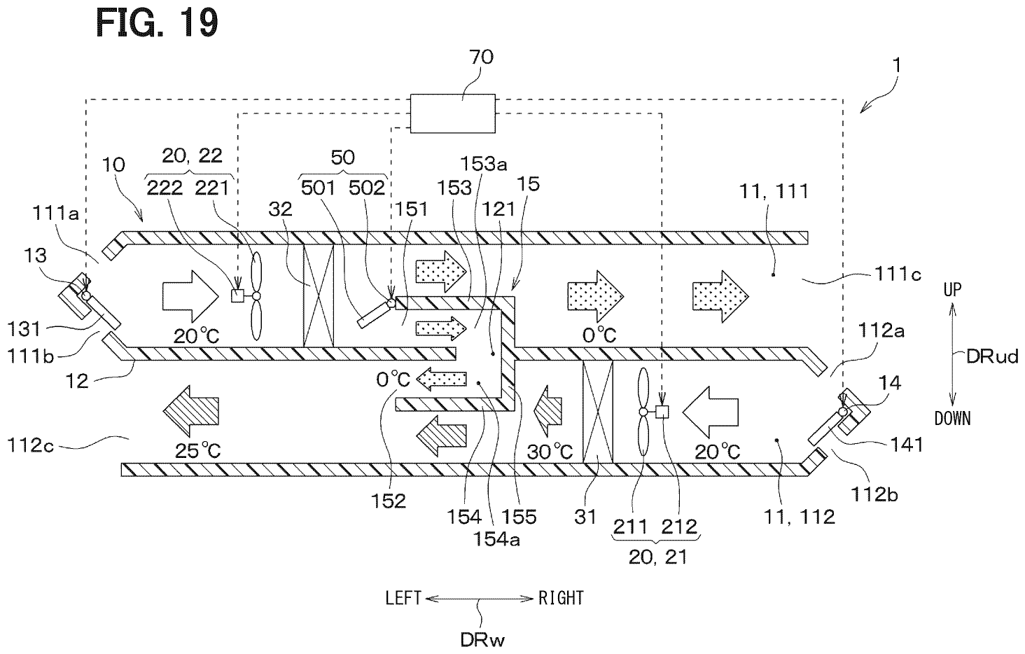

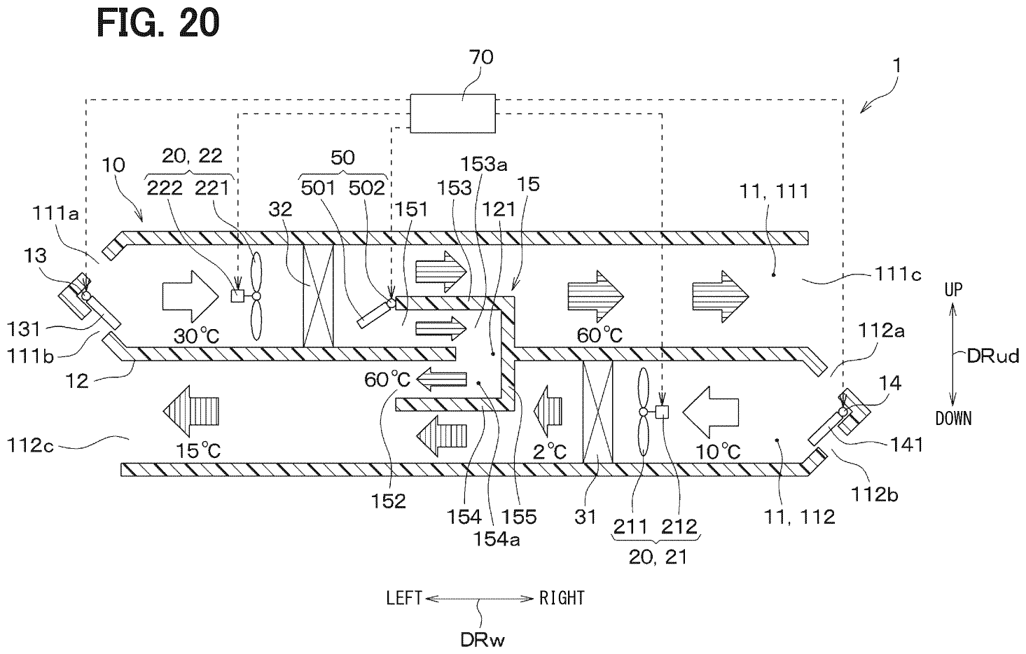

Next, a third embodiment will be described with reference to FIGS. 19 and 20. In the present embodiment, a position where the second heat exchanger 32 is disposed and a position where the flow rate adjustment unit 50 is disposed are different from those of the first embodiment. The present embodiment is different from the first embodiment in that the PTC heater 60 is eliminated and the bypass passage 15 guides the air flowing through the external passage 111 to the internal passage 112. The other configuration is similar as that of the first embodiment. Therefore, in the present embodiment, portions different from the first embodiment will be mainly described, and description of portions similar to the first embodiment may be omitted.

As shown in FIGS. 19 and 20, the second heat exchanger 32 according to the present embodiment is disposed downstream of a position of the external air blowing unit 22 and upstream of a position of the upstream opening 151 of the bypass passage 15 in air flow in the external passage 111.

The bypass passage 15 according to the present embodiment is provided such that an air flow upstream end of an air flow channel is disposed in the external passage 111, and an air flow downstream end is disposed in the internal passage 112. That is, in the bypass passage 15 according to the present embodiment, the upstream opening 151 is disposed in the external passage 111, and the downstream opening 152 is disposed in the internal passage 112. The upstream opening 151 is an opening for guiding air flowing through the external passage 111 into the bypass passage 15. The downstream opening 152 is an opening through which air introduced from the upstream opening 151 is blown into the internal passage 112.

In the bypass passage 15 according to the present embodiment, the upstream passage portion 153 is disposed in the side external passage 111, and the downstream passage portion 154 is disposed in the internal passage 112.

The upstream opening 151 is formed by a left end portion of the upstream passage portion 153 and an upper plate surface of the passage partition portion 12. Accordingly, the upstream opening 151 opens toward the left side in the left-right direction DRw. That is, the upstream opening 151 faces the air flow upstream side in the external passage 111.

The upstream opening 151 is disposed downstream of the position of the second heat exchanger 32 in air flow in the external passage 111. The upstream opening 151 faces an air blowing side in the second heat exchanger 32.

The upstream opening 151 faces an air blowing side in the external blower fan 221 via the second heat exchanger 32. In other words, the upstream opening 151 opens toward the air blowing side in the external blower fan 221 via the second heat exchanger 32.

The downstream opening 152 is formed by a left end portion of the downstream passage portion 154 and a lower plate surface of the passage partition portion 12. Accordingly, the downstream opening 152 opens toward the left side in the left-right direction DRw. That is, the downstream opening 152 faces the air flow downstream side in the internal passage 112.

The downstream opening 152 is disposed downstream of a position of the first heat exchanger 31 in air flow in the internal passage 112.

The downstream opening 152 does not face the first heat exchanger 31. The downstream opening 152 is provided downstream of the internal blower fan 211 in air flow and does not face the internal blower fan 211. In other words, the downstream opening 152 does not open toward the internal blower fan 211.

The upstream opening 151 disposed in the external passage 111 is provided with the flow rate adjustment unit 50 that adjusts a flow rate of air flowing through the bypass passage 15. The flow rate adjustment unit 50 adjusts a flow rate of air introduced into the bypass passage 15 from the external passage 111 via the upstream opening 151.

An operation of the air conditioning system 1 according to the present embodiment configured as described above will be described with reference to FIGS. 19 and 20. FIG. 19 shows a flow of air flowing through the internal passage 112 and a flow of air flowing through the external passage 111 when the air conditioning system 1 operates in a heating mode. FIG. 20 shows a flow of air flowing through the internal passage 112 and a flow of air flowing through the external passage 111 when the air conditioning system 1 operates in a cooling mode.

When the air conditioning system 1 operates in the heating mode, the first heat exchanger 31 exchanges heat between a high-temperature and high-pressure refrigerant discharged from the electric compressor 34 and air flowing through the internal passage 112 to heat the air. As shown in FIG. 19, the air that has passed through the first heat exchanger 31 and has been heated flows to an area downstream of the first heat exchanger 31 in the internal passage 112.

The second heat exchanger 32 absorbs heat from the air flowing through the external passage 111 by utilizing latent heat of vaporization when the low-temperature and low-pressure refrigerant before being introduced into the electric compressor 34 evaporates. Accordingly, the air flowing through the external passage 111 is cooled when passing through the second heat exchanger 32, and flows through an area downstream of the second heat exchanger 32 in the external passage 111.

When the flow rate adjustment unit 50 is in an open state, the air that has passed through the second heat exchanger 32 and has been cooled flows in the area downstream of the second heat exchanger 32 in the external passage 111, and a part thereof is introduced into the bypass passage 15 from the upstream opening 151. At this time, a flow rate of the air introduced into the bypass passage 15 is adjusted by the flow rate adjustment unit 50 changing an opening degree of the upstream opening 151.

The air introduced into the bypass passage 15 flows from the left side to the right side through the upstream passage 153a, and is reversed in flow direction by the bypass bottom portion 155 to be introduced into the downstream passage 154a through the through hole 121 of the passage partition portion 12. The air introduced into the downstream passage 154a flows through the downstream passage 154a from the right side to the left side, and is blown out of the downstream opening 152 to an area downstream of the bypass passage 15 in air flow in the internal passage 112.

The air blown from the downstream opening 152 to the internal passage 112 is mixed with air heated by the first heat exchanger 31 in the area downstream of the first heat exchanger 31 in air flow. Accordingly, the air heated by the first heat exchanger 31 is mixed with the air cooled to a temperature lower than the air flowing through the internal passage 112 by the second heat exchanger 32, and is cooled to a temperature lower than a temperature after passing through the first heat exchanger 31. The air cooled by being mixed with the air cooled by the second heat exchanger 32 is blown into a vehicle compartment via the internal opening 112c.

When the air conditioning system 1 operates in the cooling mode, the first heat exchanger 31 absorbs heat from the air flowing through the internal passage 112 by utilizing latent heat of vaporization when a low-temperature and low-pressure refrigerant before being introduced into the electric compressor 34 evaporates, and cools the air. As shown in FIG. 20, the air that has passed through the first heat exchanger 31 and has been cooled flows to the area downstream of the first heat exchanger 31 in air flow in the internal passage 112.

The second heat exchanger 32 exchanges heat between a high-temperature and high-pressure refrigerant discharged from the electric compressor 34 and air flowing through the external passage 111, thereby releasing heat of the refrigerant to the air flowing through the external passage 111. Accordingly, the air flowing through the external passage 111 is heated when passing through the second heat exchanger 32, and flows in the area downstream of the second heat exchanger 32 in the external passage 111.

When the flow rate adjustment unit 50 is in an open state, the air that has passed through the second heat exchanger 32 and has been heated flows in the area downstream side of the second heat exchanger 32 in air flow in the external passage 111, and a part thereof is introduced into the bypass passage 15 from the upstream opening 151. At this time, a flow rate of the air introduced into the bypass passage 15 is adjusted by the flow rate adjustment unit 50 changing an opening degree of the upstream opening 151.

The air introduced into the bypass passage 15 flows from the left side to the right side through the upstream passage 153a, and is reversed in flow direction by the bypass bottom portion 55 to be introduced into the downstream passage 154a through the through hole 121 of the passage partition portion 12. The air introduced into the downstream passage 154a flows through the downstream passage 154a from the right side to the left side, and is blown out of the downstream opening 152 to the area downstream of the bypass passage 15 in air flow in the internal passage 112.

The air blown from the downstream opening 152 to the internal passage 112 is mixed with air cooled by the first heat exchanger 31 in the area downstream of the first heat exchanger 31 in air flow. Accordingly, the air cooled by the first heat exchanger 31 is mixed with the air heated to a temperature higher than the air flowing through the internal passage 112 by the second heat exchanger 32, and is heated to a temperature higher than a temperature after passing through the first heat exchanger 31. The heated air mixed with the air heated by the second heat exchanger 32 is blown into the vehicle compartment via the internal opening 112c.

Thus, in the air conditioning system 1 according to the present embodiment, when the air conditioning system 1 operates in the heating mode and the cooling mode, a temperature of air blown into the vehicle compartment can be heated or cooled by using the air discharged to an outside of the vehicle compartment by the refrigerant circulating in a refrigeration cycle releasing heat.

The control device 70 controls an operation of the flow rate adjustment unit 50 based on sensor information input from various sensor groups provided in the air conditioning system 1. For example, the control device 70 may control the operation of the flow rate adjustment unit 50 based on temperature information on the air passed through the first heat exchanger 31, temperature information on air passed through the second heat exchanger 32, pressure information on a refrigerant discharged from the electric compressor 34, and the like. The control device 70 may control the operation of the flow rate adjustment unit 50 based on temperature information on air introduced into the external passage 111 and the internal passage 112.

By adjusting a flow rate of air introduced into the bypass passage 15 by changing an opening degree of the upstream opening 151 by the flow rate adjustment unit 50, a temperature of air blown into the vehicle compartment can be adjusted.

As a method of cooling the air heated by the first heat exchanger 31 to adjust the temperature of the air blown into the vehicle compartment, there is a method of adding an evaporator in the area downstream of the first heat exchanger 31 in air flow in the internal passage 112. In this case, the refrigeration cycle device 30 is provided with a third heat exchanger that is an evaporator in addition to the first heat exchanger 31 and the second heat exchanger 32.

As a method of heating the air cooled by the first heat exchanger 31 to adjust the temperature of the air blown into the vehicle compartment, there is a method of adding a heater core or an electric heater in the area downstream of the first heat exchanger 31 in air flow in the internal passage 112. When the heater core is added, the refrigeration cycle device 30 is provided with a third heat exchanger that is a heater core in addition to the first heat exchanger 31 and the second heat exchanger 32.

However, when the refrigerant flows through the evaporator or the heater core, a pressure loss occurs. Therefore, the method of adjusting the temperature of the air blown into the vehicle compartment by adding the evaporator or the heater core to the refrigeration cycle device 30 is a factor of increasing the pressure loss when the refrigerant circulates in the refrigerant circuit 33. When the pressure loss increases when the refrigerant circulates through the refrigerant circuit 33, it becomes difficult for the refrigerant to circulate, so that it is necessary to take measures such as increasing a rotation speed of the electric motor 341 of the electric compressor 34 in response to the increase in pressure loss.

Therefore, when an evaporator or a heater core for adjusting the temperature of the air blown into the vehicle compartment is added to the internal passage 112, efficiency of the refrigeration cycle is deteriorated. When an electric heater is added, energy consumption of the air conditioning system 1 increases.

In contrast, in the air conditioning system 1 according to the present embodiment, by adjusting the flow rate of the air flowing through the bypass passage 15 by the flow rate adjustment unit 50, it is possible to adjust a temperature of the air blown into the vehicle compartment by using air discharged to the outside of the vehicle compartment. Therefore, the rotation speed of the electric motor 341 of the electric compressor 34 can be reduced as compared with a case where an evaporator or a heater core is added to the internal passage 112. Therefore, efficiency of the refrigeration cycle in the air conditioning system 1 can be improved. The energy consumption of the air conditioning system 1 can be reduced as compared with a case where an electric heater is added.

According to the above embodiment, the following effects can be obtained.

(1) In the above embodiment, the upstream opening 151, which is the air flow upstream end of the bypass passage 15, is disposed downstream of the position of the second heat exchanger 32 in air flow in the external passage 111.

Accordingly, the air after passing through the second heat exchanger 32 can be guided to the internal passage 112 via the bypass passage 15. Therefore, it is possible to avoid a decrease in a flow rate of the air flowing into the second heat exchanger 32 as compared with a configuration in which the upstream opening 151 is provided upstream of the position of the second heat exchanger 32 in air flow in the external passage 111.

A case where the upstream opening 151 is provided upstream of the position of the second heat exchanger 32 in air flow in the external passage 111 will be considered. In this case, a part of air flowing in the area upstream of the second heat exchanger 32 in the external passage 111 flows into the internal passage 112 via the bypass passage 15, so that a flow rate of air flowing into the second heat exchanger 32 per unit time is reduced as compared with the present embodiment. When the external air blowing unit 22 exchanges heat between the refrigerant and air, an amount of heat per unit time decreases, so that performance of the second heat exchanger 32 decreases. When the performance of the second heat exchanger 32 decreases, it is necessary to increase the rotation speed of the electric motor 341 of the electric compressor 34 by an amount by which the performance of the second heat exchanger 32 decreases.

However, according to the present embodiment, the upstream opening 151 is disposed downstream of the position of the second heat exchanger 32 in air flow in the external passage 111. Therefore, it is possible to prevent a part of the air flowing in the area upstream of the second heat exchanger 32 from flowing into the internal passage 112. Therefore, it is possible to avoid an increase in the rotation speed of the electric motor 341 of the electric compressor 34 due to a decrease in the flow rate of the air flowing into the second heat exchanger 32. Therefore, the efficiency of the refrigeration cycle can be improved as compared with a configuration in which the upstream opening 151 is provided upstream the position of the second heat exchanger 32 in air flow in the external passage 111.

(2) In the above embodiment, the downstream opening 152, which is the air flow downstream end of the bypass passage 15, is disposed downstream of the position of the first heat exchanger 31 in air flow in the internal passage 112.

Accordingly, the air flowing through the external passage 111 is capable of flowing to the area downstream of the position of the first heat exchanger 31 in air flow in the internal passage 112 via the bypass passage 15. Therefore, when the air conditioning system 1 operates in the heating mode and the cooling mode, a temperature of air heated and cooled in the first heat exchanger 31 can be easily adjusted.

### Modification of Third Embodiment

In the third embodiment described above, the air conditioning system 1 is described in an example in which the internal air blowing unit 21 is provided upstream of the position of the first heat exchanger 31 in air flow in the internal passage 112. The air conditioning system 1 is described in an example in which the external air blowing unit 22 is provided upstream of the position of the second heat exchanger 32 in air flow in the external passage 111. However, positions where the internal air blowing unit 21 and the external air blowing unit 22 are disposed are not limited thereto.

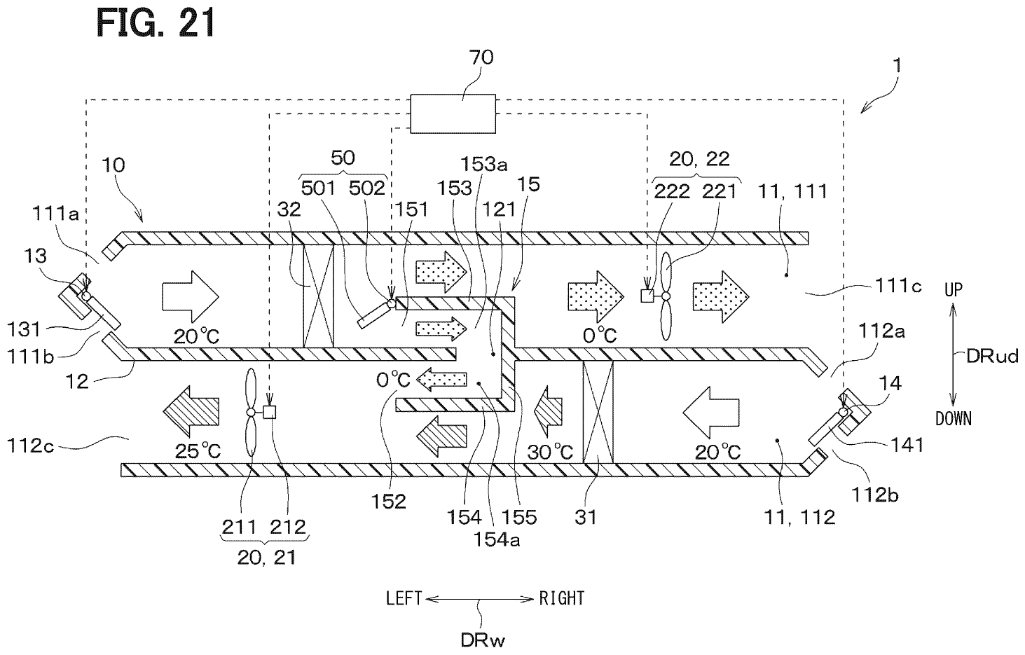

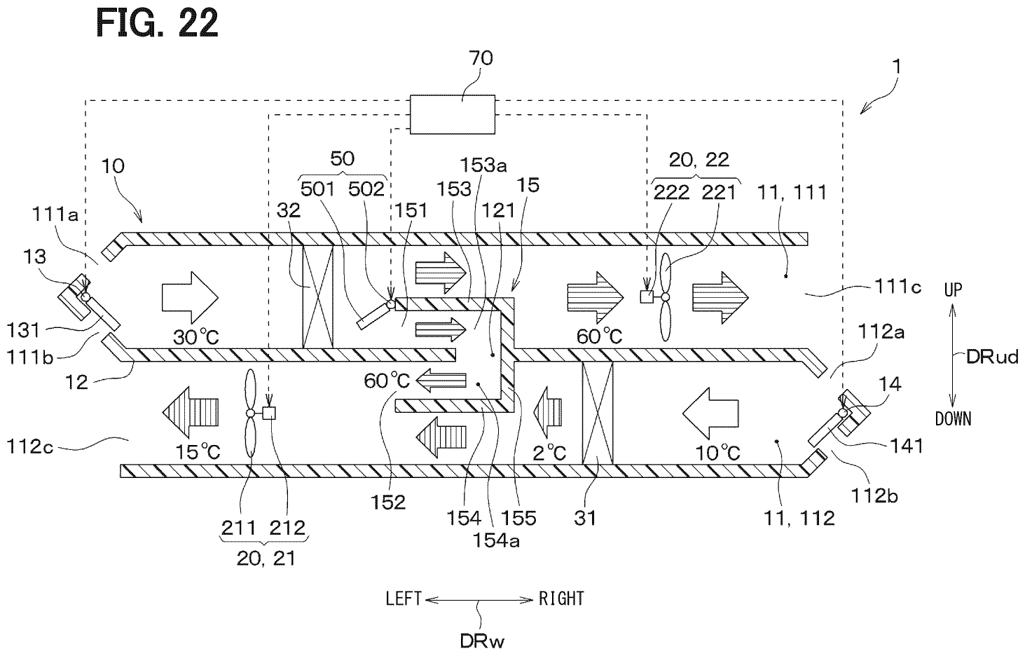

For example, in the air conditioning system 1, the internal air blowing unit 21 and the external air blowing unit 22 may be disposed at positions shown in FIGS. 21 and 22. Specifically, in the air conditioning system 1, the internal air blowing unit 21 may be provided downstream of a position of the first heat exchanger 31 in air flow in the internal passage 112, and the external air blowing unit 22 may be provided downstream of a position of the second heat exchanger 32 in air flow in the external passage 111.

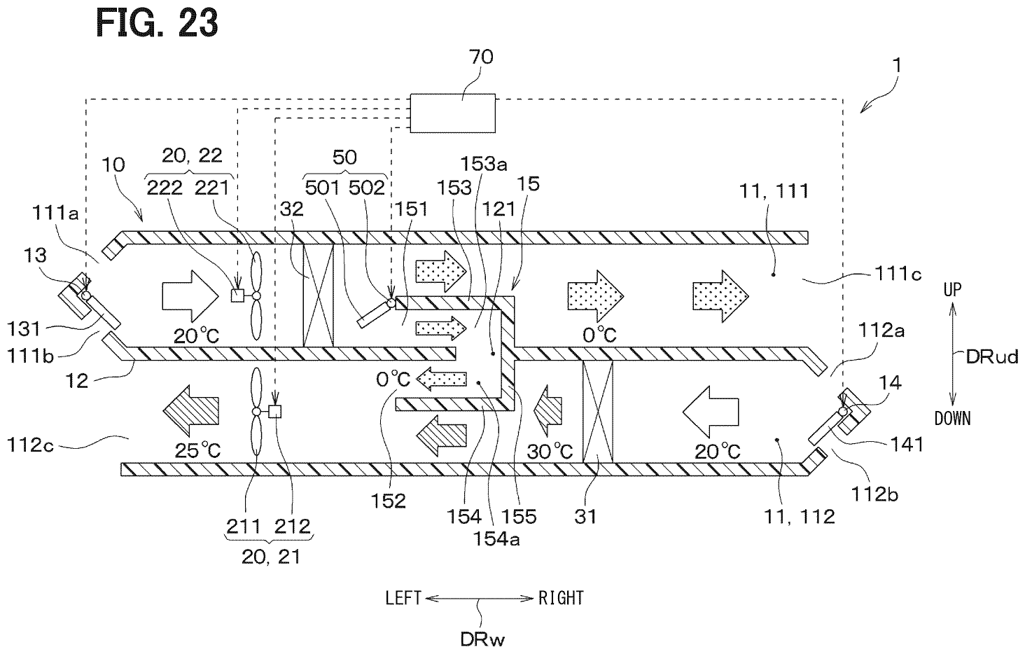

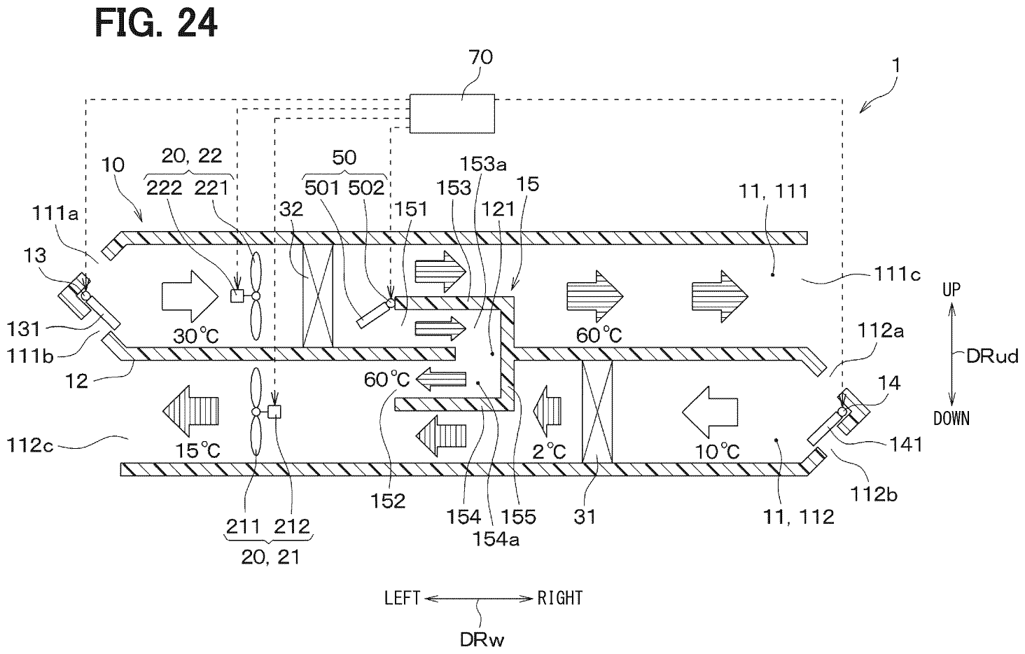

In the air conditioning system 1, the internal air blowing unit 21 and the external air blowing unit 22 may be disposed at positions shown in FIGS. 23 and 24. Specifically, in the air conditioning system 1, the internal air blowing unit 21 may be provided downstream of a position of the first heat exchanger 31 in air flow in the internal passage 112, and the external air blowing unit 22 may be provided upstream of a position of the second heat exchanger 32 in air flow in the external passage 111.

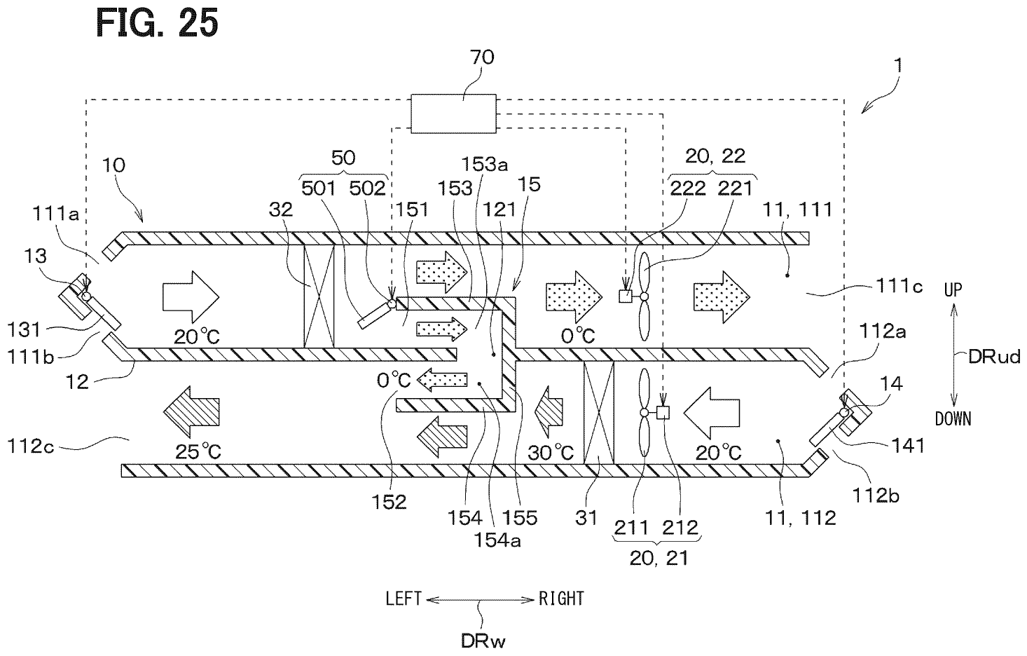

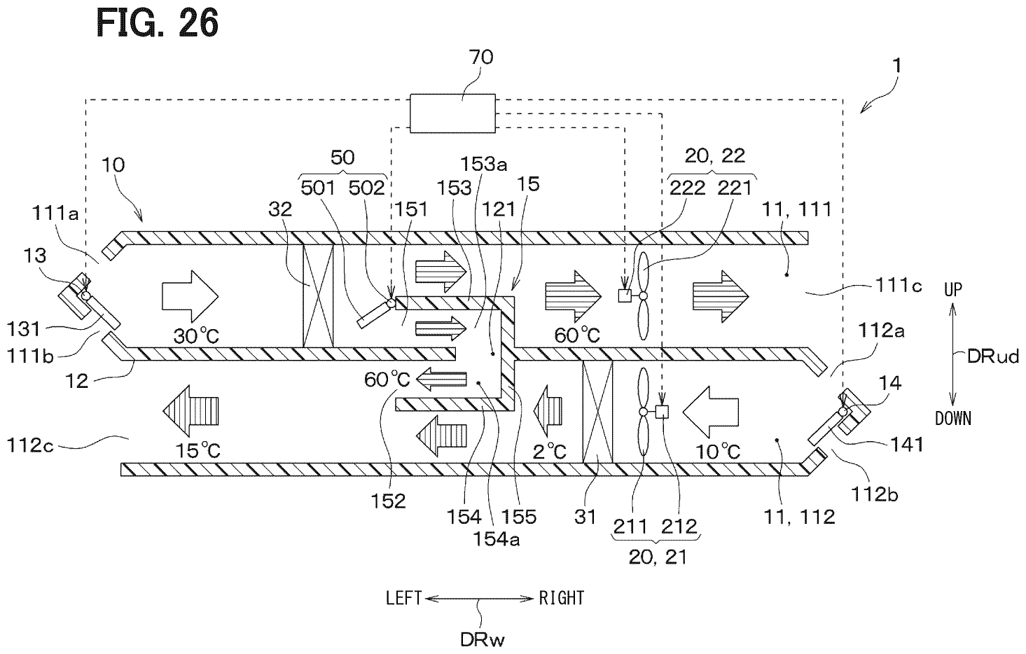

In the air conditioning system 1, the internal air blowing unit 21 and the external air blowing unit 22 may be disposed at positions shown in FIGS. 25 and 26. Specifically, in the air conditioning system 1, the internal air blowing unit 21 may be provided upstream of a position of the first heat exchanger 31 in air flow in the internal passage 112, and the external air blowing unit 22 may be provided downstream of the position of the second heat exchanger 32 in air flow in the external passage 111.

FIGS. 21, 23, and 25 show the flows of air flowing through the internal passage 112 and the flows of air flowing through the external passage 111 when the air conditioning system 1 operates in the heating mode. FIGS. 22, 24, and 26 show the flows of air flowing through the internal passage 112 and the flows of air flowing through the external passage 111 when the air conditioning system 1 operates in the cooling mode.

In the present embodiment shown in FIGS. 25 and 26, the upstream opening 151 that faces the air flow upstream side in the external passage 111 is disposed upstream of the external blower fan 221 in air flow in the external passage 111. The downstream opening 152 that faces the air flow downstream side in the internal passage 112 is disposed downstream of the internal blower fan 211 in air flow in the internal passage 112.

In this case, when an air pressure at the air flow downstream opening 152 side is higher than an air pressure at the upstream opening 151 side, air flowing through the external passage 111 hardly flows into the internal passage 112 via the bypass passage 15. Therefore, by appropriately adjusting rotation speeds of the internal motor 212 and the external motor 222 and reducing the air pressure at the air flow downstream opening 152 side to be smaller than the air pressure at the upstream opening 151 side, the air flowing through the external passage 111 easily flows into the internal passage 112 via the bypass passage 15. Accordingly, similar effects as in the first embodiment can be obtained based on a configuration that is similar or equivalent to that in the third embodiment.

### Fourth Embodiment

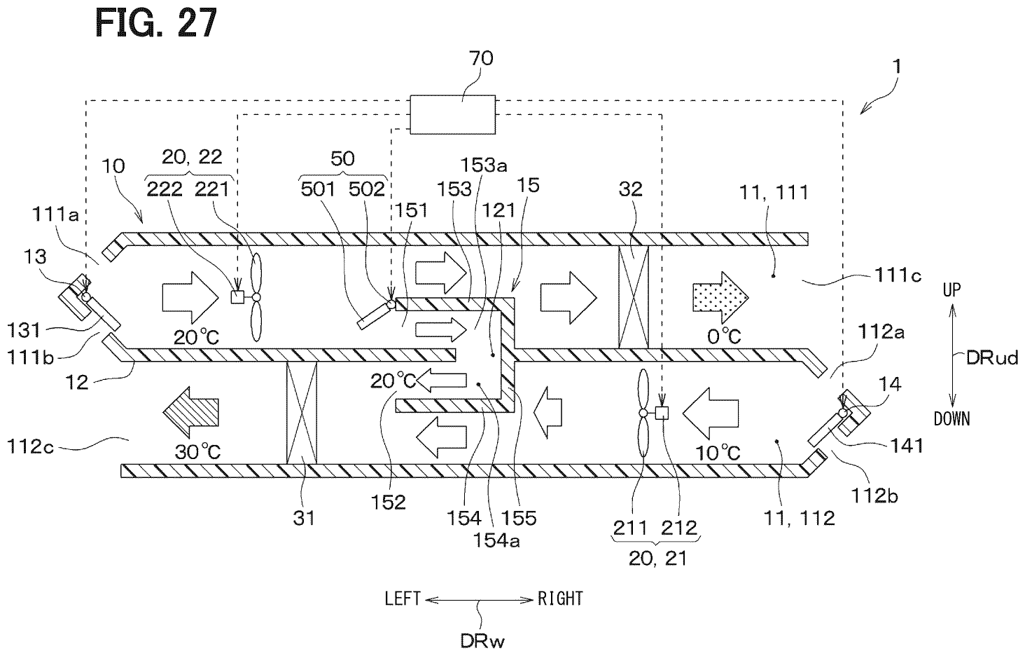

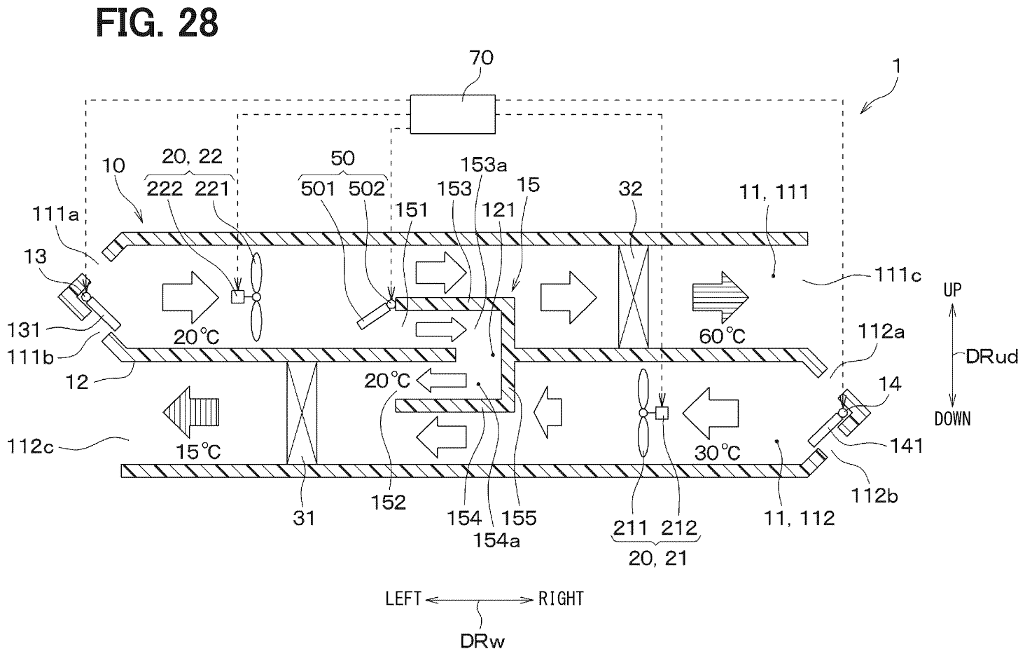

Next, a fourth embodiment will be described with reference to FIGS. 27 and 28. The present embodiment is different from the third embodiment in positions where the first heat exchanger 31 and the second heat exchanger 32 are disposed. The other configuration is similar as that of the first embodiment. Therefore, in the present embodiment, portions different from the first embodiment will be mainly described, and description of portions similar to the third embodiment may be omitted.

As shown in FIGS. 27 and 28, the first heat exchanger 31 according to the present embodiment is provided downstream of a position of the internal air blowing unit 21 and downstream of the downstream opening 152 of the bypass passage 15 in air flow in the internal passage 112. Therefore, the downstream opening 152 according to the present embodiment faces an air suction side in the first heat exchanger 31.

As shown in FIGS. 27 and 28, the second heat exchanger 32 according to the present embodiment is provided downstream of a position of the external air blowing unit 22 and downstream of the upstream opening 151 of the bypass passage 15 in air flow in the external passage 111. Therefore, the upstream opening 151 according to the present embodiment does not face the second heat exchanger 32. In other words, the upstream opening 151 is disposed upstream of a position of the second heat exchanger 32 in air flow in the external passage 111. The upstream opening 151 faces an air blowing side in the external blower fan 221.

FIG. 27 shows a flow of air flowing through the internal passage 112 and a flow of air flowing through the external passage 111 when the air conditioning system 1 operates in a heating mode. FIG. 28 shows a flow of air flowing through the internal passage 112 and a flow of air flowing through the external passage 111 when the air conditioning system 1 operates in a cooling mode.

Other configurations are similar as those in the third embodiment described above. Therefore, similar effects as in the third embodiment can be obtained based on a configuration that is similar or equivalent to that in the third embodiment.

The upstream opening 151 according to the present embodiment is disposed upstream of the position of the second heat exchanger 32 in air flow in the external passage 111. Therefore, when the air conditioning system 1 operates in the heating mode, unlike the third embodiment, air cooled by the second heat exchanger 32 cannot be guided to the internal passage 112 via the bypass passage 15. Therefore, when the air conditioning system 1 operates in the heating mode, a temperature of air flowing through the internal passage 112 cannot be adjusted using the air cooled by the second heat exchanger 32.

When the air conditioning system 1 operates in the cooling mode, unlike the third embodiment, air cooled by the second heat exchanger 32 cannot be guided to the internal passage 112 via the bypass passage 15. Therefore, when the air conditioning system 1 operates in the cooling mode, a temperature of air flowing through the internal passage 112 cannot be adjusted using the air heated by the second heat exchanger 32.

However, when the air conditioning system 1 operates in the heating mode and the cooling mode, air before being heated and cooled by the second heat exchanger 32 can be guided to the internal passage 112 via the bypass passage 15. A temperature of air flowing into the second heat exchanger 32 can be changed by mixing the air before being heated and cooled by the second heat exchanger 32 with air flowing in an area upstream of the second heat exchanger 32 in air flow in the internal passage 112.

Therefore, the bypass passage 15 may be opened and closed by controlling opening and closing of the flow rate adjustment unit 50 according to a temperature difference between internal blown air and external blown air.

For example, when the air conditioning system 1 operates in the heating mode, when a temperature of the external blown air is higher than a temperature of the internal blown air, the flow rate adjustment unit 50 may be opened, and air flowing through the external passage 111 may flow to the internal passage 112 via the bypass passage 15. Accordingly, when the air conditioning system 1 operates in the heating mode, a temperature of the air flowing into the first heat exchanger 31 can be increased by mixing the external blown air and the internal blown air. Therefore, when the air conditioning system 1 operates in the heating mode, a heat absorption amount absorbed by a refrigerant from air per unit flow rate in the first heat exchanger 31 can be increased. A required rotation speed of the electric motor 341 of the electric compressor 34 for obtaining required heating performance when the air conditioning system 1 operates in the heating mode can be reduced. Therefore, efficiency of the refrigeration cycle in the air conditioning system 1 can be improved.

In contrast, when the air conditioning system 1 operates in the heating mode, when the temperature of the external blown air is lower than the temperature of the internal blown air, the flow rate adjustment unit 50 may be closed to prevent the air flowing through the external passage 111 from flowing to the internal passage 112. Accordingly, when the air conditioning system 1 operates in the heating mode, it is possible to avoid a decrease in the temperature of the air flowing into the first heat exchanger 31 caused by mixing the air flowing through the external passage 111, which has a lower temperature than the air flowing through the internal passage 112, with the air flowing through the internal passage 112. Therefore, when the air conditioning system 1 operates in the heating mode, it is possible to avoid a decrease in the heat absorption amount absorbed by the refrigerant from air per unit flow rate in the first heat exchanger 31.

When the air conditioning system 1 operates in the cooling mode, when the temperature of the external blown air is lower than the temperature of the internal blown air, the flow rate adjustment unit 50 may be opened, and air flowing through the external passage 111 may flow to the internal passage 112 via the bypass passage 15. Accordingly, when the air conditioning system 1 operates in the cooling mode, a temperature of the air flowing into the first heat exchanger 31 can be reduced by mixing the external blown air and the internal blown air. Therefore, when the air conditioning system 1 operates in the cooling mode, a heat absorption amount absorbed by a refrigerant from air per unit flow rate in the first heat exchanger 31 can be increased.

The required rotation speed of the electric motor 341 of the electric compressor 34 for obtaining the required cooling performance when the air conditioning system 1 operates in the cooling mode can be reduced. Therefore, efficiency of the refrigeration cycle in the air conditioning system 1 can be improved.

In contrast, when the air conditioning system 1 operates in the cooling mode, when the temperature of the external blown air is higher than the temperature of the internal blown air, the flow rate adjustment unit 50 may be closed to prevent the air flowing through the external passage 111 from flowing to the internal passage 112. Accordingly, when the air conditioning system 1 operates in the cooling mode, it is possible to avoid an increase in the temperature of the air flowing into the first heat exchanger 31 caused by mixing the air flowing through the external passage 111, which has a higher temperature than the air flowing through the internal passage 112, with the air flowing through the internal passage 112. Therefore, when the air conditioning system 1 operates in the cooling mode, it is possible to avoid a decrease in the heat absorption amount absorbed by the refrigerant from air per unit flow rate in the first heat exchanger 31.

### Modification of Fourth Embodiment

In the fourth embodiment described above, the air conditioning system 1 is described in an example in which the internal air blowing unit 21 is provided upstream of the position of the first heat exchanger 31 in air flow in the internal passage 112. The air conditioning system 1 is described in an example in which the external air blowing unit 22 is provided upstream of the position of the second heat exchanger 32 in air flow in the external passage 111. However, positions where the internal air blowing unit 21 and the external air blowing unit 22 are disposed are not limited thereto.

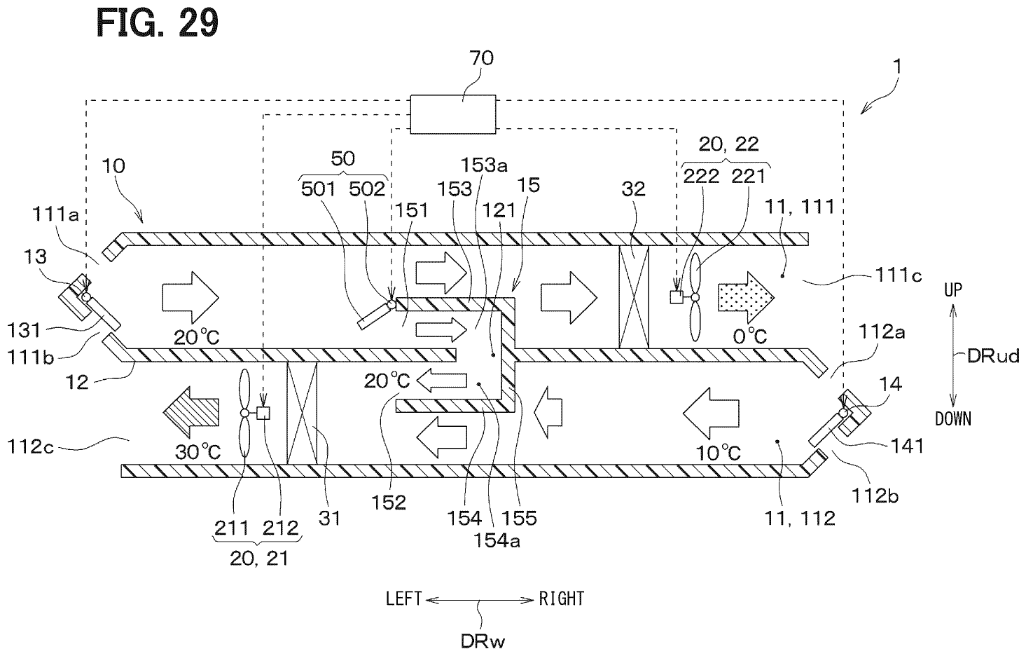

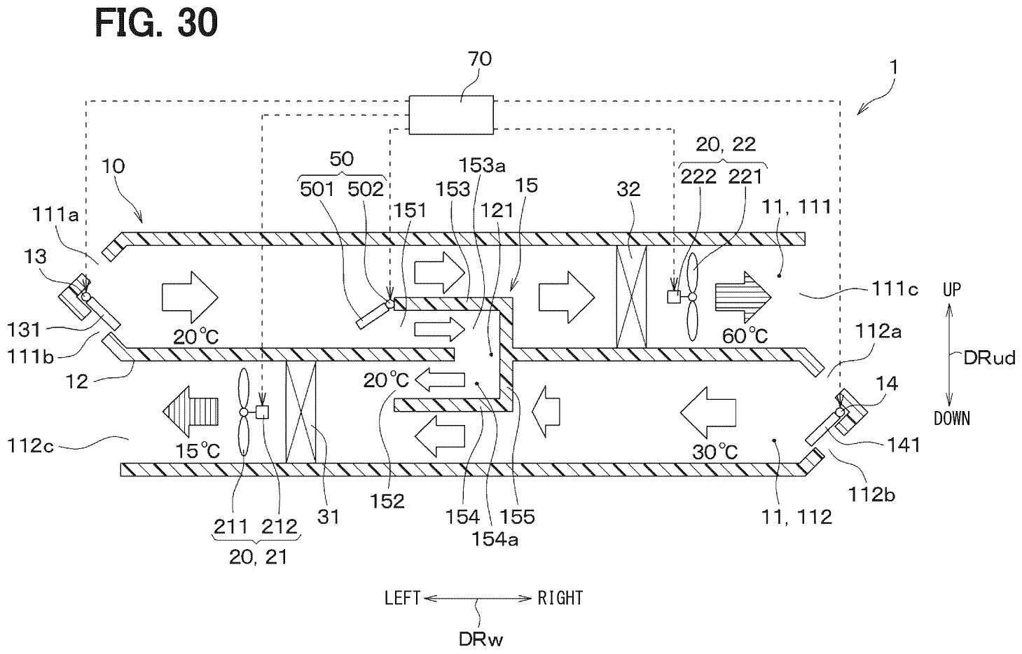

For example, in the air conditioning system 1, the internal air blowing unit 21 and the external air blowing unit 22 may be disposed at positions shown in FIGS. 29 and 30. Specifically, in the air conditioning system 1, the internal air blowing unit 21 may be provided downstream of a position of the first heat exchanger 31 in air flow in the internal passage 112, and the external air blowing unit 22 may be provided downstream of a position of the second heat exchanger 32 in air flow in the external passage 111.

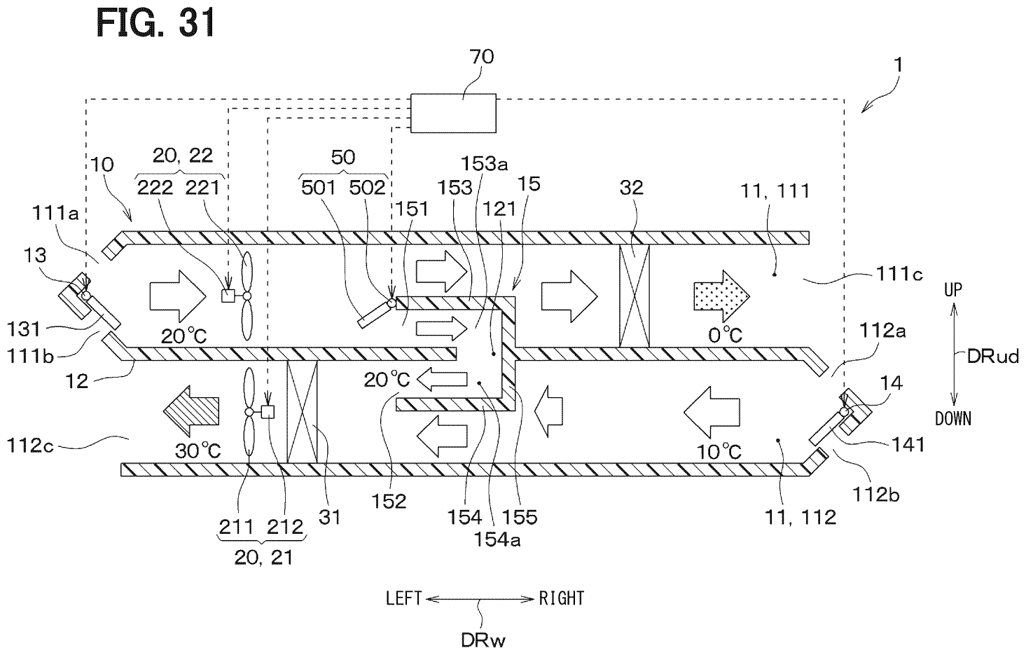

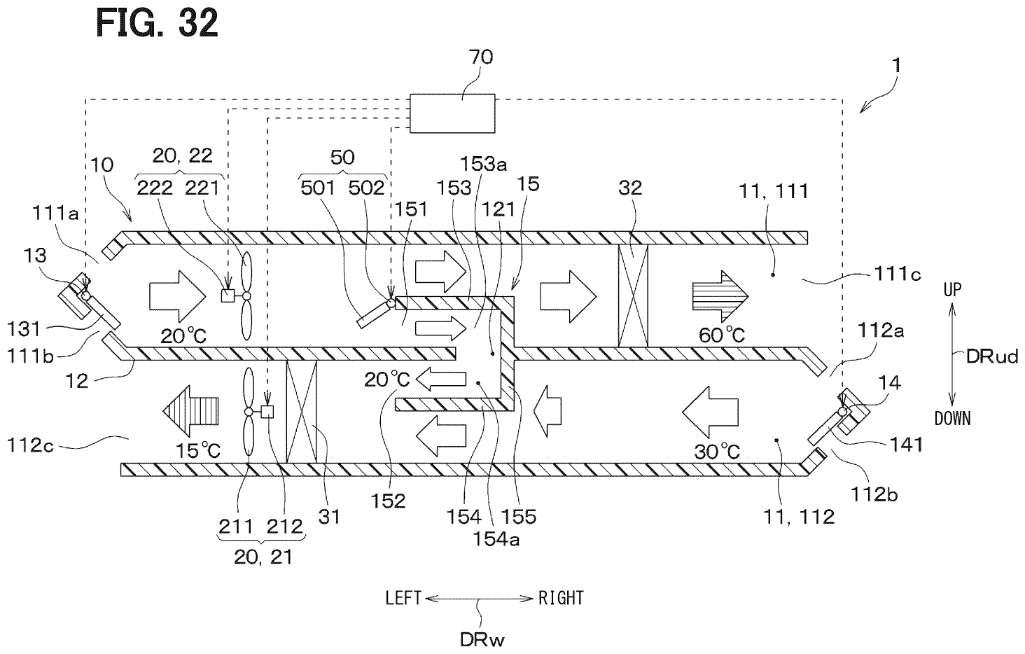

In the air conditioning system 1, the internal air blowing unit 21 and the external air blowing unit 22 may be disposed at positions shown in FIGS. 31 and 32. Specifically, in the air conditioning system 1, the internal air blowing unit 21 may be provided downstream of a position of the first heat exchanger 31 in air flow in the internal passage 112, and the external air blowing unit 22 may be provided upstream of a position of the second heat exchanger 32 in air flow in the external passage 111.

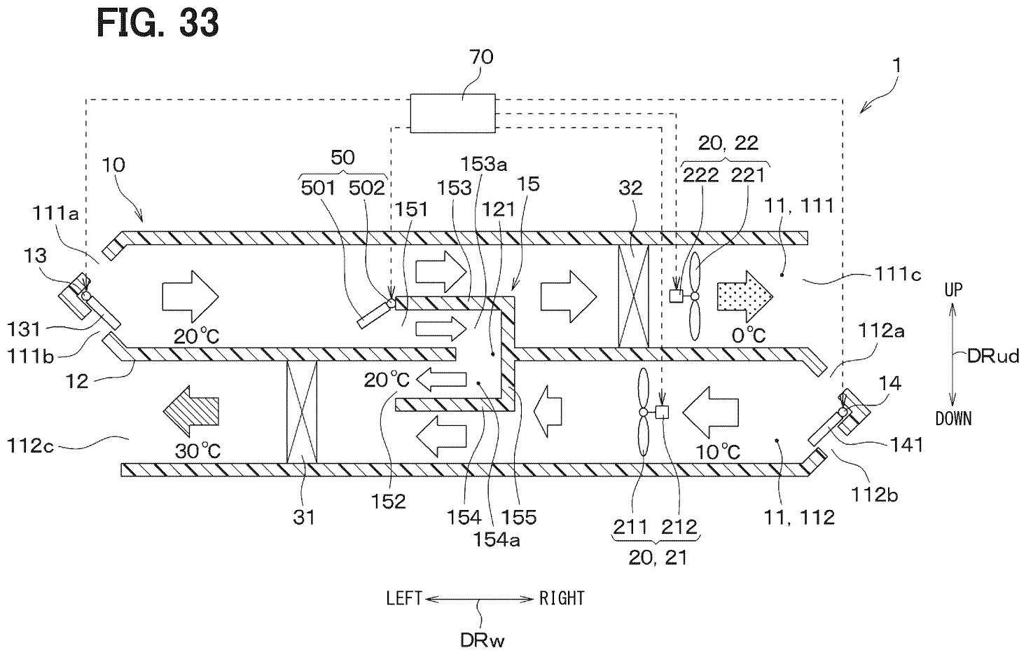

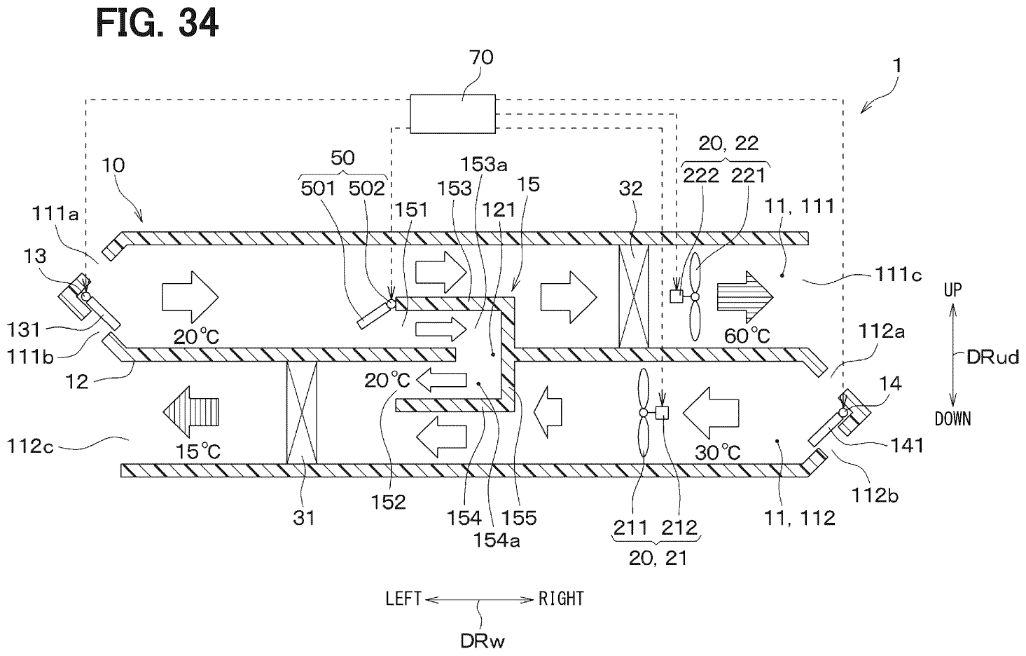

In the air conditioning system 1, the internal air blowing unit 21 and the external air blowing unit 22 may be disposed at positions shown in FIGS. 33 and 34. Specifically, in the air conditioning system 1, the internal air blowing unit 21 may be provided upstream of a position of the first heat exchanger 31 in air flow in the internal passage 112, and the external air blowing unit 22 may be provided downstream of the position of the second heat exchanger 32 in air flow in the external passage 111.

FIGS. 29, 31, and 33 show the flows of air flowing through the internal passage 112 and the flows of air flowing through the external passage 111 when the air conditioning system 1 operates in the heating mode. FIGS. 30, 32, and 34 show the flows of air flowing through the internal passage 112 and the flows of air flowing through the external passage 111 when the air conditioning system 1 operates in the cooling mode.

### Fifth Embodiment

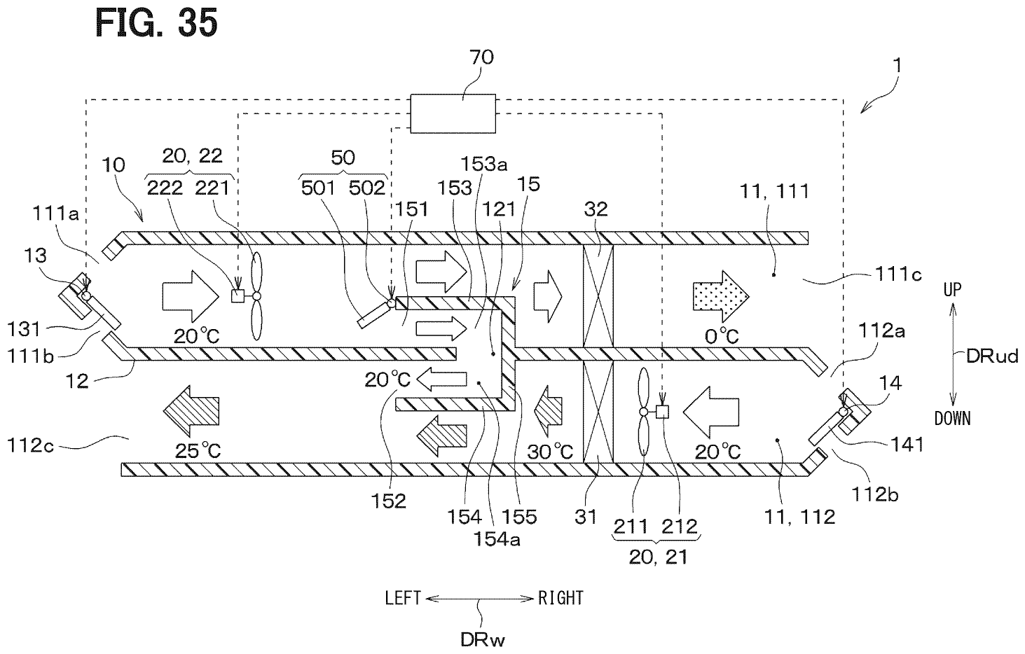

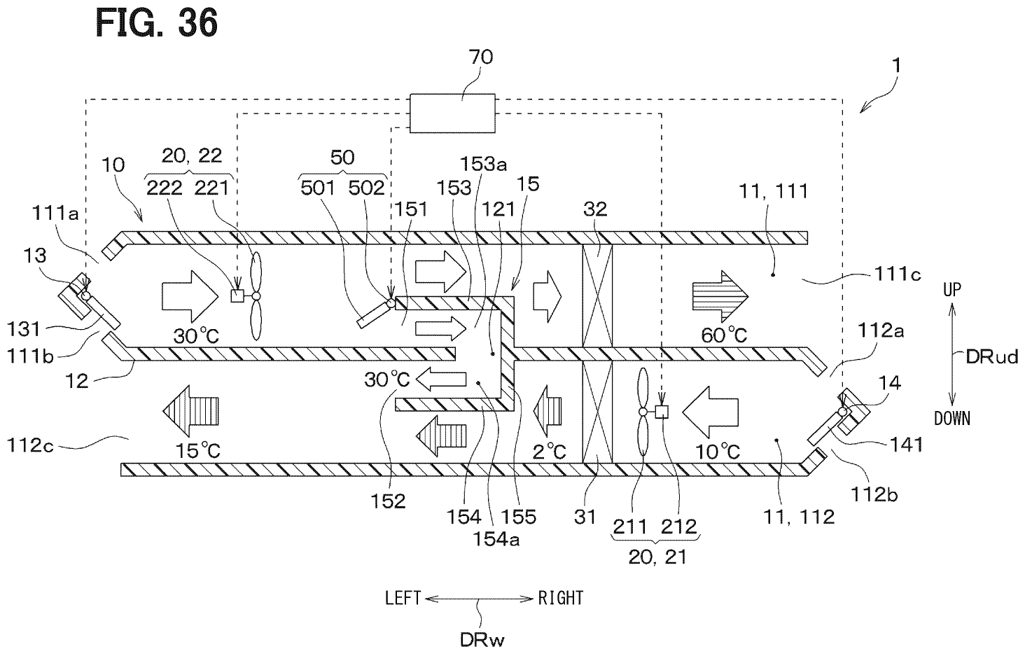

Next, a fifth embodiment will be described with reference to FIGS. 35 and 36. The present embodiment is different from the third embodiment in a position where the second heat exchanger 32 is disposed. The other configuration is the same as that of the third embodiment. Therefore, in the present embodiment, portions different from the first embodiment will be mainly described, and description of portions similar to the third embodiment may be omitted.

As shown in FIGS. 35 and 36, the second heat exchanger 32 according to the present embodiment is provided downstream of a position of the external air blowing unit 22 and downstream of the upstream opening 151 of the bypass passage 15 in air flow in the external passage 111. Therefore, the upstream opening 151 according to the present embodiment does not face the second heat exchanger 32. In other words, the upstream opening 151 is disposed upstream of a position of the second heat exchanger 32 in air flow in the external passage 111.

FIG. 35 shows a flow of air flowing through the internal passage 112 and a flow of air flowing through the external passage 111 when the air conditioning system 1 operates in a heating mode. FIG. 36 shows a flow of air flowing through the internal passage 112 and a flow of air flowing through the external passage 111 when the air conditioning system 1 operates in a cooling mode.

Other configurations are similar as those in the third embodiment described above. Therefore, similar effects as in the third embodiment can be obtained based on a configuration that is similar or equivalent to that in the third embodiment.

### Modification of Fifth Embodiment

In the fifth embodiment described above, the air conditioning system 1 is described in an example in which the internal air blowing unit 21 is provided upstream of the position of the first heat exchanger 31 in air flow in the internal passage 112. The air conditioning system 1 is described in an example in which the external air blowing unit 22 is provided upstream of the position of the second heat exchanger 32 in air flow in the external passage 111. However, positions where the internal air blowing unit 21 and the external air blowing unit 22 are disposed are not limited thereto.

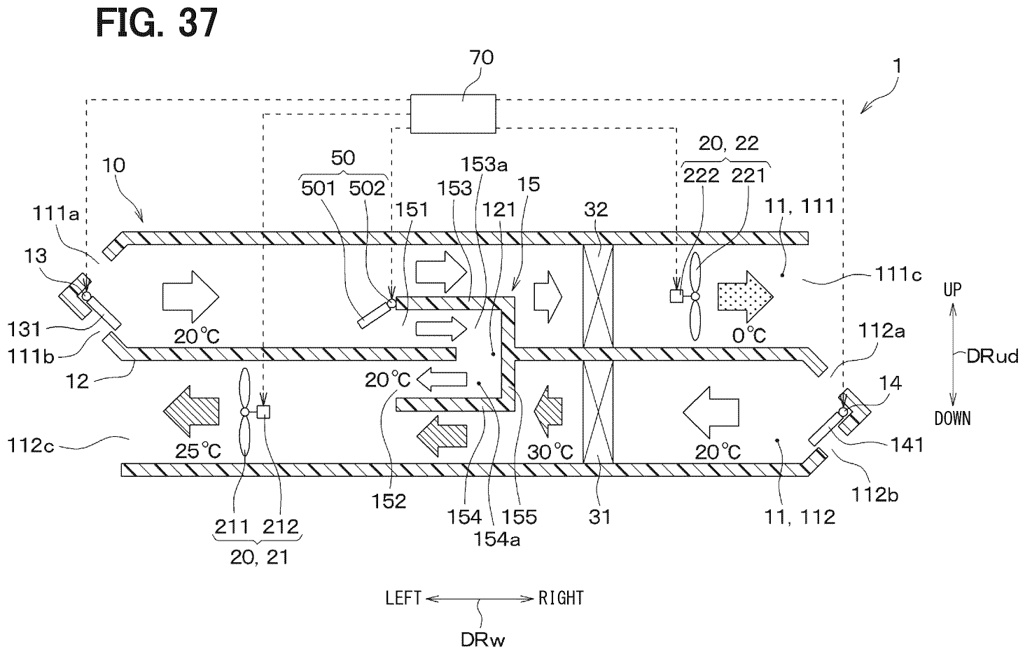

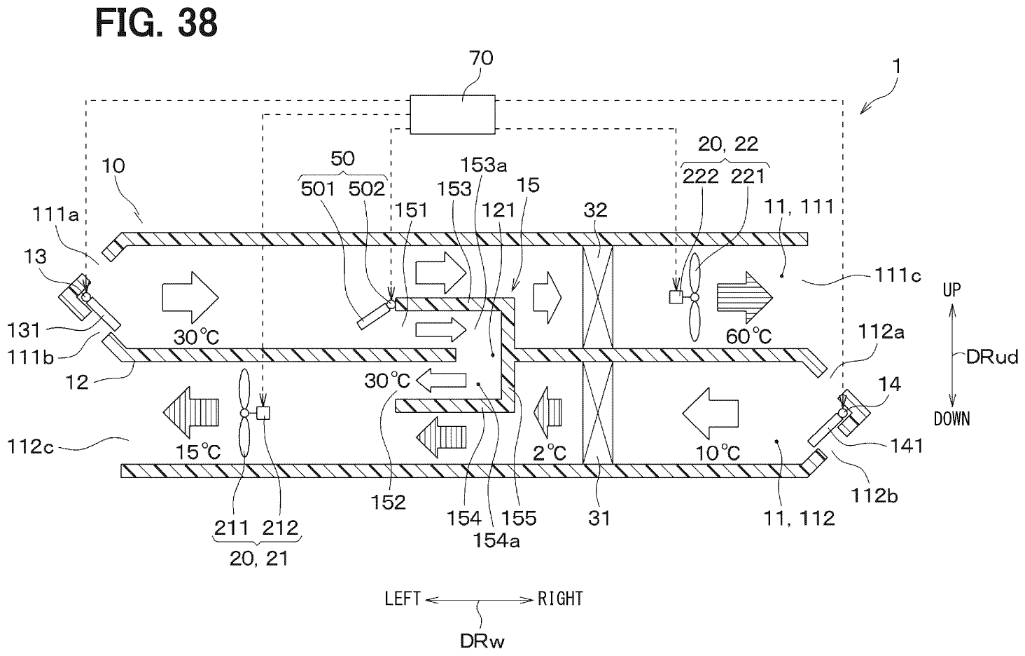

For example, in the air conditioning system 1, the internal air blowing unit 21 and the external air blowing unit 22 may be disposed at positions shown in FIGS. 37 and 38. Specifically, in the air conditioning system 1, the internal air blowing unit 21 may be provided downstream of a position of the first heat exchanger 31 in the internal passage 112, and the external air blowing unit 22 may be provided downstream of a position of the second heat exchanger 32 in the external passage 111.

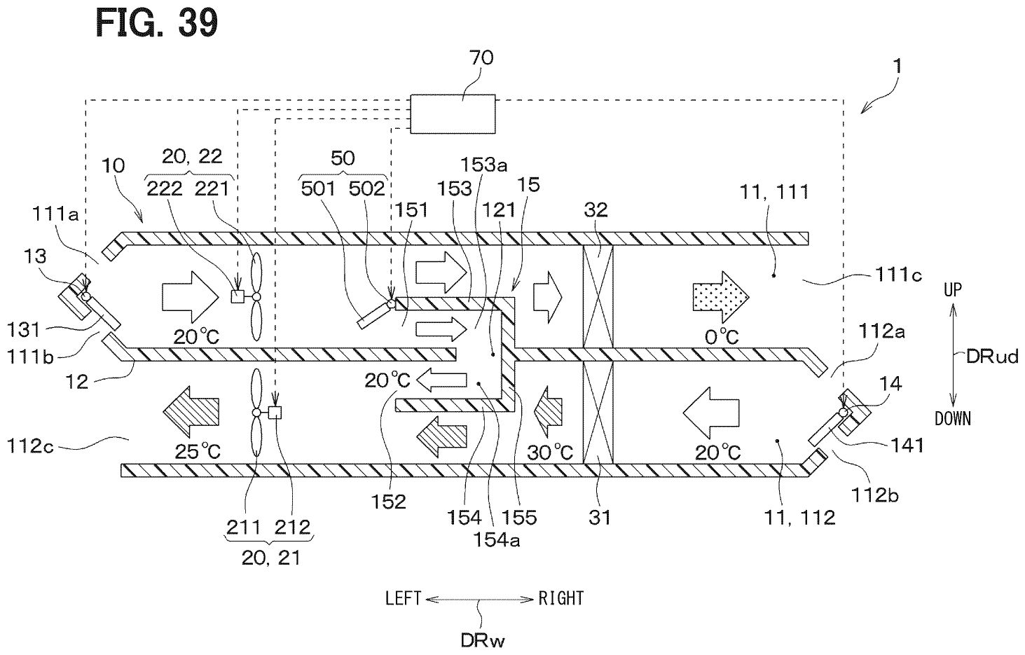

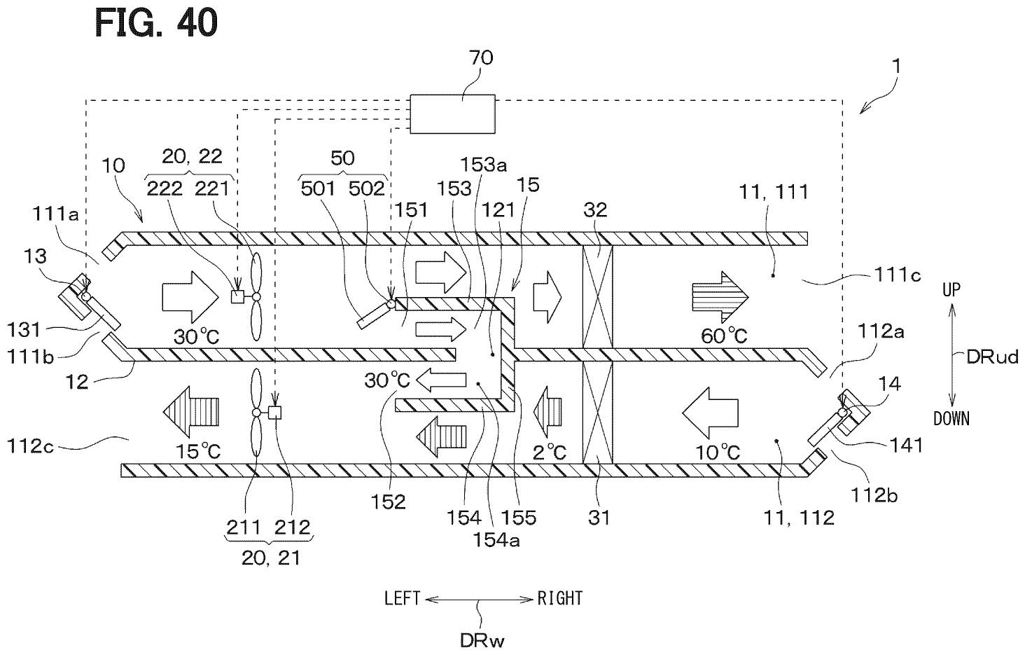

In the air conditioning system 1, the internal air blowing unit 21 and the external air blowing unit 22 may be disposed at positions shown in FIGS. 39 and 40. Specifically, in the air conditioning system 1, the internal air blowing unit 21 may be provided downstream of a position of the first heat exchanger 31 in air flow in the internal passage 112, and the external air blowing unit 22 may be provided upstream of a position of the second heat exchanger 32 in air flow in the external passage 111.

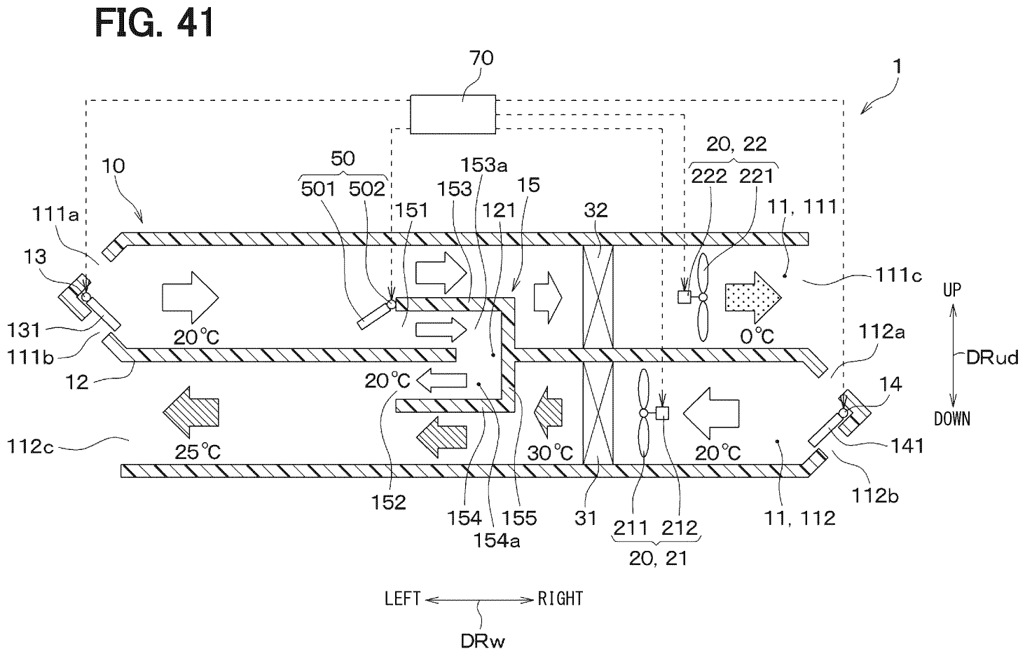

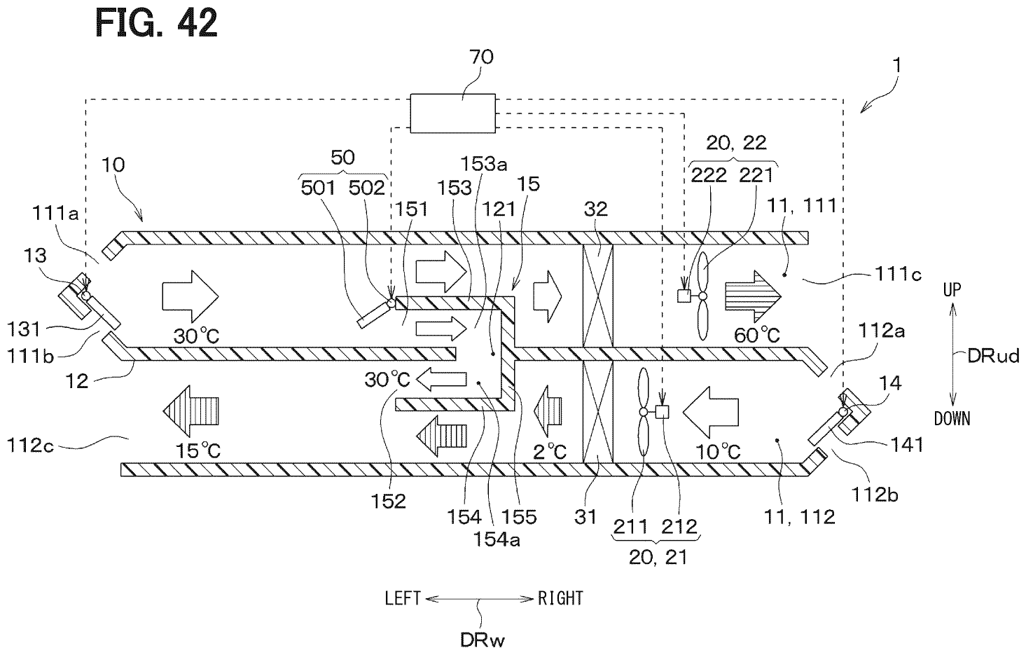

In the air conditioning system 1, the internal air blowing unit 21 and the external air blowing unit 22 may be disposed at positions shown in FIGS. 41 and 42. Specifically, in the air conditioning system 1, the internal air blowing unit 21 may be provided upstream of a position of the first heat exchanger 31 in air flow in the internal passage 112, and the external air blowing unit 22 may be provided downstream of the position of the second heat exchanger 32 in air flow in the external passage 111.

FIGS. 37, 39, and 41 show the flows of air flowing through the internal passage 112 and the flows of air flowing through the external passage 111 when the air conditioning system 1 operates in the heating mode. FIGS. 38, 40, and 42 show the flows of air flowing through the internal passage 112 and the flows of air flowing through the external passage 111 when the air conditioning system 1 operates in the cooling mode.

### Sixth Embodiment

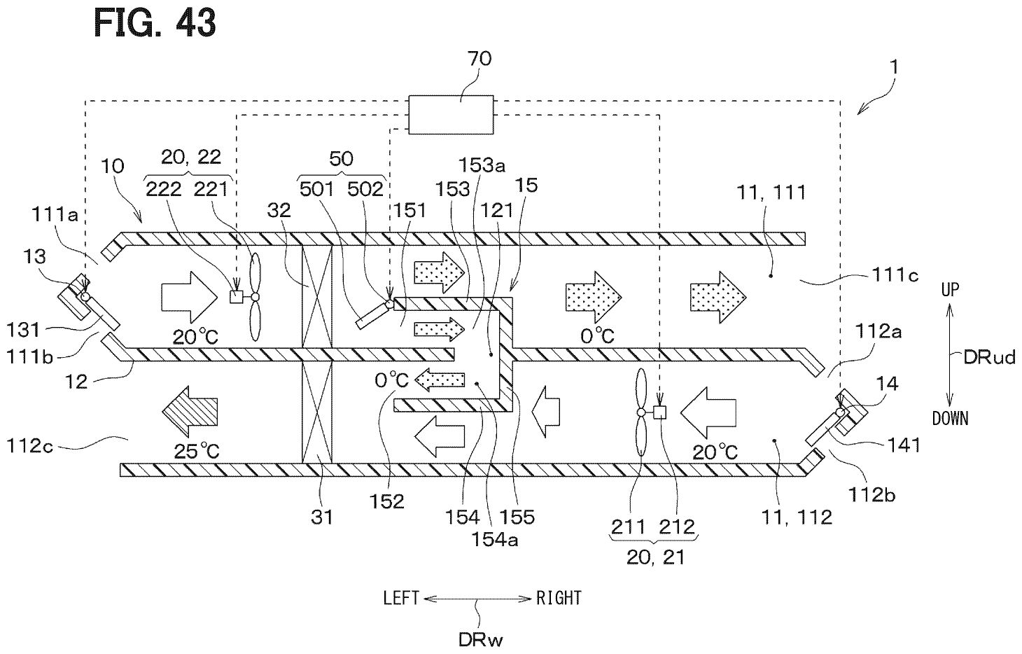

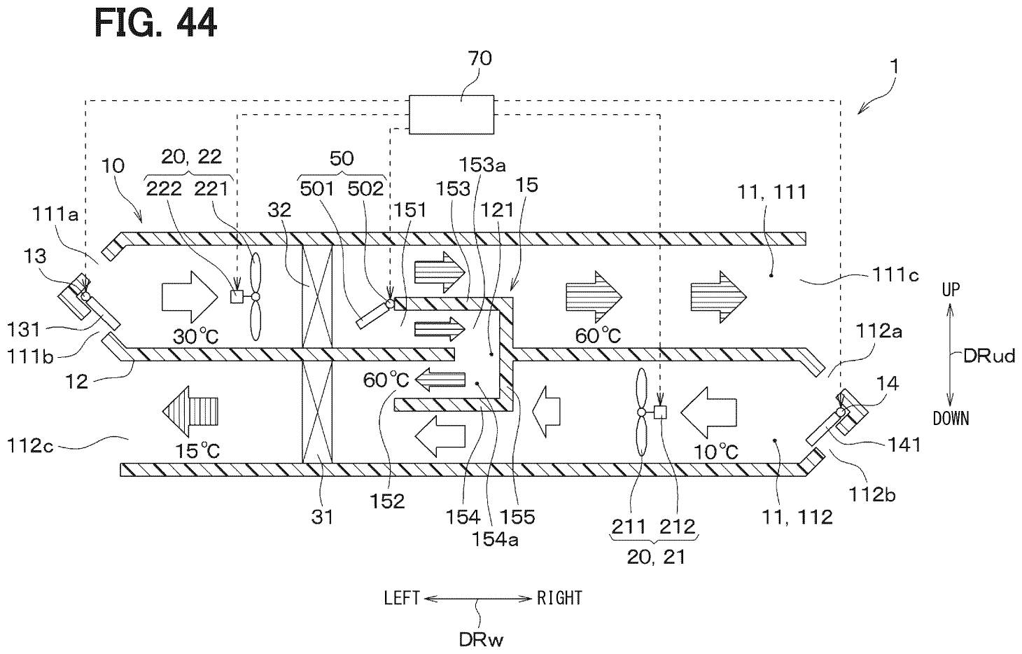

Next, a sixth embodiment will be described with reference to FIG. 43 and FIG. 44. The present embodiment is different from the third embodiment in a position where the first heat exchanger 31 is disposed. The other configuration is the same as that of the third embodiment. Therefore, in the present embodiment, portions different from the first embodiment will be mainly described, and description of portions similar to the third embodiment may be omitted.

As shown in FIGS. 43 and 44, the first heat exchanger 31 according to the present embodiment is provided downstream of a position of the internal air blowing unit 21 and downstream of the downstream opening 152 of the bypass passage 15 in air flow in the internal passage 112. Therefore, the downstream opening 152 according to the present embodiment faces an air suction side in the first heat exchanger 31.

FIG. 43 shows a flow of air flowing through the internal passage 112 and a flow of air flowing through the external passage 111 when the air conditioning system 1 operates in a heating mode. FIG. 44 shows a flow of air flowing through the internal passage 112 and a flow of air flowing through the external passage 111 when the air conditioning system 1 operates in a cooling mode.

Other configurations are similar as those in the third embodiment described above. Therefore, similar effects as in the third embodiment can be obtained based on a configuration that is similar or equivalent to that in the third embodiment.

### Modification of Sixth Embodiment

In the sixth embodiment described above, the air conditioning system 1 is described in an example in which the internal air blowing unit 21 is provided upstream of the position of the first heat exchanger 31 in air flow in the internal passage 112. The air conditioning system 1 is described in an example in which the external air blowing unit 22 is provided upstream of the position of the second heat exchanger 32 in air flow in the external passage 111. However, positions where the internal air blowing unit 21 and the external air blowing unit 22 are disposed are not limited thereto.

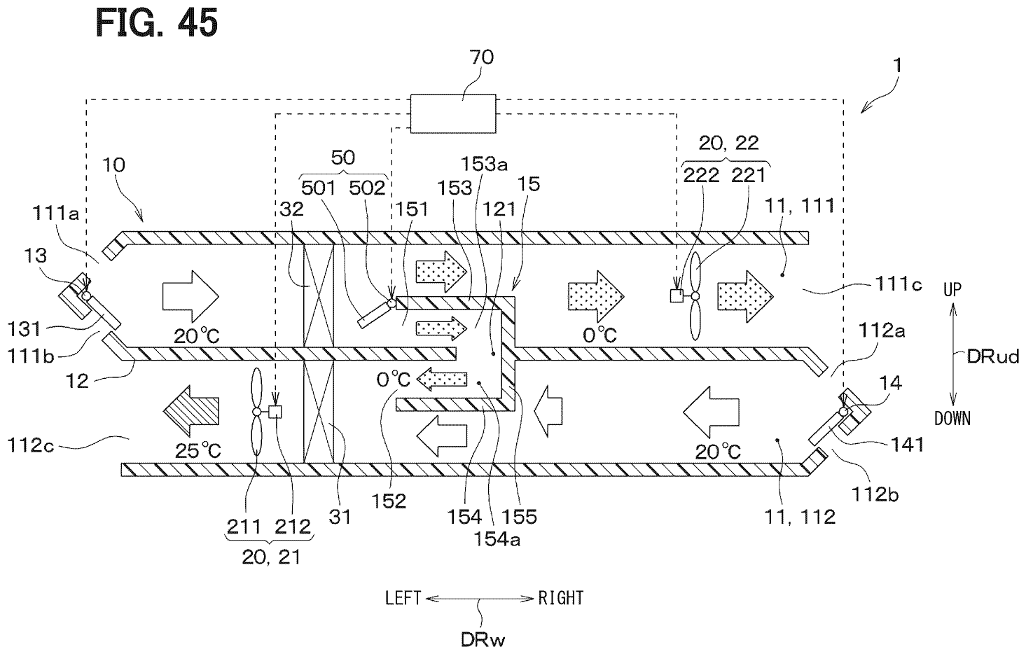

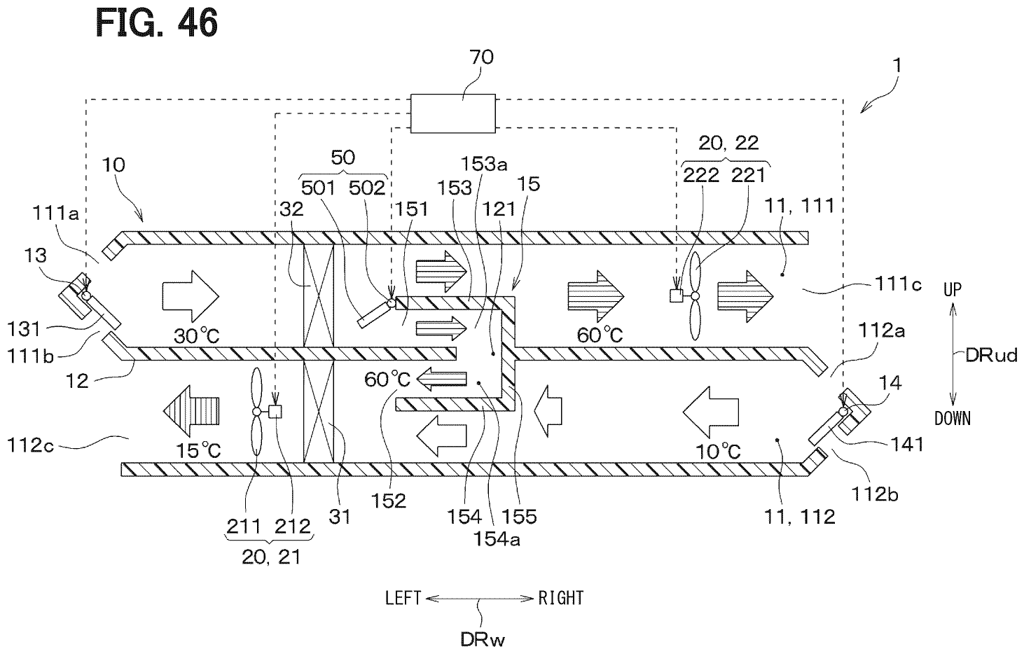

For example, in the air conditioning system 1, the internal air blowing unit 21 and the external air blowing unit 22 may be disposed at positions shown in FIGS. 45 and 46. Specifically, in the air conditioning system 1, the internal air blowing unit 21 may be provided downstream of a position of the first heat exchanger 31 in air flow in the internal passage 112, and the external air blowing unit 22 may be provided downstream of a position of the second heat exchanger 32 in air flow in the external passage 111.

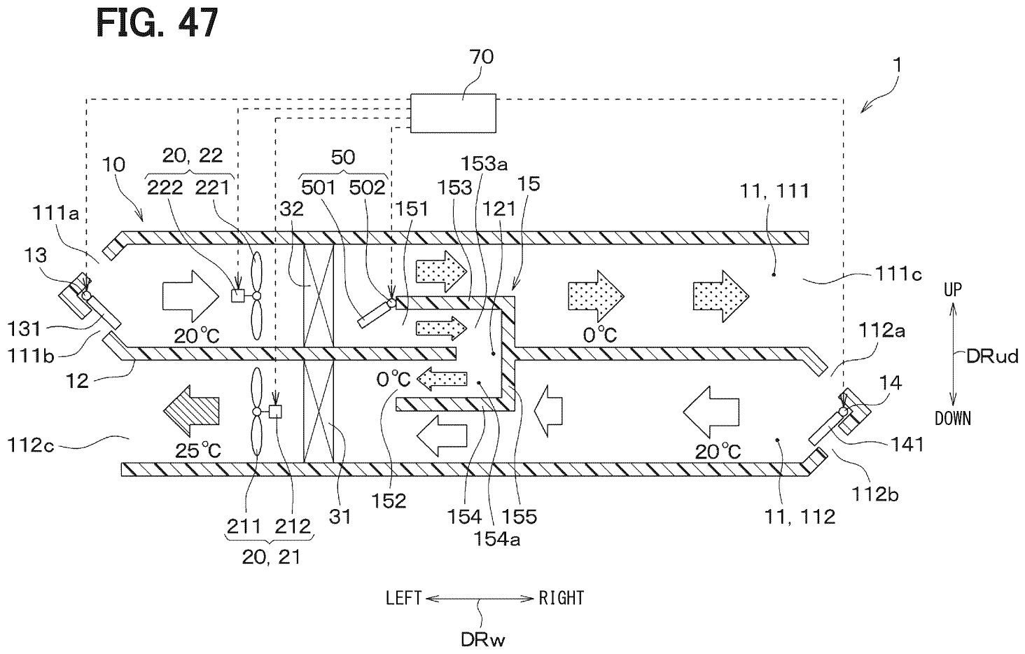

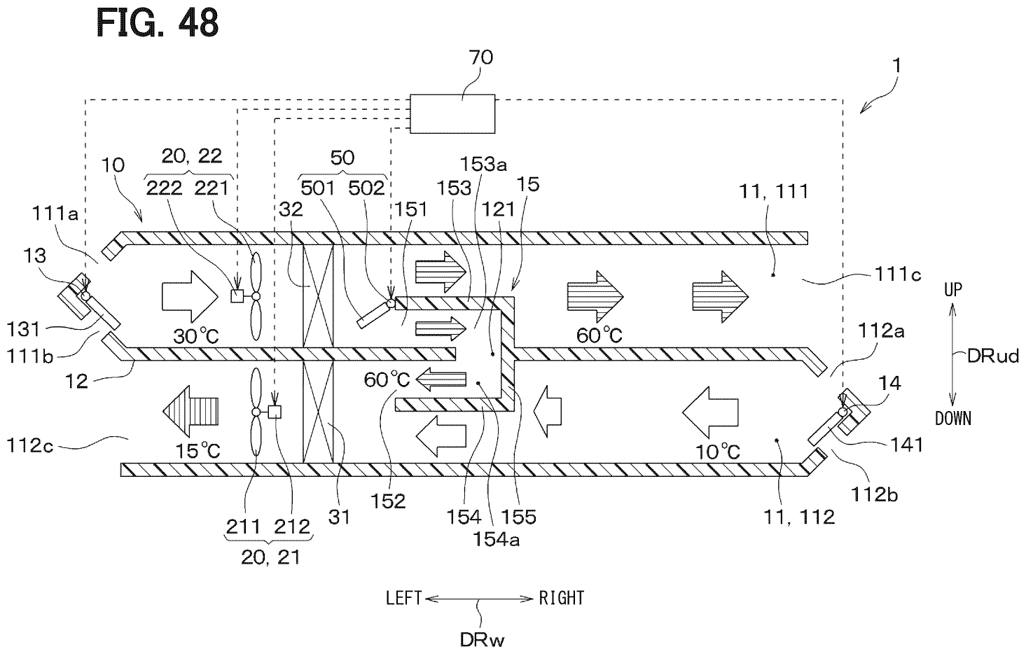

In the air conditioning system 1, the internal air blowing unit 21 and the external air blowing unit 22 may be disposed at positions shown in FIGS. 47 and 48. Specifically, in the air conditioning system 1, the internal air blowing unit 21 may be provided downstream of a position of the first heat exchanger 31 in air flow in the internal passage 112, and the external air blowing unit 22 may be provided upstream of a position of the second heat exchanger 32 in air flow in the external passage 111.

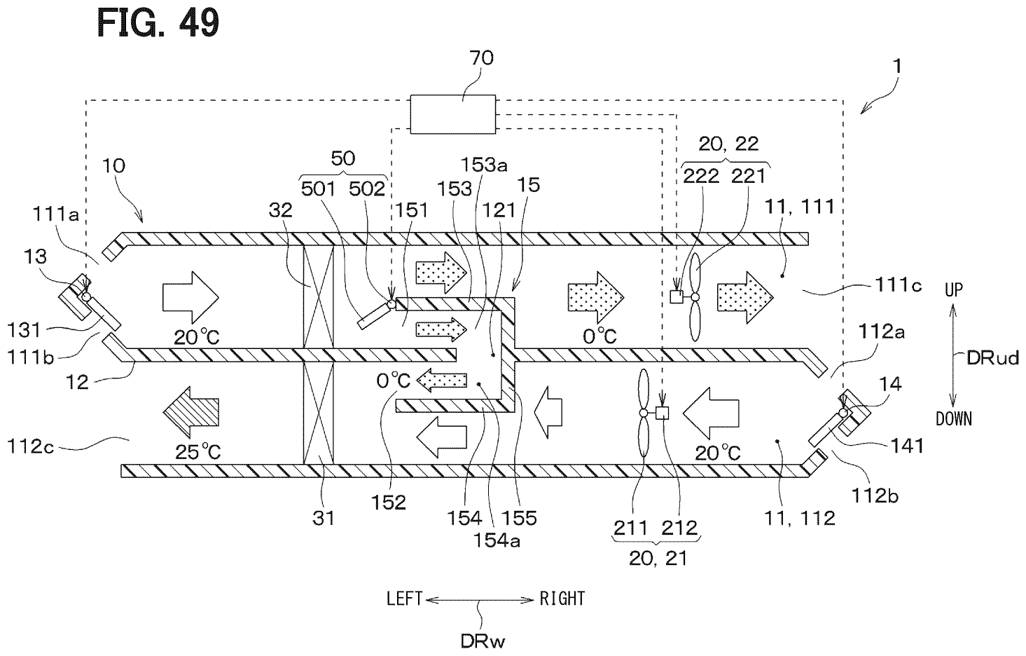

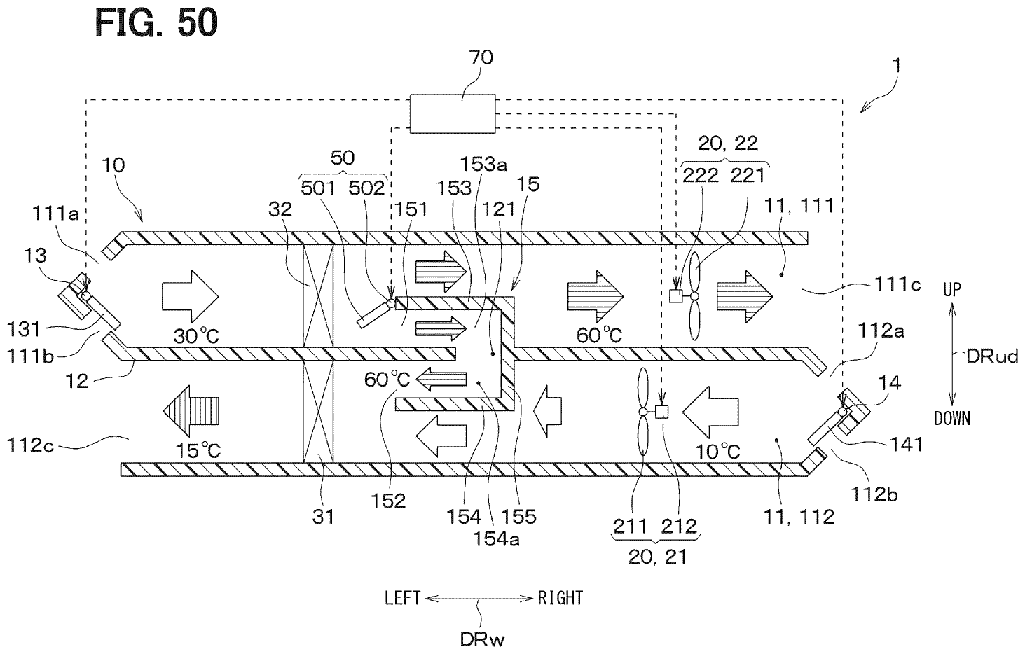

In the air conditioning system 1, the internal air blowing unit 21 and the external air blowing unit 22 may be disposed at positions shown in FIGS. 49 and 50. Specifically, in the air conditioning system 1, the internal air blowing unit 21 may be provided upstream of a position of the first heat exchanger 31 in air flow in the internal passage 112, and the external air blowing unit 22 may be provided downstream of the position of the second heat exchanger 32 in air flow in the external passage 111.

FIGS. 45, 47, and 49 show the flows of air flowing through the internal passage 112 and the flows of air flowing through the external passage 111 when the air conditioning system 1 operates in the heating mode. FIGS. 46, 48, and 50 show the flows of air flowing through the internal passage 112 and the flows of air flowing through the external passage 111 when the air conditioning system 1 operates in the cooling mode.

### Seventh Embodiment

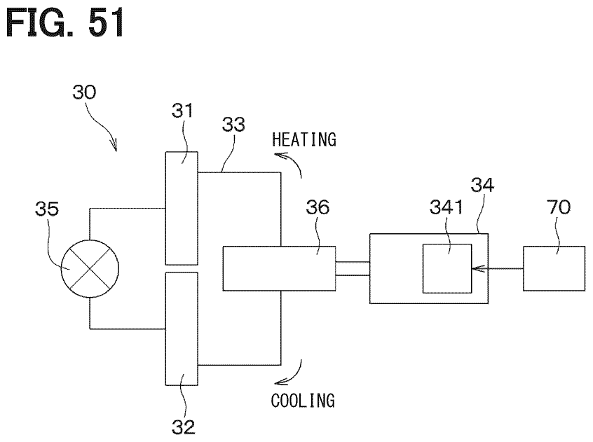

Next, a seventh embodiment will be described with reference to FIG. 51. The present embodiment is different from the first to seventh embodiments in that the refrigeration cycle device 30 includes a switching valve 36 that switches a flow direction of a refrigerant circulating in the refrigerant circuit 33. The other configuration is the same as those of the first to sixth embodiments. Therefore, in the present embodiment, portions different from the first embodiment will be mainly described, and description of portions similar to the first embodiment may be omitted.

As shown in FIG. 51, the refrigeration cycle device 30 according to the present embodiment includes the switching valve 36 in addition to the first heat exchanger 31, the second heat exchanger 32, the refrigerant circuit 33, the electric compressor 34, and the decompressor 35.

The switching valve 36 is, for example, an electric four-way valve whose operation is controlled based on a control signal transmitted from the control device 70. The switching valve 36 is connected to a refrigerant discharge side of the electric compressor 34, a refrigerant suction side of the electric compressor 34, the first heat exchanger 31, and the second heat exchanger 32. The switching valve 36 switches a flow channel of the refrigerant circuit 33 to a flow channel connecting the refrigerant discharge side of the electric compressor 34 and the first heat exchanger 31 and a flow channel connecting the refrigerant discharge side of the electric compressor 34 and the second heat exchanger 32 according to an operation mode of the air conditioning system 1.

That is, the switching valve 36 guides a high-temperature and high-pressure refrigerant discharged from the electric compressor 34 to either the first heat exchanger 31 or the second heat exchanger 32 by switching the flow channel of the refrigerant flowing through the refrigerant circuit 33. Specifically, when the air conditioning system 1 operates in a heating mode, the switching valve 36 guides the high-temperature and high-pressure refrigerant discharged from the electric compressor 34 to the first heat exchanger 31. When the air conditioning system 1 operates in a cooling mode, the switching valve 36 guides the high-temperature and high-pressure refrigerant discharged from the electric compressor 34 to the second heat exchanger 32.

In the refrigeration cycle device 30 having such a switching valve 36, when the air conditioning system 1 operates in the heating mode, the refrigerant flows in an order of the electric compressor 34, the switching valve 36, the first heat exchanger 31, the decompressor 35, and the second heat exchanger 32. In the refrigeration cycle device 30, when the air conditioning system 1 operates in the cooling mode, the refrigerant flows in an order of the electric compressor 34, the switching valve 36, the second heat exchanger 32, the decompressor 35, and the first heat exchanger 31. Thus, in the refrigeration cycle device 30 according to the present embodiment, the refrigerant circuit 33 can be switched by the switching valve 36. Therefore, it is not necessary to switch the refrigerant circuit 33 by switching a rotation direction of the electric motor 341 of the electric compressor 34. That is, the electric compressor 34 is not configured such that the rotation direction of the electric motor 341 can be both forward or reverse, but only needs to be configured such that the electric motor 341 is capable of rotating in only one of the forward and reverse directions.

Other configurations are similar as those in the first to sixth embodiments described above. Therefore, similar effects as in the first to sixth embodiments can be obtained based on a configuration that is similar or equivalent to those in the first to sixth embodiments.

According to the configuration of the refrigeration cycle device 30 having the switching valve 36, a flow direction of the refrigerant circulating in the refrigerant circuit 33 can be switched with a simple configuration as compared with a configuration including the electric compressor 34 in which the rotation direction of the electric motor 341 can be forward and reverse.

### Eighth Embodiment

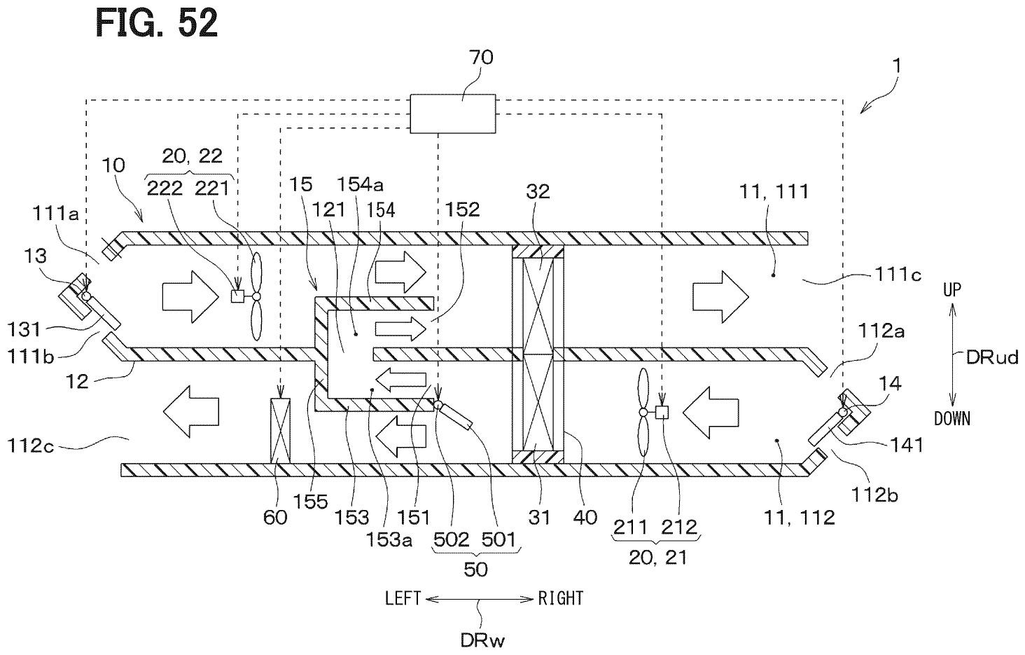

Next, an eighth embodiment will be described with reference to FIG. 52. The present embodiment is different from the first embodiment in that the air conditioning system 1 includes a heat exchange accommodation portion 40 that accommodates the first heat exchanger 31 and the second heat exchanger 32. The other configuration is similar as that of the first embodiment. Therefore, in the present embodiment, portions different from the first embodiment will be mainly described, and description of portions similar to the first embodiment may be omitted.

The heat exchange accommodation portion 40 is an accommodation case that accommodates the first heat exchanger 31 and the second heat exchanger 32 disposed in the casing 10. The heat exchange accommodation portion 40 is disposed inside the casing 10 and accommodates the first heat exchanger 31 and the second heat exchanger 32. The heat exchange accommodation portion 40 is disposed across the external passage 111 and the internal passage 112, accommodates the second heat exchanger 32 in a portion disposed in the external passage 111, and accommodates the first heat exchanger 31 in a portion disposed in the internal passage 112. The first heat exchanger 31 and the second heat exchanger 32 are disposed side by side along the upper-lower direction DRud in the heat exchange accommodation portion 40.

The heat exchange accommodation portion 40 has a rectangular parallelepiped shape and has a surface positioned on the left side in the left-right direction DRw and a surface positioned on the right side in the left-right direction DRw. The heat exchange accommodation portion 40 has openings on both a left surface in the left-right direction DRw and a right surface in the left-right direction DRw, through which air passes.

In the air conditioning system 1 having such a heat exchange accommodation portion 40, when the internal blower fan 211 of the internal air blowing unit 21 rotates, internal blown air flowing through the internal passage 112 flows into the heat exchange accommodation portion 40. The internal blown air that has flowed into the heat exchange accommodation portion 40 exchanges heat with a refrigerant by the first heat exchanger 31 and is discharged from the heat exchange accommodation portion 40. When the external blower fan 221 of the external air blowing unit 22 rotates, external blown air flowing through the external passage 111 flows into the heat exchange accommodation portion 40. The external blown air that has flowed into the heat exchange accommodation portion 40 exchanges heat with a refrigerant by the second heat exchanger 32 and is discharged from the heat exchange accommodation portion 40.

Other configurations are similar as those in the first embodiment described above. Therefore, similar effects as in the first embodiment can be obtained based on a configuration that is similar or equivalent to that in the first embodiment.

By accommodating the first heat exchanger 31 and the second heat exchanger 32 in the heat exchange accommodation portion 40, disposition positions of the first heat exchanger 31 and the second heat exchanger 32 can be easily made close to each other. Therefore, a flow channel through which the refrigerant flows between the first heat exchanger 31 and the second heat exchanger 32 can be easily shortened. Therefore, a pressure loss caused when the refrigerant flows can be reduced, and efficiency of the refrigeration cycle can be improved.

Although the representative embodiments of the present disclosure are described above, the present disclosure is not limited to the embodiments described above, and various modifications can be made, for example, as follows.

In the first embodiment and the second embodiment described above, an example is described in which the air conditioning system 1 includes the flow rate adjustment unit 50, but the present disclosure is not limited thereto. For example, the air conditioning system 1 may not include the flow rate adjustment unit 50.

In the first embodiment and the second embodiment described above, an example is described in which the air conditioning system 1 includes the PTC heater 60, but the present disclosure is not limited thereto. For example, the air conditioning system 1 may not include the PTC heater 60.

In the embodiment described above, an example is described in which the flow rate adjustment unit 50 includes the flow rate adjustment door 501 that changes the opening area of the upstream opening 151 and the electric actuator 502 that changes the rotation angle of the flow rate adjustment door 501, but the present disclosure is not limited thereto. For example, the internal air blowing unit 21 and the external air blowing unit 22 may be configured to adjust a flow rate of air flowing from the internal passage 112 to the external passage 111 via the bypass passage 15 by adjusting rotation speeds of the internal blower fan 211 and the external blower fan 221. In this case, the internal air blowing unit 21 and the external air blowing unit 22 function as the flow rate adjustment unit 50.

The flow rate adjustment unit 50 may be a blower that adjusts a flow rate of air flowing from the internal passage 112 to the external passage 111 via the bypass passage 15, and the blower may be provided in the bypass passage 15.

In the embodiment described above, an example is described in which the air blowing unit 20 includes the internal air blowing unit 21 that generates an air flow in the internal passage 112, and the external air blowing unit 22 that generates an air flow in the external passage 111. An example is described in which the control device 70 controls the rotation speeds of the internal air blowing unit 21 and the external air blowing unit 22 independently of each other, but the present disclosure is not limited thereto.

For example, the air blowing unit 20 may be implemented by a single blower that generates an air flow in the internal passage 112 and the external passage 111.

In the embodiment described above, an example is described in which the internal air blowing unit 21 includes the internal blower fan 211 that rotates to generate an air flow, and the internal motor 212 that rotates the internal blower fan 211. An example is described in which the external air blowing unit 22 includes the external blower fan 221 that rotates to generate an air flow and the external motor 222 that rotates the external blower fan 221. However, the configuration of the internal air blowing unit 21 and the external air blowing unit 22 is not limited thereto.

For example, the internal air blowing unit 21 and the external air blowing unit 22 may be configured to be operated by a common motor that rotates the internal blower fan 211 and the external blower fan 221.

In the embodiment described above, an example is described in which the control device 70 functions as the blowing control device that controls an operation of the air blowing unit 20 and the motor control device that controls rotation of the electric motor 341, but the present disclosure is not limited thereto. For example, in the air conditioning system 1, a blowing control device that controls an operation of the air blowing unit 20 and a motor control device that controls rotation of the electric motor 341 may be configured separately.

In the embodiment described above, an example is described in which the internal air blowing unit 21 and the external air blowing unit 22 are disposed such that the air flowing through the internal passage 112 and the air flowing through the external passage 111 flow in opposite directions, but the present disclosure is not limited thereto.

For example, the internal air blowing unit 21 and the external air blowing unit 22 may be disposed such that air flowing through the internal passage 112 and air flowing through the external passage 111 flow in the same direction.

In the embodiment described above, an example is described in which the bypass passage 15 is disposed inside the casing 10 and penetrates the passage partition portion 12, but the present disclosure is not limited thereto. For example, the bypass passage 15 may be provided outside the casing 10, and may be configured such that one side is connected to the external passage 111 and the other side is connected to the internal passage 112.

In the embodiment described above, an example is described in which the flow rate adjustment unit 50 is provided in the upstream opening 151 in the bypass passage 15, but the present disclosure is not limited thereto. The flow rate adjustment unit 50 may be provided in the downstream opening 152, may be provided inside the upstream passage 153a, or may be provided inside the downstream passage 154a.

In the embodiment described above, an example is described in which the air conditioning system 1 includes the external switching device 13 inside the casing 10, which switches the air introduced into the external passage 111 between the outside air and the inside air, but the present disclosure is not limited thereto. For example, the air conditioning system 1 may not include the external switching device 13. In this case, the air conditioning system 1 may be configured such that either the outside air or the inside air is introduced into the external passage 111.

In the embodiment described above, an example is described in which the air conditioning system 1 includes the internal switching device 14 inside the casing 10, which switches the air introduced into the internal passage 112 between the outside air and the inside air, but the present disclosure is not limited thereto. For example, the air conditioning system 1 may not include the internal switching device 14. In this case, the air conditioning system 1 may be configured such that either the outside air or the inside air is introduced into the internal passage 112.

In the embodiment described above, an example is described in which the air conditioning system 1 includes the vehicle exterior temperature sensor for detecting the temperature outside the vehicle compartment, the solar radiation sensor for detecting the amount of solar radiation, and the like. However, it is also possible to eliminate these sensors and receive external environment information from a server or cloud outside a vehicle. Alternatively, it is also possible to eliminate these sensors, acquire relevant information related to the external environment information from a server or cloud outside a vehicle, and estimate the external environment information based on the acquired relevant information.

In the embodiments described above, it is needless to say that the elements forming the embodiments are not necessarily essential except in a case where those elements are clearly indicated to be essential in particular, a case where those elements are considered to be obviously essential in principle, and the like.

In the embodiments described above, when referring to the number, the numerical value, the amount, the range, and the like of the components of the embodiment, the present disclosure is not limited to a specific number of components of the embodiments, except in a case of being particularly noted as being essential, a case of being limited to a specific number in principle, and the like.

In the embodiments described above, when referring to the shape, the positional relationship, and the like of the component and the like, the present disclosure is not limited to the shape, the positional relationship, and the like, except in a case of being particularly noted, a case of being limited to a specific shape, a specific positional relationship in principle, and the like.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. An air conditioning system for blowing heated air, the air conditioning system comprising:
a casing including
an air introduction port configured to introduce air,
an internal passage configured to guide the air introduced from the air introduction port to an inside of a compartment, and
an external passage configured to guide the air introduced from the air introduction port to an outside of the compartment;
a bypass passage configured to guide air flowing through the internal passage to the external passage;
an air blowing unit configured to generate an air flow in the internal passage and the external passage; and
a refrigeration cycle including
an electric compressor configured to compress and discharge a refrigerant by an operation of an electric motor as a drive source,
a first heat exchanger provided in the internal passage and configured to heat the air flowing in the internal passage by exchanging heat between the refrigerant discharged from the electric compressor and the air flowing in the internal passage,
a decompressor configured to reduce a pressure of a refrigerant that has flowed out from the first heat exchanger, and
a second heat exchanger provided in the external passage and configured to absorb heat from air flowing in the external passage by exchanging heat between a refrigerant that has flowed out from the decompressor and the air flowing in the external passage, wherein
the bypass passage includes
an air flow upstream end disposed in the internal passage, and
an air flow downstream end disposed in the external passage and upstream of a position of the second heat exchanger in the air flow in the external passage.

2. The air conditioning system according to claim 1, wherein
the air flow upstream end of the bypass passage is disposed downstream of a position of the first heat exchanger in the air flow in the internal passage.

3. The air conditioning system according to claim 1, further comprising:
a flow rate adjustment unit configured to adjust a flow rate of air flowing from the internal passage to the external passage via the bypass passage.

4. An air conditioning system for blowing heated air, the air conditioning system comprising:
a casing including
an air introduction port configured to introduce air,
an internal passage configured to guide the air introduced from the air introduction port to an inside of a compartment, and
an external passage configured to guide the air introduced from the air introduction port to an outside of the compartment;
a bypass passage configured to guide air flowing through the internal passage to the external passage, the bypass passage including
an air flow upstream end disposed in the external passage, and
an air flow downstream end disposed in the internal passage;
an air blowing unit configured to generate an air flow in the internal passage and the external passage;
a refrigeration cycle including
an electric compressor configured to compress and discharge a refrigerant by an operation of an electric motor as a drive source,
a first heat exchanger provided in the internal passage and configured to heat air flowing in the internal passage by exchanging heat between the refrigerant discharged from the electric compressor and the air flowing in the internal passage,
a decompressor configured to reduce a pressure of a refrigerant that has flowed out from the first heat exchanger, and
a second heat exchanger provided in the external passage and configured to absorb heat from the air flowing in the external passage by exchanging heat between a refrigerant that has flowed out from the decompressor and the air flowing in the external passage; and
a flow rate adjustment unit configured to adjust a flow rate of air flowing from the external passage to the internal passage via the bypass passage, wherein
the air blowing unit is configured to generate an air flow in the internal passage and an air flow in the external passage such that the air flow in the internal passage and the air flow in the external passage are opposite in flow direction,
the air flow upstream end of the bypass passage has an opening facing upstream in the air flow in the external passage,
the air flow downstream end of the bypass passage has an opening facing downstream in the air flow in the internal passage, and
the flow rate adjustment unit is configured to adjust a temperature of the air flowing through the internal passage by adjusting the flow rate of the air flowing from the external passage to the internal passage via the bypass passage.

5. The air conditioning system according to claim 4, wherein
the air flow upstream end of the bypass passage is disposed downstream of a position of the second heat exchanger in the air flow in the external passage.

6. The air conditioning system according to claim 4, wherein
the air flow downstream end of the bypass passage is disposed downstream of a position of the first heat exchanger in the air flow in the internal passage.

7. The air conditioning system according to claim 3, wherein
the flow rate adjustment unit includes a flow channel adjustment unit that changes a flow channel area of the bypass passage and an actuator unit that changes a posture of the flow rate adjustment unit.

8. The air conditioning system according to claim 1, further comprising:
a blowing control device configured to control an operation of the air blowing unit, wherein
the air blowing unit includes
an internal air blowing unit provided in the internal passage and configured to generate an air flow in the internal passage, and
an external air blowing unit provided in the external passage and configured to generate an air flow in the external passage, and
the blowing control device controls rotation speeds of the internal air blowing unit and the external air blowing unit independently of each other.

9. The air conditioning system according to claim 8, wherein
the internal air blowing unit includes an internal blower fan that rotates to generate an air flow, and an internal motor that rotates the internal blower fan, and
the internal motor is provided upstream of a position of the first heat exchanger in the air flow in the internal passage.

10. The air conditioning system according to claim 8, wherein
the internal air blowing unit includes an internal blower fan that rotates to generate an air flow, and
the internal blower fan is provided downstream of a position of the first heat exchanger in the air flow in the internal passage.

11. The air conditioning system according to claim 8, wherein
the external air blowing unit includes an external blower fan that rotates to generate an air flow, and an external motor that rotates the external blower fan, and
the external motor is provided upstream of the position of the second heat exchanger in the air flow in the external passage.

12. The air conditioning system according to claim 8, wherein
the external air blowing unit includes an external blower fan that rotates to generate an air flow, and
the external blower fan is provided downstream of the position of the second heat exchanger in the air flow in the external passage.

13. The air conditioning system according to claim 1, further comprising:
a heat exchange accommodation portion accommodating the first heat exchanger and the second heat exchanger.

14. The air conditioning system according to claim 1, further comprising:
a motor control device configured to control rotation of the electric motor; and
a refrigerant circuit configured to circulate a refrigerant, wherein
the motor control device is configured to change a flow direction of the refrigerant circulating in the refrigerant circuit by switching a rotation direction of the electric motor.

15. The air conditioning system according to claim 1, further comprising:
a refrigerant circuit configured to circulate a refrigerant;
a switching valve configured to switch a flow direction of a refrigerant circulating in the refrigerant circuit; and
a motor control device configured to control an operation of the switching valve, wherein
the motor control device is configured to change the flow direction of the refrigerant circulating in the refrigerant circuit by controlling an operation of the switching valve.
